(19) United States
(12) Patent Application Publication
(10) Pub. No.: US 2009/0292599 A1
(43) Pub. Date: Nov. 26, 2009

(54) TRANSACTIONAL ADVERTISING

(76) Inventors: Alastair Rampell, Palo Alto, CA (US); Alexander E. Campbell, San Jose, CA (US); Terry Angelos, Mountain View, CA (US); Kenneth K. Yu, Mountain View, CA (US)

Correspondence Address: STRATEGIC PATENTS P.C.., C/O PORTFOLIOIP, P.O. BOX 52050, MINNEAPOLIS, MN, 55402, US

(21) Appl. No.: 12/430,656

(22) Filed: Apr. 27, 2009

Related U.S. Application Data
(63) Continuation-in-part of application No. 11/781,856, filed on Jul. 23, 2007.
Application No. 11/781,856 is a continuation-in-part of application No. 11/781,831, filed on Jul. 23, 2007.
Application No. 11/781,831 is a continuation-in-part of application No. 11/781,844, filed on Jul. 23, 2007.
(60) Provisional application No. 61/048,034, filed on Apr. 25, 2008.
(60) Provisional application No. 60/820,701, filed on Jul. 28, 2006.
(60) Provisional application No. 60/825,885, filed on Sep. 15, 2006.
(60) Provisional application No. 60/868,767, filed on Dec. 6, 2006.
(60) Provisional application No. 60/869,899, filed on Dec. 13, 2006.
(60) Provisional application No. 60/914,298, filed on Apr. 26, 2007.

(30) Foreign Application Priority Data
Jul. 24, 2007 (US) PCT/US07/74166

(51) Int. Cl. G06Q 30/00

(52) U.S. Cl. 705/14.13; 705/14.23; 705/14.71

(57) ABSTRACT

A method of transactional advertising includes providing a transactional advertising platform for presenting offers to a user who is committed to complete an electronic transaction; selecting an offer to present based on at least two of the following associated with the transaction: a transaction amount, a payment type, a shipment address, and a shopping cart contents; and presenting the offer to the user based on a user level of commitment to complete the electronic transaction and based on the status of the transaction. The user level of commitment includes one of an indication of non-payment, an indication of payment, and an indication of indecision to pay. The transaction status includes one of needs incentive to transact, method of payment provided, payment approved, and payment complete.

### CROSS-REFERENCE TO RELATED APPLICATIONS

This application claims the benefit of U.S. Provisional Patent Application No. 61/048,034 filed Apr. 25, 2008 which is hereby incorporated by reference in its entirety.

This application is a continuation in part of the following patent applications, each of which is incorporated by reference in its entirety: U.S. patent application Ser. No. 11/781,856, U.S. patent application Ser. No. 11/781,831, and U.S. patent application Ser. No. 11/781,844 each of which was filed Jul. 23, 2007 and each of which claims the benefit of U.S. Provisional Application No. 60/820,701 filed Jul. 28, 2006, U.S. Provisional Application No. 60/825,885 filed Sep. 15, 2006, U.S. Provisional Application No. 60/868,767 filed Dec. 6, 2006, U.S. Provisional Application No. 60/869,899 filed Dec. 13, 2006, and U.S. Provisional Application No. 60/914,298 filed Apr. 26, 2007.

This application claims foreign priority to international application Serial Number PCT/US07/74166 filed Jul. 24, 2007.

This application is also related to the following U.S. patent applications each of which is incorporated by reference herein in its entirety:

U.S. patent application Ser. No. 11/924,410; U.S. patent application Ser. No. 11/924,429; U.S. patent application Ser. No. 11/924,443; U.S. patent application Ser. No. 11/924,454; U.S. patent application Ser. No. 11/924,465; U.S. patent application Ser. No. 11/924,471; U.S. patent application Ser. No. 11/924,466; U.S. patent application Ser. No. 11/924,452; U.S. patent application Ser. No. 11/924,439; and U.S. patent application Ser. No. 11/924,412 each of which was filed Oct. 25, 2007.

### BACKGROUND

1. Field

This invention generally relates to payment for products or services. The invention specifically relates to methods and systems that enable providing an alternate form of payment for products or services.

2. Background

Existing systems for lead generation in advertising of products and services have drawbacks that either result in diminishing marginal return, or inefficacy. Acquiring access to high quality leads that have a relevance to the product or service being advertised or promoted is considered of higher value than less relevant or random leads.

In addition, on-line response to advertisements, offers, and promotions continues to support increasingly higher levels of spending by advertisers, and product or service providers, for high quality leads. This has led to an increasing shift to online direct marketing from all segments of the marketplace.

A need exists for methods and systems that facilitate gaining access to high quality leads by online advertisers and others who benefit from these leads and for allowing consumers to benefit from such access by participating in favorable offers for such goods and services at critical phases of an electronic purchase transaction.

### SUMMARY

Provided herein are methods and systems for transaction offers of products or services. A transaction offer platform as herein described may provide an advertiser with access to high-value customers. The transaction offer platform may provide benefit to a wide range of markets such as online services, online content providers, software products, shareware, information services, online retailers, financial services, publishers, online games, virtual goods, and the like. For many online goods and services, especially digital products where the marginal cost of additional production is negligible or zero, the true (economic) value of these goods and services is hard for the consumer to quantify. This makes a traditional purchase decision difficult. A transaction offer platform may facilitate a product or service vendor receiving compensation for providing products, premium goods, or services to users who are unwilling to use traditional payment methods to access the premium goods and services. The transaction offer platform may also enable these merchants to exchange other sources of value, such as customer demographics, that are not supported in traditional payment methods for products, premium goods, or services.

The transaction offer platform may offer a high degree of scalability as it may be integrated with any type of e-commerce transaction. The transaction offer platform may facilitate optimizing transaction offer selection for vendors. This optimization may be performed locally for each vendor. It may also be performed across a plurality of vendors associated with the payment platform, such that the benefits of optimization may accrue to all parties associated with the platform.

Terms such as “merchant,” “offeror,” “vendor,” “seller,” and “advertiser,” are used herein to refer to any parties who engage in the business of offering goods, products, services, or other items, such as by sales, leases, licenses, or other forms of transaction, whether conducted by electronic commerce, digital commerce, offline commerce, or other channels. Use of one such term should be understood to encompass the others, except where context indicates otherwise. Without limitation of the foregoing, the terms “merchant” and “primary offeror” are used in most cases herein to refer interchangeably to a party who offers a primary offer, such as an offer to sell an item or bundle of items at a price or prices, while the terms “advertiser” and “transaction offer offeror” are used interchangeably herein in most cases to refer to a party who provides a transaction offer. Terms such as “transaction offer” “transaction offer offering,” “transaction offering and the like should be understood as various species of transaction offer, and except where context indicates otherwise, it should be understood that in various embodiments described herein one such species may be substituted for another, resulting in additional alternative embodiments of the methods and systems disclosed herein.

In an aspect of the present invention, methods and systems described herein may provide methods and systems for transactional advertising. The methods and systems may include providing a transaction offer platform for presenting offers to a user committed to complete an electronic transaction in which the user is currently engaged, accessing a database of offer templates, electronically calculating an anticipated payout amount for user acceptance of among one of the offers in the database, customizing one or more offer templates based on the anticipated payout to provide a transaction offer and presenting the transaction offer to the user in the electronic transaction.

In the aspect, the methods and systems may include an advertiser associated with each offer template in the database of offer templates. The methods and systems may include customizing one or more offer template by adjusting a redemption value, a redemption validity time frame, and the like. The methods and systems may include a portion of the offer templates having multiple offers with adjustable redemption values that may be adjusted within a range of values. One or more offer template may be customized by selecting a redemption value within the range of values based on an aspect of the transaction. The aspect of the transaction may be the purchase amount of the transaction or may be an aspect of an advertiser transaction offer program that may be associated with the offer template, and the like. The offer may be a discount coupon, an e-check, an electronic certificate, a mailer, and the like. The anticipated payout amount may be the total amount received after completing the transaction.

In another aspect of the present invention methods and systems may be provided for a transactional advertising facility for handling bids from advertisers to provide offers to users. The methods and systems may include an offer search facility for identifying candidate offers based on transactional advertising information, an offer bidding facility for suggesting a bid amount to an advertiser associated with a number of candidate offers based on the transactional advertising information and information associated with the advertiser, the offer bidding facility for receiving bids from a number of advertisers for offer placement in an electronic transaction, an offer selection facility for selecting numerous offers to present to the user in the electronic transaction based on results of analyzing the matched offers, suggested bid amount, and received bids, and an offer presentation facility for presenting one or more selected offers in the electronic transaction.

In the aspect the offer may be a discount coupon, an e-check, an electronic certificate, a mailer, and the like. In embodiments, the anticipated payout amount may be the total amount received after completing the transaction.

In the aspect, the methods and systems may include the information associated with the transaction. The information may include a transaction amount, a payment type, a shipment address, a shopping cart contents, a user level of commitment, transaction status, and the like. The user's level of commitment may include one of an indication of non-payment, an indication of payment commitment, an indication of payment authorization, an indication of indecision to pay, and the like. The transaction status may be out of the set of needs incentive to transact, method of payment provided, payment approved, payment complete, and the like.

In yet another aspect of the present invention methods and systems may be provided for transactional advertising. The methods and systems may include providing a transactional advertising platform for presenting offers to a user who may be committed to complete an electronic transaction, selecting an offer to present based on two of the following associated with the transaction a transaction amount, a payment type, a shipment address, and a shopping cart contents, and presenting the offer to the user based on a user level of commitment to complete the electronic transaction and based on the status of the transaction.

In the aspect, the methods and systems may include user level of commitment with one of an indication of non-payment, an indication of payment, and an indication of indecision to pay. The transaction status may be out of the set of needs incentive to transact, method of payment provided, payment approved, payment complete, and the like.

The present invention provides methods and systems for electronic transaction offer. The methods and systems may include presenting a transaction offer to a user at no cost to the user in an electronic commerce purchase transaction, electronically calculating an offer acceptance payout amount to debit from an advertiser when the user accepts the offer, electronically calculating a transaction offer placement payout to debit from an advertiser in exchange for presenting the transaction offer, and electronically delivering a coupon to the user that depicts a redemption value of the transaction offer.

The transaction offer may be targeted to the user based on information provided with or associated with payment information provided by the user. The transaction offer may target to the user based on user-related information provided by a user and a seller identified in the electronic commerce purchase transaction. In addition, the transaction offer may not obligate the user to undertake any action. The offer may be usable in a future transaction with a third party. The e-commerce purchase transaction terms may not be affected by the transaction offer. The payment information may include a form of payment. The user-related information may be provided prior to the user providing payment information. The offer platform may know the user's information. The purchase transaction term may include the fees and payment terms.

In an alternate aspect of the invention, methods and systems may include a transactional advertising facility that may include a transactional advertising platform for presenting offers to a user who is committed to complete an electronic transaction; a selection facility selecting an offer to present based on at least two of the following associated with the transaction: a transaction amount, a payment type, a shipment address, and a shopping cart contents; and a presentation facility for presenting the offer to the user based on a user level of commitment to complete the electronic transaction and based on the status of the transaction.

In yet another alternate aspect of the invention, methods and systems of an electronic transaction offer facility for electronic commerce purchase transactions may include a transaction offer presentation facility for presenting a transaction offer to a user at no cost to the user, wherein authentication of the offer is contingent upon a successful completion of the purchase transaction and wherein the offer is usable in a future transaction; an electronic payment facility for calculating an offer acceptance payout amount to debit from an advertiser when the user accepts the offer and for calculating a transaction offer placement payout to debit from an advertiser to in exchange for presenting the transaction offer; and an offer fulfillment facility for electronically delivering a coupon to the user that depicts a redemption value of the transaction offer.

### BRIEF DESCRIPTION OF FIGURES

The systems and methods described herein may be understood by reference to the following figures:

FIG. 1 depicts a block diagram with components of a transaction offer platform.

FIG. 2 depicts a flow diagram of activities associated with a transaction offer platform.

FIG. 3 depicts a block diagram of additional details of a transaction offer platform.

FIG. 4 depicts a block diagram of a transaction offer platform.

FIG. 5 depicts a block diagram of an offer optimization.

FIG. 6 depicts a block diagram of a user interface.

FIG. 7 depicts a block diagram of a method of taking bids for placement of transaction offer offerings.

FIG. 8 depicts a block diagram of a method of consumer value optimization associated with a transaction offer platform.

FIG. 9 shows a screen depicting an advertiser panel dashboard.

FIG. 10 shows a screen depicting an advertiser panel.

FIG. 11 shows a screen depicting an advertiser panel.

FIG. 12 shows a screen depicting a transaction report.

FIG. 13 shows an advertiser performance panel, in which an advertiser is presented with performance statistics associated with the performance of transaction offers.

FIG. 14 shows a flow diagram of a transaction offer method.

FIG. 15 illustrates a screen depicting a user account.

FIG. 16 depicts a screen for checking the status of transaction offers.

FIG. 17 depicts a primary offeror web page with an embodiment of the invention.

FIG. 18 depicts an exemplary web browser display of a detailed description of a transactional offer.

FIG. 19 depicts a transactional offer invitation placement on a product page.

FIG. 20 depicts a transactional offer opt-out invitation in a checkout page.

FIG. 21 depicts a transactional offer opt-in invitation in a checkout page.

FIG. 22 depicts a transactional offer in an electronic transaction confirmation page.

### DETAILED DESCRIPTION OF FIGURES

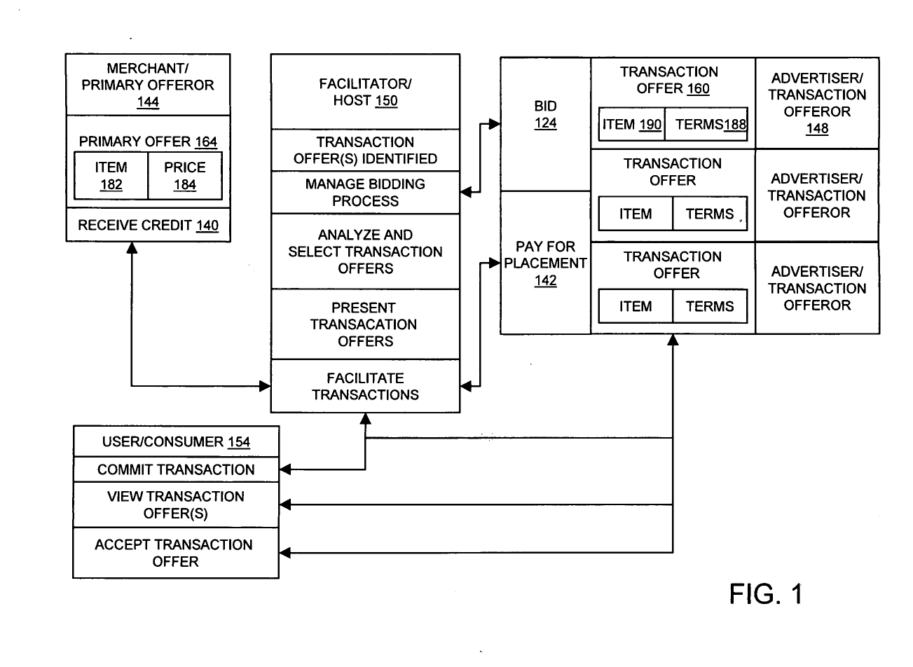

FIG. 1 shows roles of certain entities that interact in the use of a transaction offer platform 100 as described herein. A facilitator 150 facilitates interaction of merchants, or primary offerors 144, advertisers, or transaction offer offerors 148, and users 154 (referred to interchangeably herein as consumers). The merchant, or primary offeror 144, makes an offer 164, such as an offer of an item 182 at a price 184. A user 154 may initially engage with the merchant 144, such as to consider whether to purchase the item 182 at the price 184, such as by viewing the item at the merchant's website; however, for various reasons, such as unwillingness to pay the full price 184 of the item 182, the user 154 may be reluctant to complete the transaction with the merchant 144. Meanwhile, various advertisers, or transaction offer offerors 148, may introduce transaction offers 160 into the marketplace, such as for other items 190. Those transaction offer offerors 148 may be willing to offer an economic compensation (such as a payment) to engage with user 154. This is particularly true in cases where the advertiser perceives that it will receive a significant benefit from having the opportunity to engage with the user 154, such as to establish the user 154 as a long-time customer of the advertiser 148.

In various preferred embodiments of the methods and systems disclosed herein, the facilitator 150 (referred to interchangeably herein as the host) may manage a transaction offer platform 100 to enable advertisers 148 to engage with a user 154 in return for an appropriate economic compensation which the facilitator 150 may use for various reasons, such as compensating the merchant 144 for allowing the advertiser 148 to present the transaction offer. The facilitator 150 may present relevant transaction offers 160 to users 154, thereby enabling the users 154 to obtain a benefit for completing an electronic transaction with the merchant 144. The facilitator 150 may further facilitate an exchange of value among the facilitator 150, the advertiser 148 and the merchant 144, such as by debiting the advertiser 148, retaining an amount for the facilitator 150 and crediting the merchant 144. Thus, each party obtains a benefit from the facilitation of the transaction offer transaction. The merchant 144 receives a payment/credit, notwithstanding the reluctance of the user 154 to transact with the merchant 144. The advertiser 148 obtains the opportunity to engage with a user 154, such as to increase participation in trial programs offered by the advertiser 148, or the like. The user 154 obtains an offer for a future discount. The facilitator 150 receives payment from the advertiser for presenting the transaction offer 160 and/or enabling the user 154 to receive the transaction offer 160.

Referring still to FIG. 1, the facilitator 150 may optionally undertake various activities in managing the transaction offer platform 100, such as searching for or identifying transaction offers 160, managing the process by which advertisers 148 are given the opportunity to present transaction offers 160 to users 154 (such as by conducting a bidding process, or the like), analyzing various parameters associated with transaction offers 160, such as to optimize the selection, timing, placement, and the like of particular transaction offers 160 to users 154, presenting transaction offers 160 to users 154 (such as in an ecommerce transaction environment of the original merchant 144 or in a different environment), and facilitating the completion of the transaction among the user 154, advertiser 148 and merchant 144 (such as managing payment details, fulfillment, allocation of debits and credits, handling of receipts, prevention of fraud and other problems, and the like).

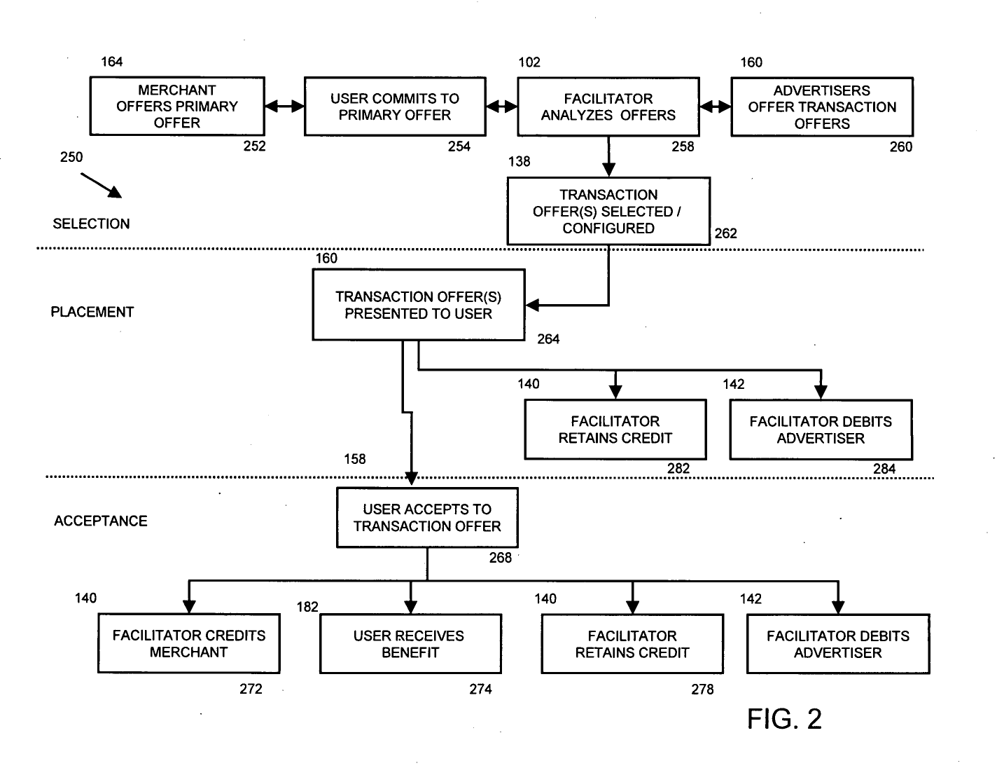

Referring to FIG. 2, a flow diagram 250 shows certain actions that take place in the context of a transaction offer platform 100 in one embodiment of an interaction of a merchant 144, an advertiser 148 and a user 154 with a platform managed by a facilitator 150. At step 252, a merchant 144 offers a primary offer 164, such as offering an item 182 at a price, and a user 154 may commit to transact the primary offer 164 at a step 254, such as by providing a form of payment, or the like. Meanwhile, advertisers 148 offer various transaction offers 160 at a step 260. The facilitator 150 analyzes the various transaction offers 160 at a step 258. The facilitator 150, undertaking various actions described in more detail elsewhere herein, may select one or more transaction offers 160 at a step 262. Upon selection at the step 262, the transaction offer(s) 160 may be presented to the user 154 at a step 264. Advertisers may be willing to pay for placement of a transaction offer even if the offer is not accepted. Therefore, at step 282, the facilitator 150 may optionally debit the advertiser 148 for placement of a transaction offer 160. Alternatively, the facilitator 150 may automatically debit the advertiser a placement amount and adjust an additional amount debited upon user acceptance of the transaction offer based on the placement amount already debited. Upon debiting the advertiser 148, the facilitator 150 may retain the debit amount at step 282 to be used for any variety of purposes including, compensating the facilitator 150, compensating the merchant 140, customizing the transaction offer, and the like. The user 154 may accept the transaction offer 160 at a step 268. Subsequent to acceptance of the transaction offer by the user 154, the facilitator 150 may give the merchant 144 a credit 140 or payment at a step 272. At a step 274 the user may receive the benefit associated with the transaction offer 160 (such as receiving a coupon that may be redeemed in a future transaction). At a step 278 the facilitator 150 may retain a benefit, such as a credit, fee, or the like. At a step 280 the advertiser 148 may receive a debit 142 or make a payment (such payment/debit obligation being optionally triggered by the user's 154 acceptance of the transaction offer, the advertiser 148 having the opportunity to present the transaction offer 160, or other conditions).

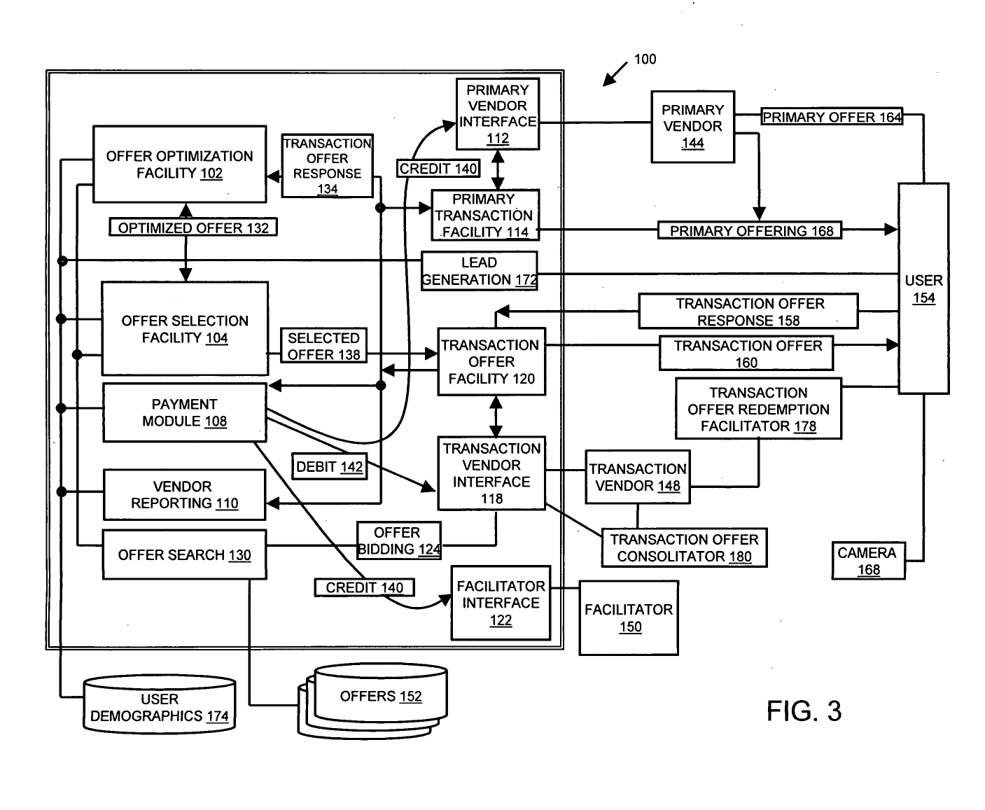

Referring to FIG. 3, additional details are provided with respect to optional components of a transaction offer platform 100 and various actions that may optionally take place in the context of such transaction offer platform 100. Such components and steps may include a facilitator 150, a primary vendor 144, a transaction offer offeror 148, a primary offer 164, a transaction offer 160, a debit 142, and a credit 140. Upon detection that a user 154 has accepted the transaction offer 160, a transaction the facilitator 150 may coordinate activities associated with authorizing delivery of an item 182 associated with the primary offer 164 and facilitating a credit 140. The transaction offer offeror 148 may make available, through the transaction offer platform 100, one or more transaction offers 160 for the user 154, which, with the assistance of the facilitator 150, may be associated with the primary offer 164. a transaction It should be noted that completion of a transaction offer 160 may result from varying degrees of engagement with the transaction offer 160. For example, completion may involve merely viewing the transaction offer 160 or accepting the transaction offer 160. In a preferred embodiment, the user 154 may receive the item 182 associated with the primary offer 164 independently of accepting the transaction offer 160. In this case, the user benefit described in FIG. 1 and FIG. 2 may be unrelated to a mechanism to allow the user 154 to receive, activate, extend or make permanent his use of the item 182 associated with the primary offer 164, such as and without limitation for the activation, extension, or permanent use thereof. In embodiments, the primary offer 164 may encompass any and all products or services. Any and all references to a “product” may, without limitation, refer to a product and/or service. Likewise, any and all references to a “service” may refer to a product and/or service.

A facilitator 150 may use a transaction offer consolidator 180 to assist with identification and consolidation of transaction offers 160. Such a consolidator 180 may be an advertising network manager, an advertisement placement manager, or similar party, or may use or comprise a software-based service for consolidating transaction offers 160 and may act on behalf of the offerors with regard to the transactional offer platform 100. Such a consolidator 180 may charge a fee for consolidating offers 160.

The primary vendor 144 may make available a primary offer 164 for download 104 or other delivery to the user 154 and may receive credit 140 once the user has accepted one or more transaction offers 160.

The credit 140 paid to the primary vendor 144 may include a fixed portion related to a retail cost or other cost such as a minimum primary offer 164 price. The credit 140 paid to the primary vendor 144 may include a variable portion related to a profit earned by the facilitator 150 from debit 142 by the transaction offer offeror 148. The variable amount may be based upon various factors, such as the number of primary offers 148 for which the facilitator 150 has arranged transaction offers 160, the economics associated with the transaction offers 160, and the like, or a percentage of the profit, for example. The price paid may be based on an estimated profit, an estimated debit 142, an actual profit, an actual debit 142, and other estimated or actual financial factors associated with the transactional offer platform 100, such as fees, transaction offer consolidator 180 charges, and the like. The credit 140 may be adjusted based on prior credits 140 and actual financial factors related to the primary vendor 144, primary offer 164, user 154, transaction offer offeror 148, transaction offer 160, other participants, and the like. In an example, a credit 140 may be reduced because a prior credit 140 paid to the primary vendor 144 was based on an estimated debit 142 that turned out to be higher than the actual debit 142.

The financial terms of a transactional offer transaction, such as the credit 140 to the primary offeror 144, the debit 142 to the transaction offer offeror 148, the amount retained by the facilitator 150, and the like may be determined by agreement between the facilitator 150 of the transactional offer platform 100, the transaction offer offeror 148 and the primary vendor 144 in advance of a transaction offer 160 being presented. However, the agreement may include variable pricing, wherein the amount paid may be determined at the time the transaction offer 160 is accepted (such as during the user 154 checkout process). This may allow a primary vendor 144 to differentiate pricing based on attributes of the user 154, such as geography (consumers in low GDP per capita countries pay less for the product/service than consumers in high GPD per capital countries) or user 154 credit worthiness (consumers with greater propensity to select higher-end offers will result in higher payments to the primary vendor 144 than consumers who select lower-end offers). The primary vendor 144 may elect to adjust the amount to be paid by the transactional offer platform 100 based on an aspect of the user 154.

The price paid may be based on an algorithm that may facilitate scalability of the platform. The algorithm may accept inputs related to the primary offer 164, the primary vendor 144, and the like. These inputs may introduce ambiguity, such as default versus custom payments and margin-based versus fixed-dollar payments, that may be resolved by logic associated with the algorithm. Aspects of offers and vendors may be classified to facilitate determining logic for resolving such ambiguity and for determining payment amounts. Offers may be classified as margin-based payments that may automatically base the margin on economies associated with the transaction offer 160, the transaction offer consolidator 180, and the like.

In certain optional embodiments, offers may be associated with margin-based payments that include customization on an offer-specific basis, or fixed-dollar payments, which may also include customization on an offer-specific basis. Vendor payment aspects that may impact the logic may be classified as a base case, wherein no additional vendor criteria are required to determine the payment. Other vendor classifications include non-standard aligned classifications, wherein a primary vendor 144 may define custom payment criteria while remaining aligned with a transaction offer 160 related payment paradigm; custom margins, wherein a primary vendor 144 defines a fully custom margin scheme that may be independent of transaction offer 160 or transaction offer offeror 148 related economies; and flat payout (fixed pricing), wherein a primary vendor 144 requires a fixed payment per transaction to facilitate avoiding impact on payments caused by other variables. These classifications are only exemplary and are not meant to be limiting. The algorithms, logic, classifications, and other aspects of primary vendor 144 payments should be considered extensible so that additional classifications may be introduced and supported. Resolution of the ambiguities herein described may be based, at least in part, on a rules table that may include offer parameters, vendor parameters, and the like. Additionally, the platform 100 may support fully customized payments that may be applied. Such customized payments may be configured to override or work in cooperation with the algorithms associated with payments.

Changes to primary vendor 144 payment rules may be incorporated into the rules tables, algorithms, customized payments, and the like. The following exemplifies one of many possible payment configurations.

Payment Table

| | Offer type | | |
|---|---|---|---|
| | Offer 1; Revenue $20 | | |
| | Transaction offer | Offer 2; Revenue $20 | Offer3; Revenue $90 |
| Vendor type | margin 20% | Custom margin 25% | Fixed payout $50 |
| Small Co; | $20 × 80% = $16 | $20 × 75% = $15 | $50 |
| Big Co; custom | $20 × 85% = $17 | $20 × 75% = $15 | $50 |
| margin 15% | | | |
| Strong Co; fixed | $20 × 90% = $18 | $20 × 90% = $18 | $90 × 90% = $81 |
| margin 10% | | | |
| Fixed Co; fixed | $10 | $10 | $10 |
| payment $10 | | | |

In the previous table, payment ambiguity is resolved by entries in the table, such as when offer type 2 custom margin overrides vendor Big Co custom margin, resulting in Big Co receiving $17 for offer 1, but only $15 for offer 2.

To facilitate an administrator of the platform 100, or a vendor accessing the platform 100 managing the payment algorithms, logic, rules, and the like, one or more of the following screens may be included in one or more interfaces of the platform 100: payouts for all offers associated with a specific vendor, payouts for all vendors associated with a specific offer, configuration of vendor rules and parameters, configuration of offer rules and parameters, override screen triggered by a change to an offer (e.g. a change to the offer classification), override screen triggered by a change to a vendor (e.g. a new vendor classification), offer record screen to create linkage with one or more of these screens, and vendor record screen to create linkage with one or more of these screens.

The payment module 108 may record indications of events associated with transaction offers 160, such as notifications that various activities have taken place respect to offers (such as viewing the transaction offers 160, acceptance of transaction offers 160, or redemption of transaction offers, such that upon occurrence of relevant events or activities, each primary vendor 144 may receive the credit 140 herein disclosed. The vendor payment facility may perform a financial payment transaction to a primary vendor 144 account, such as and without limitation a bank account, for an amount associated with any and all accumulated offer notifications. This financial payment transaction may occur upon offer notifications, from time to time, periodically, and so forth.

The debit 142 from the transaction offer offeror 148 may include a fixed portion related to the transaction offer 160 or related to the primary offer 164 with which the transaction offer 160 is associated. The fixed portion may be set by the transaction offer offeror 148 or the facilitator 150. The debit 142 may include a variable amount such as an amount based on the number of new users 154 who accept a transaction offer 160 with the transaction offer offeror 148. The variable amount may be based on a quality of the user 154 accepting the transaction offer 160. The quality of the user 154 may include a user characteristic such as a user demographic. Commission based transaction offers 160 may require an adjustable debit 142 wherein the amount debited from the transaction offer offeror 148 is calculated at the time the transaction offer 160 is presented or accepted. A credit 140 resulting from a commission based transaction offer 160 may also be variably based at least in part on the commission of the transaction offer 160. The payment module 108 may perform the calculations and issue the debit 142 and credit 140 accordingly.

The user 154 may be notified of the transaction offer 160 in a variety of ways. The way of notifying the user 154 may influence the likelihood of the user 154 completing the offer 160. Therefore it may be beneficial to include a plurality of ways of notifying the user 154 of the offer 160. However, it may not be beneficial in that the user 154 may disregard all subsequent offers after declining the first offer 160.

A user 154 may be notified of the transaction offer 160 on the primary vendor 144 payment webpage. This notification may be in lieu of or independent of a primary offer 164. The transaction offer platform 100 may enable users 154 to select a transaction offer 160, p in addition to other forms of payment.

The facilitator 150 may facilitate the display of transaction offers 160 in a multitude of ways, herein called touchpoints, in order to facilitate a transaction between the user 154, primary vendor 144 and advertiser 148. These touchpoints define the context in which the facilitator 150 may display or otherwise present the transaction offers 160 to the user 154 and by which the user 154 is encouraged to accept a transaction offer 160.

A webpage of a primary vendor 144 website may include a transactional offer button or other selectable element that may be placed on the page with equal, lesser, or greater prominence than a buy button. In an example of greater prominence, the transactional offer selection button may include animated graphics to attract a user's 154 attention. Lesser prominence may include placing the transactional offer selection button at the bottom of the web page along side contact or other selections that are not payment related. Equal prominence may include placing the buy button and the transactional offer button side by side with similar visual impact. The transactional offer selection may be presented in a wide range of combinations of position and visual prominence that include the above examples and many others. The prominence of the transactional offer selection may be specified in a contractual agreement between a facilitator 150 of the transactional offer platform 100 and a primary vendor 144. The prominence may be selected to meet a certain marketing objective. The prominence may alternatively be based on an aspect of the user 154 (such as a user preference) so that the transactional offer selection element is more appealing to the user 154. Independent of prominence, selection of the transactional offer element may result in a transaction offer 160 being presented to the user 154 as a transactional offer option.

The navigation alternatives herein described may be performed by aspects of the web page being viewed (such as HTML code) or by other software executing on the user 154 computing facility in association with the web browser (such as a plug-in, applet, browser menu, or the like). Although a web browser is described for viewing web pages of a primary vendor 144 web site, other web page access and display software, programs, devices, hardware, and services may also be used to display and navigate the web pages.

A user 154 may be notified of offers by configuring an RSS reader to deliver information related to primary offers 164 or primary vendors 144 being associated with transaction offers 160 or transaction offer offerors 148. In this way the user 154 may create a wish list of offer combinations and may be notified of published electronic information related to the combinations. The wish list may be created through a webpage of the transactional offer platform 100, or through RSS reader software.

Transaction offer transaction offers 160 may be associated with the primary offer 164, the primary vendor 144, or the user 154. A primary offer 164 or transaction offer 160 may be provided to a user 154 based on user 154 attributes such as demographics, geo-profile of comparable consumers, and the like. Based on information the user 154 provides to the facilitator 150 or the transaction offer offeror 148 while completing a transaction offer 160, the offer may be selected from an inventory of offers or dynamically generated. The offer may be based on a relevance to one or more user 154 demographics such as age, income, address, sex, profession, marital status, and the like. The offer may be selected to maximize the overall profit of the transaction based on a conversion rate, a payout amount and total volume of completed transaction offers 160 from all vendors associated with the transaction offer platform 100, and the like.

A transaction offer offeror 148 may be an advertiser, product supplier, service provider, market research firm, non-profit agency, educational institution, or any other entity that may benefit from a user 154 engaging with the transaction offer offeror 148 by completing a transaction offer 160. Since in certain optional embodiments the transaction offer offeror 148 may only pay the facilitator 150 for a completed transaction offer 160, the transaction offer offeror 148 can, in such cases have some improved confidence that the information provided by the user 154 is accurate, since the same information may be used to provide the primary offer 164. The transaction offer offeror 148 may also seek primary vendors 144 with which they may establish cross promotional arrangements. They may also seek primary vendors 144 with products that align with their own product objectives such that a user 154 of the primary vendor 144 product may have a greater likelihood of having an interest in the transaction offer 160.

The facilitator 150 may solicit or receive from the users 154 of primary offers 164 recommendations or suggestions for items or services of interest to the users 154. Such recommendations and suggestions may also be provided to the facilitator 150 by the primary vendor 144 on behalf of the users 154. Additionally or alternatively, the primary vendor 144 may provide to the facilitator 150 demographic and/or preference data. In embodiments, this data may be utilized by the facilitator 150 in targeting transaction offers 160 to users 154 so as to increase conversion rates for the primary vendor 144. The facilitator 150 may solicit primary vendors 144 and/or transaction offer transaction offer offerors 148 for such items or services. The facilitator 150 may coordinate the association of a primary offer 164 with a transaction offer 160 based on the suggestions or recommendations. The facilitator 150 may seek new primary vendors 144 and/or transaction offer offerors 148 to provide items or services based on the suggestions or recommendations.

A transactional offer platform 100 may include an offer optimization facility 102, which may select and/or create an optimized offer 132. Optimization of a transaction offer 160 may be based at least in part on one or more aspects of the transaction offer 160, a transaction offer offeror 148, a primary offer 164, a user 154, and timing associated with the transaction offer 160. A transaction offer 160 that is not accepted by a user 154 may not provide significant value to the transaction offer offeror 148, primary vendor 144, user 154, or facilitator 150. Therefore, transaction offers 160 may be optimized so they are relevant to the user 154 thereby increasing the likelihood of user 154 acceptance. Offer optimization may be based on an aspect of the transaction offer 160. The transaction offer 160 may include aspects such as approval terms, transaction offer 160 redemption value to the user 154, time to redeem a transaction offer 160, age restrictions to accept the transaction offer 160, residency requirements, and the like. One or more of these aspects may be combined so that a transaction offer 160 may be optimized on a combination such as age restrictions and transaction offer 160 redemption value to the user 154. In an example, a transaction offer 160 may be optimized based on approval terms. The approval terms of transaction offers 160 may be evaluated to determine which transaction offer 160 may provide the best approval terms. One transaction offer 160 may require approval based on an on-line credit scoring method that returns an approval decision to the user 154 in seconds. Another transaction offer 160 may require approval by an underwriting department that requires 10 days for an approval decision. In this example, the transaction offer 160 that returns an approval decision in seconds may be considered to be optimal as compared with the other transaction offer 160 because a user 154 is more likely to accept an offer with immediate feedback as compared with an offer that requires considerable time for approval. Offer optimization may also include combining one or more of these aspects with one or more aspects of the user 154, facilitator 150, primary vendor 144, primary offer 164, and transaction offer 160 timing. Certain combinations are exemplified elsewhere herein.

In another example, offer optimization may also be based on an aspect of the popularity of a transaction offer 160. Popularity optimization may be beneficial in that a more popular transaction offer 160 is likely to be frequently accepted, thereby providing value.

Optimization may be based on one or more aspects of a transaction offer offeror 148. The aspects of a transaction offer offeror 148 for optimization may include cross marketing arrangements, time for the transaction offer offeror 148 to pay the facilitator 150, amount the transaction offer offeror 148 pays the facilitator 150 for a transaction offer 160 acceptance, the number of potential transaction offers 160 from the transaction offer offeror 148, a traffic/payout plan, and the like.

Offer optimization based on aspects of the transaction offer 160 may be related to offer optimization based on the transaction offer offeror 148. As an example, a transaction offer offeror 148 may provide a plurality of transaction offers 160. This plurality of transaction offers 160 may be combinable so that payout tier traffic volume may be reached using a combination of transaction offer 160 acceptances. A transaction offer offeror 148 that permits combining transaction offers 160 to reach a payout tier increased payout may be optimized above a transaction offer offeror 148 that does not permit combining transaction offers 160. In this example, the transaction offers 160 of the transaction offer offeror 148 that can be combined may be presented before other transaction offers 160.

An offer may be optimized based on an aspect of a primary offer 164. Aspects of a primary offer 164 may include the class of primary offer 164, the list (or normal) price, the discounted price of the primary offer 164, and the like.

An offer may be optimized based on one or more aspects of a primary vendor 144. Aspects of a primary vendor 144 may include business affiliations between a primary vendor 144 and a transaction offer offeror 148, transaction offer 160 preferences or restrictions, the number of primary offers 164 available to the transactional offer platform 100 from the vendor, a volume discount threshold, and the like.

When primary offer 164 aspects and primary vendor 144 aspects are combined for optimization, transaction offers 160 may be selected that have a high relevance to a user 154 of a primary offer 164 and may more readily be accepted.

An offer may be optimized based on one or more aspects of a user 154. Aspects of a user 154 for optimization may include demographics, prior transaction offer 160 acceptance history, geographic region, browser type, internet connection speed, receipt history, prior transaction history, and the like.

An offer may be optimized based on one or more aspects of timing. Aspects of timing for optimization may include time until expiration of a transaction offer 160, duration of a transaction offer 160, a difference between the time to deliver the primary offer 164 and time to approve the transaction offer 160, and the like. Optimization of transaction offers 160 based on timing may include selecting a transaction offer 160 that expires sooner than one that expires later since the later expiring transaction offer 160 may be presented after the sooner expiring transaction offer 160 expires.

An offer may be optimized to maximize revenue (e.g. vendor revenue, platform revenue); to target users 154 based on user 154 demographics, user 154 behavior, user 154 interaction with the platform 100, and the like. Offer optimization may be unique for each transaction offer offeror 148, transaction offer 160, transaction offer consolidator 180, and other transaction offer related aspects such as offer terms, offer timing, and the like. Offer optimization may be dynamic so that it takes into account transaction offer offerors 148 who may be approaching a pricing threshold associated with transaction offer payouts to the platform 100. Offers may also be optimized to generate the highest quality leads for transaction offer offerors 148.

The offer optimization facility 102 may include access to one or more databases containing transaction offers 160, preferences, user 154 transaction history, demographics, and the like. The results of an optimization may be stored in one or more of the databases, delivered to the offer selection and display facility 104, or both.

Offer optimization may include one or more algorithms to facilitate optimizing offers. Optimization algorithms may include heuristic optimization algorithms, Markov decision processes, ranking techniques, steepest descent methods, conjugate gradient methods, and the like. In an example, non-gender-neutral offers based on the gender of the user may be selected through a Markov decision process. Offers relating to women's clothing may be optimized to be presented to female users, while offers relating to men's clothing may be optimized to be presented to male users.

Optimization may be performed locally for each vendor. It may also be performed across a plurality of vendors associated with the payment platform 100, so that the benefits of optimization may accrue to all parties associated with the platform 100.

An aspect of the transactional offer platform 100 may include an offer selection and display facility 104. The offer selection and display facility 104 may match an offer or offers to a user 154, match an offer or offers to a primary offer 164, match an offer to an optimization result, and the like. The offer selection and display facility 104 may also present offers. The offers may be presented based on location, based on an aspect of the offer, based on a user 154 preference, based on a primary vendor 144 preference, based on an optimization result, based on a transaction offer offeror 148 preference, and the like.

The offer selection and display facility 104 may select a plurality of offers to be presented to a user 154 based on the geographic location of the user 154. For example and without limitation, a user 154 located in the United States may be presented with a selection of offers that can be transacted in the United States, while a user 154 located in Canada may be presented with a selection of offers that can be transacted in Canada.

The offer selection and display facility 104 may facilitate a user's 154 viewing of any and all combinations of offers available through the transactional offer platform 100. When facilitating such viewing, the offer selection and display facility 104 may mark any and all offers that might not be valid for the user 154. This mark may involve italicizing text, graying out text or graphics, using an alternate visual representation to provide the offer, and so on.

In another example, the optimization facility may place optimized offers 132 into a results list or group of optimized offers 132. The selection facility may first access this results list or group when selecting one or more offers to present to a user 154. The selection facility may apply selection criteria as herein described to the optimized results list or group of offers. The selection facility may present none, some, or all of the offers in the optimization results list with none or some other offers.

The selection facility may arrange the offers for presentation to the user 154 so that optimized offers 132 are presented first or more prominently than non-optimized offers 132. In certain preferred embodiments, optimized offers 132 are presented in a list of offers, rather than one-by-one.

The selection facility may facilitate presenting the offers in an order or prominence that is relevant to the user 154. In an example, a user 154 may instruct the selection facility through a user 154 interface to arrange the offers so that the offers with the greatest relevance to the user 154 are presented first or more prominently. To the extent that a user 154 may be unknown to the transactional offer platform 100 when offers are presented, the user 154 may enter relevant information that may be used in the selection of offers. For example, the user 154 may be presented a list of interest areas from which they could select one or more. The selection facility may use this information to identify and present to the user 154 offers that are relevant to the user's 154 interests.

Alternatively, the user 154 may select to register with the transactional offer platform 100 so that each time the user 154 accesses the platform 100, the preferences, interests, and other information related to the user 154 can be applied to offer selection by the offer selection and display facility 104.

The selection facility may include an interface to the optimization facility, the payment module 108, and other modules and facilities of the transactional offer platform 100 as necessary. The selection facility may also include an interface to one or more databases containing offers, preferences, user 154 transaction history, demographics 174, and the like.

In certain preferred embodiments, the offer selection and display facility 104 may further include web pages for presenting aspects of the offer and or the transactional offer platform 100. The web pages may include user 154 interaction screens related to viewing, evaluating, selecting, and responding to a transactional offer 148 The offer selection and display facility 104 may allow a facilitator 150 to associate new transaction offers 160 with one or more primary vendors 144 so that a user 154 selecting to alternatively pay for the primary offer 164 may select the associated new transaction offer 160. The association may be based at least in part on pricing of the offer, geography, and primary vendor 144 preferences.

The offer selection and display facility 104 may also provide transaction offer 160 tracking so that a user 154 will not see and cannot accept two related transaction offers 160. In an example, a user 154 may accept a transaction offer 160 from Blockbuster from primary vendor A. Although the Blockbuster transaction offer 160 is available from primary vendor B, the user 154 may not be presented the Blockbuster transaction offer 160 through primary vendor B. In this way, the user 154 may not be presented offers that the user 154 cannot accept and the transaction offer offeror 148 does not have to deny the user's 154 acceptance of the transaction offer 160. This may also maintain the image and integrity of the transactional offer platform 100.

The transaction offer offerors 148 may provide variable payment for acceptance of a transaction offer 160 based on the quality of the user 154 engagement. An aspect of quality may be geography which may be represented by regional pricing. Offer selection, as may be performed through offer selection and display facility 104 may include regional pricing. Offer selection may be based at least in part on an aspect of the transaction offer offeror 148 payment terms as they relate to geography. Aspects of transaction offer offeror 148 payment terms that may affect payments to the platform 100 may include the user location, such as the user country, county, district, postal code, neighborhood, town, city, street, and the like. Offer selection with regional pricing may facilitate an administrator of the platform 100 to quickly and clearly select one or more offers that meet the applicable pricing and geographic constraints.

Offer selection and display facility 104 may include logic for selecting an offer based on location to support regional pricing. The logic may iterate through each user location associated with each potentially related offer and identify offers that target the user 154 location (e.g. country) and have an expected payout (pricing) greater than the minimum acceptable price agreed to by the primary vendor 144 for the primary offer 164. The logic may consider user location, offer availability in the user 154 location, pricing of offer in the user 154 location, primary offer 164 price, and other factors associated with offer selection and display facility 104 as described elsewhere herein. The logic may determine that an offer may not suitably meet selection criteria. In an example, the minimum acceptable price that primary vendor 144 has agreed to accept with respect to a primary offer 164 that is presented to a user 154 in the USA may be $8. In this case, any offer yielding less than this amount to the primary vendor 144 will not be displayed to the user 154.

The platform 100 may include an offers database 152. The offers database 152 may contain advertisements that may be offered to the user 154. The offers database 152 may be updated at regular interval with new offers provided by the advertisers for presentation to the user 154. The new offers may be presented to the user 154. In addition, the offers database 152 may include the procedures (e.g. programs built within the database using SQL procedures) for selection of advertisements from the database. An advertisement may be selected based on a pre-determined/identified criteria. For example, the repository 152 may be queried for a transactional advertisement based on an anticipated advertiser payout. The user 154 may promise to complete a transaction of $100. In this case, the platform 100 may query the offers database 152 for advertisement offers that are below 30% of the anticipated payout, i.e. less than $30 in the above example. In may be noted that the anticipated payout may be calculated in a number of ways such as total expected payout over a unit time, immediate payout, or a promise to complete the transaction after receipt of product and the like. For example, the user 154 may promise to pay the outstanding amount after the product is received. In this scenario the anticipated payout may be calculated using a predefined rule.

In embodiments, the current transaction with the primary merchant may provide the user 154 with a transaction offer that includes an incentive for completing the current transaction with the primary merchant. The transaction offer may be based on price, type of product, terms of payment, location, and type of credit card (master card or visa), customer loyalty, customer preferences, customer affiliation and the like of the first transaction. For example, the purchaser may enter into a transaction with the primary merchant and subsequently may be presented with the transaction offer. Since the user 154 has a long transaction history of purchasing products from another merchant Z, the user 154 may be presented with a transaction offer belonging to merchant Z.

In embodiments, the completion of the current transaction may allow access to user's history maintained in the user's demographic 174. As described herein and elsewhere, the user demographics 174 may include age, profession, transaction history, location, address, office address, and the like. In addition to the anticipated payout, the user 154 may be presented with a transactional offer that may completely or partially dependent on the user's demographics 174, in addition to the anticipated payout. The user may be presented with the transactional offer based on the completion of the last transaction. For example, the user 154 may be located in Ottawa in Canada and may have made a transaction of $90 with the platform 100. The platform 100 may spout a transaction advertisement to the user 154 for a discount of $10 on purchase of Pizza from the local pizza outlet. In this example, the transactional offer may be based both on the user's demographics (location of purchase) as well as the transactional payout.

In embodiments, the transactional offer presented to the user 154 as result of the last transaction may be based on the terms of the payment accepted by the user 154. As described above, the transaction offer may be presented to the user after the completion of the last transaction. The user 154 may select one of the following options: 100% advance; 50% advance and 50% at delivery of the product; 100% on delivery of the product or any other mutually agreed criteria between the user 154 and the merchant.

In addition, the transactional offer presented to the user 154 may at least be based on mutually accepted terms of payment. In embodiments, the platform 100 may query offers database 152 and select relevant offers to be presented to the user 154. For example, a 100% advance payment may reward user 154 with a free holiday tour to an amusement park; such an offer will be presented to the user 154 based on the total transaction value of the last committed transaction. In another embodiment, the platform 100 may maintain the purchase history of the user 154. Incentive for a volume of purchases and transactions done previously may be provided to the user 154 and the best offer available in the received bid may be selected for display overruling other rules in order to reward the user 154.

An advertiser may offer to payout an amount for one or more of presenting a transaction offer to a user and the user accepting a presented transaction offer. The payout amount may be anticipated based on a variety of factors that may include aspects of the transaction, such as an amount of a current transaction in which the transaction offer is being presented. An anticipated payout amount may be derived using any of the payout calculation or other methods and systems described herein and elsewhere. An anticipated payout amount may be an actual payout amount that is promised by or debited from a transaction offer offeror, such as in association with placement of a transaction offer or in association with an acceptance of a placed transaction offer.

Payout amounts and/or amounts debited from transaction offer offerors, advertisers and the like may be used for a variety of purposes, including, for example, selecting an offer, and other uses as described herein and elsewhere. In addition to these many uses, an anticipated payout amount may be used to customize a transaction offer to be presented to a user who is engaged in an electronic purchase transaction. Customizing a transaction offer may be facilitated by an anticipated payout in that a variable value of the transaction offer may be determined based on the anticipated payout. An anticipated payout may affect other aspects of a transaction offer including without limitation offer redemption value, offer duration, offer terms, offer flexibility, offer placement, offer presentation features, and the like. Customizing an offer based at least in part on an anticipated payout may impact offer redemption value in that offer redemption value may be determined as a percentage of the anticipated payout. An anticipated payout for placement and/or acceptance of a transaction offer may be determined based on factors described herein such as lifetime value of the user, geographic location of the user, and the like. Based on the determined anticipated payout, a transaction offer may be presented that reflects a redemption value that is some fraction or multiple of the anticipated payout amount.

In an example, a user located in a geographic location associated with very affluent consumers may be engaged with a primary vendor and may have committed to an electronic transaction with the vendor. The platform may determine candidate transaction offers to present to the affluent user based on a variety of factors (e.g. primary vendor guidelines or requirements). The platform may calculate an anticipated payout (which may include a range of payout values) from one or more advertisers (transaction offer offerors). The anticipated payout for one of the candidate offers that has a default redemption value of $20, may be $60 for transaction offer user acceptance but only $18 for transaction offer placement without acceptance. The platform may determine a likelihood of the user accepting the transaction offer to be 28% if the redemption value of the transaction offer is only $20 with higher redemption values resulting in higher likelihood of acceptance. The platform may consider other factors and then customize the one candidate offer to have a $30 redemption value. Therefore presenting the offer to the user provides a 100% chance of the platform will receive $18 for placement. However, a customized transaction offer redemption value of $30 may have a much greater chance that the offer will be accepted by the user, so that the platform (or a facilitator of the platform) may receive a portion of the $60 acceptance payout that is greater than the placement only payout of $18. By customizing the transaction offer to have a higher redemption value of $30, the platform has ‘spent’ $10 to increase the likelihood that the user will accept the transaction offer. Therefore the platform has increased the chances that presenting the customized offer will result in the advertiser paying the acceptance amount of $60. In this way, the platform may increase the likelihood of receiving $50 profit instead of just $18 for presenting the transaction offer. The platform would not receive all $60 of the advertiser acceptance payout as profit because the platform has contributed $10 to the redemption value.

In another example of transaction offer customization, an advertiser may offer $11 to place a transaction offer and the transaction offer may have an adjustable redemption value in the range of $10-$25 based on other factors associated with at least one of the transaction, the user, the primary vendor, the item being purchased, a monthly transaction offer acceptance goal, and the like. The transaction offer acceptance anticipated payout may be $30 and may be independent of the redemption value of the transaction offer. The platform, or an aspect of the platform that may operate as part of the platform or as part of the advertiser environment or both, may consider these and/or other factors related to the transaction and may present the transaction offer with a value within the redemption value range. In an example in which an advertiser has already reached a monthly transaction offer acceptance goal, the platform may utilize this information, and other transaction, user, or vendor information and present a transaction offer near the low end of the range, such as $12. Alternatively, if the advertiser has not yet reached a monthly offer acceptance goal, the platform may customize the transaction offer based at least in part on the advertiser monthly offer acceptance goal status and present a transaction offer with a redemption value of $24.

Other examples of customized transaction offers may include adjusting an offer redemption period, requiring the user to use the same form of payment when redeeming the transaction offer as is used in the current transaction, using a specific form of payment, and the like.

A user 154 interface associated with the platform 100 such as the primary vendor interface 112, the transaction offer offeror interface 118, the facilitator interface 122, and the like may include offer selection related input. In an optional example, the platform 100 interface may facilitate displaying offers based on a target user 154 location, an actual user 154 location, and the like. A user 154 target location may include North America which may include the US mainland, portions of Mexico, Canada, Puerto Rico, and the like. Therefore targeting North America may display only those offers that are valid in the geographic regions associated with the target location. Offer selection may be based at least in part on pre-defined offer groups as may be presented through a template that may be based at least in part on a vendor, industry, geography, and the like.

The transactional offer platform 100 may include a payment module 108. The payment module 108 may facilitate transactions associated with payments related to the transactional offer platform 100. The payment module 108 may maintain payment records. The payment records may be maintained permanently such as in one or more databases of the transactional offer platform 100. The payment module 108 may track a user 154 interaction with an accepted offer in such a way that the accepted offer is associated with a transaction offer offeror 148, a primary vendor 144, a user 154, and a primary offer 164. The payment module 108 may facilitate processing accepted offer approval notifications from the transaction offer offeror 148 so that payments can be processed. It should be noted that a variety of conditions may result in an offer 160 being completed. In some cases, any engagement by a user 154 with the offer 160 may be sufficient to complete the offer 160, ranging from viewing the offer 160 to accepting the offer to redeeming the transaction offer 160. An accepted offer may or may not require approval by the transaction offer offeror 148 in order to be completed, and in cases where approval is required, the acceptance of the offer 160 may or may not in fact be approved by the transaction offer offeror 148. Thus, only some accepted offers require approval. Such may be the case, for example, for offers that involve user 154 payments or credit approval. An accepted offer that requires approval becomes a completed offer once a transaction offer offeror 148 approves the accepted offer. In some cases the transaction offer offeror 148 may not approve an accepted offer and, consequently, the accepted offer may be vacated. In other cases any accepted offer is completed. It should be noted that while in some cases there is a distinction between accepted offers and completed offers, in many cases an accepted offer, a completed offer, or an engagement by the user 154 with the transaction offer offeror 148 are equivalent in the methods and systems disclosed herein; therefore, references to each of these terms should be understood to encompass, in various alternative embodiments, the others, except where context depends on the distinctions described here.

The payment module 108 may process payments associated with offers of the transactional offer platform 100. To process a payment, the payment module 108 may include receiving notification or an indication of the user 154 viewing a transaction offer 160, accepting an offer, receiving electronic payment (or record of electronic payment) from the transaction offer offeror 148, sending electronic payment to the primary vendor 144, sending payment to the facilitator 150, and the like.

The payment module 108 may process a payment associated with a transaction offer offeror 148. The payment module 108 may access a database or other storage of transaction offer offeror 148 payment information such as a fixed amount and a variable amount associated with a transaction offer offeror 148 payment. The payment module 108 may use this information for verifying the transaction offer offeror 148 payment. The payment module 108 may also determine an amount owed by the transaction offer offeror 148 and may issue a debit 142 to the transaction offer offeror 148 for the determined amount. The payment module 108 may determine this for each accepted offer or may determine it on an aggregation of accepted offers as often a once per hour, day, week or other time period. The payment module 108 may process an electronic payment received from the transaction offer offeror 148 in one or more portions such as a fixed portion and a variable portion. The payment module 108 may verify a fixed portion includes an amount related to an agreed payment for each accepted offer approval. The payment module 108 may verify the transaction offer offeror 148 electronic payment includes a variable amount such as an amount based on the number of new users 154 who accept a transaction offer with the transaction offer offeror 148. The payment module 108 may access a database or other storage of transaction offer offeror 148 payment information such as the fixed amount and the variable amount for use in verifying the transaction offer offeror 148 payment. The payment module 108 may record the transaction offer offeror 148 payment in a permanent record such as one or more databases of the transactional offer platform 100.

The payment module 108 may process primary vendor 144 payments associated with an accepted offer. The payment module 108 may process a payment to be made to the primary vendor 144 that includes one or more portions such as a fixed portion and a variable portion. The payment module 108 may access a database of primary vendor 144 payment information to determine the fixed and/or variable portion of a primary vendor 144 payment. The payment module 108 may process records associated with the primary vendor 144 such as related profit earned by the facilitator 150, number of accepted offers and accepted offer approvals associated with the primary vendor 144, and the like to determine the fixed portion and/or the variable portion to be paid to the primary vendor 144. The payment module 108 may determine an amount owed to the primary vendor 144 for each accepted offer or may determine the amount owed on an aggregation of accepted offers as often a once per hour, day, week or other time period. The payment module 108 may record the primary vendor 144 payment in a permanent record such as one or more databases of the transactional offer platform 100.

The payment module 108 may facilitate processing a payment associated with a user 154. The payment module 108 may send a payment to a user 154 (such as to a user's 154 bank account or other electronic account). The payment module 108 may receive payment from a user 154 (such as from a user's 154 bank account, credit card or other electronic account). The payment module 108 may record the user 154 payment in a permanent record such as one or more databases of the transactional offer platform 100. The payment module 108 may facilitate processing both transaction offers as well as traditional payment processing (such as with a credit card). In embodiments, processing may facilitate a blended or hybrid payment, with a component of traditional payment and a component of transaction offer. In such a “blended” or “hybrid” payment transaction, the payment module 108 may be used in a two-part (or multi-part) transaction; thus, in one part the payment is via a traditional payment method (such as a credit card), while in another part the payment is via the transactional offer platform 100. The payment module 108 may send a payment to a user 154 (such as to a user's 154 bank account or other electronic account). The payment module 108 may receive payment from a user 154 (such as from a user's 154 bank account, credit card or other electronic account). The payment module 108 may record the user 154 payment in a permanent record such as one or more databases of the transactional offer platform 100.

The transactional offer platform 100 may include vendor reporting 110. Vendor reporting 110 may facilitate collection, compilation, delivery, and presentation of information related to a vendor's association with the transactional offer platform 100. Vendor reporting 110 may include reporting related to a primary vendor 144, a transaction offer offeror 148, a facilitator 150, a primary offer 164, or the like. Vendor reporting 110 may include reporting related to payments, offer traffic, user 154 information such as demographics, and the like. Vendor reporting 110 may collect information from other elements of the transactional offer platform 100 including one or more databases such as a transaction database. Vendor reporting 110 may be performed based on a schedule (such as each day, week, month, quarter, etc.), based on an event, based on a request, and the like. Aspects of vendor reporting 110 may be performed based on different factors. For example, collection and compilation may be performed on a schedule or with each transaction, while delivery or presentation may only be performed on a schedule or when requested.

Vendor reporting 110 may include reports relating a primary offer 164 to one or more transaction offers 160. For example, a report may include a list of transaction offers 160 made to users 154 of the transactional offer platform 100 who commit to purchase a primary offer 164. The report may include results from a plurality of users 154 purchasing the primary offer 164 through the transactional offer platform 100. The list may show each transaction offer completed, the number of times users 154 selected each offer, the number of users 154 who accepted each offer, the number of offer approvals, and other information relevant to assessing a relationship between a primary offer 164 and one or more transaction offers.

Primary vendors 144 may receive reports from vendor reporting 110 that show payments and transactions such as a listing of each transaction and the associated payment sent to the primary vendor 144. The report may include subtotals for primary offers 164, calendar periods, transaction offer offerors 148, and the like.

Transaction offer offerors 148 may receive reports from vendor reporting 110 related to offer performance. As described elsewhere herein a user 154 may be presented with a plurality of transaction offers 160. The user 154 may select any transaction offer 160 presented to view details of the transaction offer 160 and the transactional offer platform 100 may record the order of detail view selections made by the user 154. A report may indicate the number of times a transaction offer 160 was selected for detail viewing first, second, third, and so forth. This report may be useful to the transaction offer offeror 148 in preparation of transaction offers 160 to make them more attractive to the user 154, thereby improving the transaction offer 160 selection position. A transaction offer offeror 148 may also be interested in a relationship of a transaction offer 160 detail view selection order to acceptance of the transaction offer 160 by the user 154.

Vendor reporting 110 may be useful to a facilitator 150 of the transactional offer platform 100. The facilitator 150 may receive reports comparing transaction offer offerors 148. Transaction offer offerors 148 may be compared on a variety of aspects including payments, payment rate, payment time, comparison of payment data to payment terms, and the like. A vendor report that indicates a first vendor generates higher revenue than a second vendor may be useful to a facilitator 150 in managing services provided to the vendors.

Vendor reporting 110 may be useful to a facilitator 150 in managing aspects of the transactional offer platform 100 such as offer optimization and offer selection. A report that indicates a completed offer for a first primary offer 164 (such as virus protection software) is generating a preferred level of payments from the transaction offer offeror 148. The facilitator 150 may prefer to adjust the offer optimization or offer selection so that the offer is displayed to users 154 purchasing a second primary offer 164 (such as video editing software).

Vendor reporting 110 may also include reports on transaction and viewing activity based on a source of user traffic. Sources of user traffic may include websites, web pages, checkout screens, email, product nag screens, on-line shopping cart abandonment event, and the like. Information such as quantity of user transactions sourced from the traffic source, amount of revenue generated per source, and the like. User traffic source reports may be beneficial to a vendor in assessing the user sourcing strategies so that they vendor can make adjustments to potentially improve revenue.

Vendor reporting 110 may also include reporting capability associated with a self service tier for primary vendors 144, transaction offer offerors 148, and the like. Vendor reporting 110 may include transaction lists, transaction detail, transaction integrity model display, totals by week, month, touch point, and the like. Reporting 110 may include payment records, pending payments, mix of pending and complete payments, credit extensions, mix of offers, and the like. Extended reporting based on vendor defined variables, aggregating categories underlying transactions, conversion rates, and the like may also be included in vendor reporting 110. Conversion rate metrics may be reported based on aspects such as revenue per visit, revenue per user, number and rate of converted users, and the like. Reporting 110 may also include various reports on user 154 traffic sources and/or statistics associated with traffic sources. Traffic related reports may include presenting information and analysis associated with touch points before the sale, after the sale, during the sale, by email, by website, by intra-product nag screens and messages, physical world sources, mobile users, and metrics such as vendor performance metrics.

A transactional offer platform 100 may include a primary vendor interface 112. The primary vendor interface 112 may interconnect with other aspects of the transactional offer platform 100 such as a primary transaction facility 114, the payment module 108, and the like. The primary vendor interface 112 may facilitate a vendor interacting with the transactional offer platform 100. A primary vendor 144 may access the transactional offer platform 100 through one or more web sites or web pages of the primary vendor interface 112. The primary vendor interface 112 may include a welcome guide that may guide a vendor setting up an account and interacting with the transactional offer platform 100. The vendor may enter information such as primary offer 164 descriptions, primary offer 164 pricing, offer preferences and restrictions, pricing adjustments based on geographic location, pricing adjustments based on a temporary sale, pricing volume discounts, payment account information, vendor reporting 110 requirements, user 154 information, vendor contact information such as an email address, checkout page URLs, checkout page transactional offer options, payee bank details such as bank account number, contact preference information, minimum acceptable price for a completed transaction offer 160 that relates to a primary offer 164, and the like. The primary vendor interface 112 may provide web pages that facilitate a primary vendor 144 viewing and exporting reports generated by vendor reporting 110.

The primary vendor interface 112 may provide security and access controls for employees such as requiring a primary vendor 144 to log in using a user name and/or password to access the transactional offer platform 100.

In an example of another aspect of the primary vendor interface 112, the primary vendor 144 may correspond with a facilitator 150, a transaction offer offeror 148, a user 154, and the like through a communication aspect of the primary vendor interface 112. In embodiments, the primary vendor interface 112 may be provided as an application programming interface, a service-oriented architecture, or any and all other machine-machine interfaces.

The primary vendor interface 112 may be embodied as an automatic service, such as and without limitation according to a service-oriented architecture or any other computing architecture. In an example, a primary vendor 144 may dynamically configure the minimum acceptable price associated with a primary offer 164 during a transaction offer transaction. In this way, the primary vendor 144 can dynamically configure the payment platform 100 to meet certain business needs such as profit margin etc.

The primary vendor interface 112 may support a primary vendor 144 requesting approval of changes to an aspect of a primary offer 164 such as a minimum price to be paid to the primary vendor 144. The primary vendor interface 112 may be adapted to automatically approve some changes, such as email address, while requiring manual approval, such as by a facilitator 150 for other changes like pricing details, targeted geographies, and the like.

A transactional offer platform 100 may include a primary transaction facility 114. The primary transaction facility 114 may interconnect with other aspects of the transactional offer platform 100 such as a primary vendor interface 112, an accepted offer, a transaction offer transaction facility 120, a primary offer 164, user 154, and the like. The primary transaction facility 114 may include processing transactions associated with a primary offer 164, an accepted offer, an approved accepted offer, and a user 154.

The primary transaction facility 114 may interface with the primary vendor interface 112 to exchange information related to a primary offer 164. The information exchanged may include information such as a user 154 name and email, user 154 ID, a primary offer 164 identifier, serial number, revision, options, activation or authorization code, URL (such as a link to a licensed copy of a primary offer 164), and order ID of the current user 154 transaction. This information may provide support to primary vendors 144 offering primary offers 164 that are not downloadable and/or are not serialized. This information may also facilitate the primary vendor 144 easily and securely fulfilling a user 154 order of the primary offer 164. In response to a user 154 accepting an offer (or an accepted offer being approved by the transaction offer offeror 148), the primary transaction facility 114 may send information to the user 154 such as an activation code, or primary offer 164 URL so that the user 154 may complete a transaction to acquire the primary offer 164. The primary transaction facility 114 may receive a list of primary offer 164 authorization codes or URLs and may select, according to rules associated with the list, a code or URL to be sent to the user 154. The primary transaction facility 114 may track and record the codes or URLs selected from the list so that they are not duplicated or improperly used. The information sent from the primary transaction facility 114 to the user 154 may facilitate a user 154 acquiring or using an item 182 associated with a primary offer 164.

The primary transaction facility 114 may receive a notification of an accepted transaction offer 160. The notification of an accepted transaction offer 160 may be conditionally based on one or more aspects of the transaction offer 160. A conditionally accepted offer may need approval by the transaction offer offeror 148 to be authorized. The primary transaction facility 114 may provide a notification to the user 154 associated with the conditional acceptance. The primary vendor interface 112 may also receive payment requests, such as requests for credit 140 associated with a transaction, or with a plurality of transactions.

The transactional offer platform 100 may include a transaction offer offeror interface 118 such as may be used by a transaction offer offeror 148. The transaction offer offeror interface 118 may interconnect with other aspects of the transactional offer platform 100 such as a transaction offer transaction facility 120, the payment module 108, a transaction offer offeror 148 and other aspects such as a facilitator interface 122, or one or more databases of the transactional offer platform 100.

The transaction offer offeror interface 118 may facilitate a vendor interacting with the transactional offer platform 100. A transaction offer offeror 148 may access the transactional offer platform 100 through one or more web sites or web pages of the transaction offer offeror interface 118. The transaction offer offeror 148 may enter information such as offers, offer descriptions, offer pricing, offer preferences and restrictions, pricing adjustments based on geographic location, pricing adjustments based on a temporary sale, pricing volume discounts, payment account information, vendor reporting 110 requirements, user 154 information, and the like. The transaction offer offeror interface 118 may provide web pages that facilitate a transaction offer offeror 148 viewing and exporting reports generated by vendor reporting 110.

The transaction offer offeror interface 118 may also facilitate a transaction offer offeror 148 providing offer graphics, text, URLs, web pages that may be displayed on a web browser as part of presenting transaction offers 160 to users 154. The transaction offer offeror interface 118 may also facilitate a transaction offer offeror 148 providing rules or guidelines associated with offers that may be related to offer optimization or offer selection. The transaction offer offeror interface 118 may also receive payment requests, such as a debit 142 associated with an offer transaction, or with a plurality of transactions.

The transaction offer offeror interface 118 may provide security such as requiring a transaction offer offeror 148 to log in using a user name and/or password to access the transactional offer platform 100.

In an example of another aspect of the transaction offer offeror interface 118, the transaction offer offeror 148 may correspond with a facilitator 150, a primary vendor 144, a user 154, and the like through a communication aspect of the transaction offer offeror interface 118.

The transaction offer offeror interface 118 may be embodied as an automatic service, such as and without limitation according to a service-oriented architecture or any other computing architecture.

A transaction offer offeror 148 may use a transaction offer offeror interface 118 to interact directly with the transactional offer platform 100. The transaction offer offeror interface 118 may be used to activate, configure, manage and monitor an account on the transactional offer platform 100. The transaction offer offeror interface 118 may display leads generated, advertising statistics, commissions paid, and the like. The transaction offer offeror interface 118 may facilitate automatic transaction importing, whereby offers are batched together and processed according to rules setup by the transaction offer offeror 148. In an example, certain transactions may contain multiple payment components based on whether a user 154 provides additional value to the transaction offer offeror 148 by further engaging with the transaction offer offeror 148 such as by continuing to make use of the transaction offer 160 after an initial trial period.

A transactional offer platform 100 may include a transaction offer transaction facility 120. The transaction offer transaction facility 120 may interconnect with other aspects of the transactional offer platform 100 such as a transaction offer offeror interface 118, one or more selected transaction offer(s) 138, such as selected from a wider range of potentially relevant transaction offers 160, an accepted transaction offer 160, a user 154, and the like. The transaction offer transaction facility 120 may include processing transactions associated with selected offer(s) 138, an accepted transaction offer 160, a user 154, and the like.

The transaction offer transaction facility 120 may interface with the transaction offer offeror interface 118 to exchange information related to an offer. The information exchanged may include information such as a user name and email, an offer identifier, serial number, revision, options, activation or authorization code, URL (such as a link to an authorized offer). In response to a user 154 accepting a transaction offer 160 (or an accepted offer being approved by the transaction offer offeror 148 in cases where approval is required), the transaction offer transaction facility 120 may send information to the user 154 such as an activation code, or URL so that the user 154 may access to activate the transaction offer 160.

The transaction offer transaction facility 120 may include one or more web sites or web pages associated with presenting transaction offers 160 to users 154 of the transactional offer platform 100. The web pages may also facilitate a user 154 evaluating, selecting and completing a transaction offer 160 from a plurality of transaction offers 160 selected by the offer selection and display facility 104. A user 154 may, through one or more web pages of the transaction offer transaction facility 120, browse and review transaction offers 160 and accept a transaction offer 160. The transaction offer transaction facility 120 may provide the accepted offer information to the transaction offer offeror interface 118 for purposes of facilitating the transaction offer offeror 148 receiving a user's 154 transaction offer 160 acceptance.

The transaction offer transaction facility 120 may, through the one or more web pages complete the transactions associated with a transaction offer 160 so that the transaction offer offeror 148 is only notified of the transaction and delivered the relevant user 154 information (including payment information).

The transactional offer platform 100 may include a universal shopping cart that displays to the user 154 aspects of the current transactions such as the primary offer 164, the primary vendor 144, the natural or primary vendor price for the primary offer 164, the transaction offer 160, a status of the transaction offer 160, a payment method, and the like. The universal shopping cart may display, such as through a web browser, a plurality of primary offers 164 selected by the user 154 along with selected transaction offers 160, and other relevant information.

The transaction offer transaction facility 120 may be embodied as an automatic service, such as and without limitation according to a service-oriented architecture or any other computing architecture.

The transactional offer platform 100 may include a facilitator interface 122. The facilitator interface 122 may facilitate a facilitator 150 interacting with the transactional offer platform 100. The facilitator interface 122 may include one or more web sites or web pages, RSS feeds, and the like. A facilitator 150 may setup and maintenance the transaction offer platform 100 through the facilitator interface 122. The facilitator interface 122 may facilitate viewing and controlling one or more transactional offer platforms 100. The facilitator interface 122 may provide web pages that facilitate a facilitator 150 viewing reports generated by the transactional offer platform 100 such as may be generated by vendor reporting 110. In an example of another aspect of the facilitator interface 122, the facilitator 150 may correspond with a primary vendor 144, a transaction offer offeror 148, a user 154, other facilitators 150, and the like through a communication aspect of the facilitator interface 122.

A facilitator 150 may manage aspects of the transactional offer platform 100 through the facilitator interface 122. For example, the facilitator 150 may configure aspects of the transactional offer platform 100 such as the transaction offer transaction facility 120, the payment module 108, and other aspects such as the facilitator interface 122 or one or more databases of the transactional offer platform 100. The facilitator interface 122 may provide web pages through which a facilitator 150 may establish user names and passwords and associate access rights such as access controls to aspects of the transactional offer platform 100 to the user names.

The facilitator interface 122 may provide security and access control such as requiring a facilitator 150 to log in using a user name and/or password to access the transactional offer platform 100.

The facilitator interface 122 may be embodied as an automatic service, such as and without limitation according to a service-oriented architecture or any other computing architecture.

The facilitator interface 122 may facilitate a facilitator 150 sending email to users 154, primary vendors 144, transaction offer offerors 148, and any other user or participant in the transactional offer platform 100. In an example, the facilitator interface 122 may include a list of system issued emails and a ‘re-send’ button that, when selected by the facilitator 150, automatically resends a selected email to one or more participants.

The facilitator interface 122 may also provide system integrity and rules checking capabilities so that a facilitator 150 may test the transactional offer platform 100. Rules such as minimum credit amount a primary vendor 144 will accept may be violated as aspects of the system change dynamically (such as a transaction offer offeror 148 changing offer terms). A manual or automatic integrity check to verify transactions are meeting the rules may be beneficial to the primary vendor 144.

The transactional offer platform 100 may also include demo or dummy offers, vendors, and payment models that can be used to test “end-to-end” transactional offers.

The transactional offer platform 100 may include communications between elements of the platform 100. The communications may include information such as data associated with optimized offers 132, selected offers 138, accepted transaction offers 160, debits 142, credits 140, configuration, reporting, correspondence, and the like. The communication may be a result of an action, event, request, schedule or other aspect of the transactional offer platform 100. Communication may include any form of electronic communication such as email, messaging, text messaging, voice mail, e-commerce transaction, file transfer, database transfer, HTTP, TCP/IP, and other types of communication modes, formats, and content. Communication associated with the transactional offer platform 100 may include security aspects such as encoding, encrypting, password protection, SSL, VPN, and other security measures to facilitate protecting communication.

Communications associated with the transactional offer platform 100 may include optimized offers 132. Optimized offers 132 may be communicated between at least an offer optimization facility 102 and an offer selection and display facility 104. Optimized offer 132 communication may include information related to optimization of offer alternatives as may be performed by the offer optimization facility 102 as herein described. In an example, the offer optimization facility 102 may communicate one or more offers that meet one or more optimization criteria such as conversion rate or profitability. The one or more optimized offers 132 may be communicated to the selection facility for inclusion in an offer selection process. The optimized offer 132 communication may include prioritization criteria associated with various aspects of the optimized offer 132 so that the selection facility may include the relevant prioritization criteria in the selection process.

In embodiments an optimized offer 132 may be communicated by the selection facility as a selected offer(s) 138 to the transaction offer transaction facility 120.

Communications associated with the transactional offer platform 100 may include selected offers 138. Selected offers 138 may be communicated between at least an offer selection and display facility 104 and a transaction offer transaction facility 120. Selected offers 138 communication may include one or more selected offers 138. The selected offers 138 may be communicated to the transaction offer transaction facility 120 based on an event, a request, a schedule, or other aspect associated with selecting an offer. The selection facility may send a selected offer(s) 138 communication when a user 154 accesses the transactional offer platform 100 to acquire a primary offer 164 from a primary vendor 144. In such a situation, the selection facility may communicate a list of selected offers 138 that the transaction offer transaction facility 120 may present to the user 154. The selected offer(s) 138 communication may include HTML representing the selected offers 138. The selected offer(s) 138 communication may include a link or URL to HTML, XML, or other electronic representation of the selected offer(s) 138. A selected offer 138 may be communicated by the transaction offer transaction facility 120 as becoming an accepted transaction offer 160 based on a user 154 interaction with the transaction offer transaction facility 120.

Communications associated with the transactional offer platform 100 may include a transaction offer response 134. Communication to respond to a transaction offer 160 may occur among at least the transaction offer transaction facility 120, the primary transaction facility 114, the offer optimization facility 102, the payment module 108, vendor reporting 110, other aspects of the platform 100 such as one or more databases, and the like. Communicating a transaction offer response 134 may include information associated with at least one transaction facilitated by the transaction offer transaction facility 120. The transaction offer platform 100 may provide a user 154 with a status of whether a transaction offer 160 has been completed, such as whether the user 154 has completed all actions necessary for engaging with the transaction offer offeror 148, accepting a transaction offer 160, or the like, or whether an accepted offer has been approved by the transaction offer offeror 148, in cases where approval is required.

A transaction offer response 134 communication may include an acceptance of a transaction offer 160. The information may include data such as an offer, user 154 identifying information, a primary offer 164, and the like. The information may also include data relevant to the offer evaluation and selection actions associated with the accepted transaction offer 160. Such data may include identification of the accepted transaction offer 160 as pending approval of a transaction offer offeror 148, time until approval, number of offers reviewed by the user 154 before accepting the transaction offer 160, and the like.

Communicating the accepted transaction offer 160 may occur in real-time between at least the transaction offer transaction facility 120 and the primary transaction facility 114 so that the user 154 may be provided the primary offer 164 associated with accepting the transaction offer 160. As an example, a user 154 may receive a primary offer 164 of a software program download contingent upon the user 154 accepting a transaction offer 160. The user 154 may review one or more transaction offers 160 such as may be presented by the transactional offer platform 100, and accept one. Upon completion of the user 154 acceptance of the transaction offer 160, which may be facilitated by the transaction offer transaction facility 120, the communication between the transaction offer transaction facility 120 and the primary transaction facility 114 may occur. As herein described, the primary transaction facility 114 may receive the communication and provide the user 154 with information about accessing and activating a primary offer 164. The offer optimization facility 102 may receive a communication indicating completion of the transaction offer 160. The information associated with the communication may be included in subsequent offer optimizations. The offer optimization facility 102 may process the information resulting in an indication, for example, that a transaction offer 160 is popular. The communication may also include information about other transaction offers 160 related to the accepted transaction offer 160. The other transaction offer 160 information may be processed to determine their popularity (or lack of popularity). The offer optimization facility 102 may use the information included with and associated with the completed transaction offer communication 158 in any manner of offer optimization as herein described.

The payment module 108 may receive a transaction offer communication 158, such as a communication that an offer has been completed. The payment module 108 may use the communication to identify one or more debits 142 and credits 140 associated with the completed transaction offer 160. Each debit 142 and/or credit 140 may be identified by the communication directly, indirectly, or a combination thereof. In an example, the transaction offer communication 158 may directly identify the transaction offer offeror 148 and the debit 142 amount to be charged to the transaction offer offeror 148 in connection with a completed transaction offer 160. The communication may also include a primary offer 164 reference or identifier that the payment module 108 may use to access the relevant primary vendor 144, credit information, user 154 information, and the like from one or more databases. To account for transaction associated errors, the payment module 108 may support charge backs. Charge backs may facilitate recovering credits 140 or adjusting debits 142 for a transaction offer offering 170 failure. The transactional offer platform 100 may perform a charge back if the transactional offer platform 100 does not receive the debit 142 amount charged to the transaction offer offeror 148. The total charge back may appear as a reduction in a future credit 140 to a primary vendor 144. The total charge back may appear as a fee to the primary vendor 144. Vendor reporting module 110 may provide reports of transaction activity, including fulfillment errors and charge backs to primary vendors 144, transaction offer offerors 148, the facilitator 150, and any other participant or regulatory agency legally authorized to review financial transactions of the transactional offer platform 100.

Vendor reporting facility 110 may receive a transaction offer communication 158 indicating completion of a transaction offer 160. Vendor reporting 110 may use the communication to generate one or more vendor reports or other reports as herein described. The communication may trigger one or more actions associated with vendor reporting 110 such as compiling data for vendor reporting 110 and others as herein described.

A transaction offer communication 158 may include any communication about transaction offer(s) 160 among the facilitator 150, transaction offer offeror(s) 148, and users 154. In one embodiment, such a transaction offer communication 158 may include a search criteria as provided by a user 154. The search criteria may include one or more keywords, primary vendors 144, products, transaction offer offerors 148, services, payment amounts, payment types, and the like. The search criteria may be used by the transactional offer platform 100 to search one or more databases to identify one or more offers having a relevance to one or more aspects of the search criteria. The transactional offer platform 100 may present, such as through the transaction offer transaction facility 120, the one or more identified offers to a user 154.

The transaction offer response 134 may include user 154 preferences, opinion, votes, or the like related to one or more transaction offers 160. The transactional offer platform 100 may use these and other aspects of transaction offer communications 158 to facilitate optimizing offers such as through the offer optimization facility 102.

Communications associated with the transactional offer platform 100 may include credit communications. Credit communication may occur among the payment module 108, a facilitator interface 122, a primary vendor interface 112, vendor reporting 110, and the like. Credit communication may include information such as credit 140 amount, identifiers for a transaction, user 154, primary offer 164, primary vendor 144, transactional offer platform 100, facilitator 150, payment plan, and the like. A credit communication may include information that may facilitate an electronic financial transfer between two financial entities. For example, a credit 140 transaction may include an authorization code with which a primary vendor 144 may withdraw an amount identified in the credit communication from a financial account associated with the transactional offer platform 100. In another example, a credit communication may be an email with a link such as a URL that, when accessed allows a receiver of the email to accept a payment into a PayPal (or similar) account.

A credit communication may occur as a result of an event (such as an accepted transaction offer 160 communication), an action (such as a facilitator 150 instructing the payment facility to issue a credit 140), a schedule (such as a monthly minimum payment), a request (such as a primary vendor 144 requesting a credit 140), or other aspect of the transactional offer platform 100.

A facilitator interface 122 may receive a credit communication. The facilitator interface 122 may receive a notification that a credit 140 has been accrued or deposited. The credit 140 may be associated with an accepted transaction offer 160. The credit 140 may also be associated with a fee of the transactional offer platform 100. In an example of such a fee, the transactional offer platform 100 may require a fee be paid by a primary vendor 144 to establish an account with the platform 100. A fee may be charged to a transaction offer offeror 148 based on an offer presentation volume, an offer acceptance volume, a number of offers, and the like. The credit communication may indicate the source of the credit 140, the amount, and the time of the credit 140. The credit communication may alternatively indicate that a credit 140 is due (or will soon be due) to the facilitator 150 so that the facilitator 150 as the option to take action regarding the credit 140 due.

A primary vendor interface 112 may receive a credit communication. The primary vendor interface 112 may receive a notification that a credit 140 has been accrued or deposited. The credit 140 may be associated with an accepted transaction offer 160. The credit 140 may also be associated with a fee of the transactional offer platform 100. In an example of such a fee, the transactional offer platform 100 may issue a credit 140 of a required a fee based on an aspect of the business being conducted with the transactional offer platform 100. A fee may be credited back to a primary vendor 144 based on primary offer 164 volume, an offer acceptance volume associated with a transaction offer 160 or a primary offer 164, a number of primary offers 164, and the like. The credit communication may indicate the source of the credit 140, the amount, and the time of the credit 140. The credit communication may alternatively indicate that a credit 140 is due (or will soon be due) to the primary vendor 144 so that the primary vendor 144 has the option to take action regarding the credit 140 due.

Communications associated with the transactional offer platform 100 may include debit communication. Debit communication may occur among a payment module 108, a transaction offer offeror interface 118, and other aspects of the transactional offer platform 100. Debit communication may include information such as debit 142 amount, identifiers for a transaction, user 154, transaction offer 160, transaction offer offeror 148, transactional offer platform 100, facilitator 150, payment plan, and the like. A debit communication may include information that may facilitate an electronic financial transfer between two financial entities. For example, a debit 142 transaction may include an authorization code with which a transaction offer offeror 148 may deposit an amount identified in the credit communication to a financial account associated with the transactional offer platform 100. In another example, a debit communication may be an email with a link such as a URL that, when accessed allows a receiver of the email to deposit a debit 142 into a PayPal account.

A debit communication may occur as a result of an event (such as an accepted transaction offer 160 communication), an action (such as a facilitator 150 instructing the payment facility to issue a debit 142), a schedule (such as a monthly minimum payment request), a request (such as a requesting a transaction offer offeror 148 requesting to pay a debit 142), or other aspect of the transactional offer platform 100.

A transaction offer offeror interface 118 may receive a debit communication. The transaction offer offeror interface 118 may receive a notification that a debit 142 has accrued. The debit 142 may be associated with an accepted transaction offer 160. The debit 142 may also be associated with a fee of the transactional offer platform 100. In an example of such a fee, the transactional offer platform 100 may issue a debit 142 for a required a fee based on an aspect of the business being conducted with the transactional offer platform 100. A fee may be debited from transaction offer offeror 148 based on transaction offer 160 volume, an offer acceptance volume, a number of transaction offers 160, and the like. The debit communication may indicate the source of the debit 142 request, the amount, and the due date of the debit 142. The debit communication may alternatively indicate that a debit 142 is due (or will soon be due) so that the transaction offer offeror 148 has the option to take action regarding the debit 142 owed.

The transactional offer platform 100 may include one or more primary vendors 144. Each primary vendor 144 may be uniquely identified by the transactional offer platform 100 so that credits 140, transactions, and the like associated with each primary vendor 144 may be tracked by the transactional offer platform 100. The unique identifier of a primary vendor 144 may be generated by the transactional offer platform 100 when the primary vendor 144 registers.

A primary vendor 144 may make available one or more primary offers 164 such as products or services. The primary vendor 144 may associate one or more products or services with the transactional offer platform 100 to facilitate a user 154 acquiring the product or service through the transactional offer platform 100. Such an association may establish a primary offer 164 of the transactional offer platform 100.

A primary vendor 144 may identify limits of use associated with a primary offer 164. The limits of use may relate to the transactional offer platform 100. The transactional offer platform 100 may, through the primary transaction facility 114 for example, based at least in part on the limits of use, contact a user 154 on a primary vendor's 144 behalf to acquire the product or service using the transactional offer platform 100.

The primary vendor 144 may receive, such as through the primary vendor interface 112, information associated with a transaction offer 160 transaction and a primary offer 164. The primary vendor 144 may evaluate the received information to determine if the primary vendor 144 should send authorization of a primary offer 164 to the transactional offer platform 100 through the primary vendor interface 112 so that the primary transaction facility 114 can execute the primary offer 164 with the user 154.

The primary vendor 144 may execute a primary offer 164 directly with a user 154. The primary vendor 144 may execute the offering through one or more web pages, emails, messages, texts, calls, letters, packages, and the like.

The primary vendor 144 may include one or more websites or web pages independent of the transactional offer platform 100. One or more of the web pages may be associated with the transactional offer platform 100. The primary vendor 144 may be responsible for maintaining any or all web pages that associate the primary vendor 144 product or service offers with the transactional offer platform 100. Alternatively, the primary vendor 144 may only maintain a link to web pages associated with the transactional offer platform 100 and the facilitator 150 may be responsible for maintaining any or all associated web pages.

A primary vendor 144 may establish cross promotional arrangements with transaction offer offerors 148. The primary vendor 144 may notify the transactional offer platform 100 of the cross promotional arrangement through the primary vendor interface 112.

The primary vendor 144 may interact with users 154 directly, such as through a primary offer 164. The primary vendor 144 may alternatively interact with users 154 indirectly through the transactional offer platform 100, such as through a primary offer 164. The mode of interaction may be indistinguishable to the user 154 so that the user 154 may perceive that the primary vendor 144 is directly interacting with them at all times.

The transactional offer platform 100 may include one or more transaction offer offerors 148. Each transaction offer offeror 148 may be uniquely identified by the transactional offer platform 100 so that debits 142, transactions, and the like associated with each transaction offer offeror 148 may be tracked by the transactional offer platform 100. The unique identifier of a transaction offer offeror 148 may be generated by the transactional offer platform 100 when the transaction offer offeror 148 registers.

A transaction offer offeror 148 may make available one or more transaction offers 160 to users 154 through the transactional offer platform 100. The transaction offer offeror 148 may associate one or more products or services with transaction offers 160 of the transactional offer platform 100 to facilitate a user 154 acquiring the product or service through the transactional offer platform 100. Such an association may establish a transaction offer 160 on the transactional offer platform 100.

A transaction offer offeror 148 may identify limits of use, terms of approval, payment terms, and the like associated with a transaction offer 160. The limits of use, terms of approval, and payment terms may relate to the transactional offer platform 100. In an example, the transactional offer platform 100 may, through the transaction offer transaction facility 120 and based at least in part on limits of use, contact a user 154 on a transaction offer offeror's 148 behalf to facilitate acquiring the product or service associated with the transaction offer 160 by using the transactional offer platform 100.

The transaction offer offeror's 148 association with the transactional offer platform 100 may encompass a variety of interactions. An example of one interaction may include a transaction offer offeror 148 making available a product or service for download or other delivery to the user 154. The transaction offer offeror 148 may send payment to the transactional offer platform 100 once the transactional offer platform 100 notifies the transaction offer offeror 148 that the user 154 has accepted one or more transaction offer (transactional offer) offers 160. The transaction offer offeror 148 may pay the transactional offer platform 100 an amount specified by the transaction offer offeror 148 or agreed by the transaction offer offeror 148 and transactional offer platform 100 facilitator 150.

The transaction offer offeror 148 may receive, such as through the transaction offer offeror interface 118, information associated with a user 154 acceptance of a transaction offer 160 transaction. The transaction offer offeror 148 may evaluate the received information to determine if the transaction offer offeror 148 should authorize the user 154 acceptance of the transaction offer 160 so that the transaction offer transaction facility 120 can execute the transaction offer 160 with the user 154.

The transaction offer offeror 148 may execute a transaction offer 160 directly with a user 154. The transaction offer offeror 148 may execute the transaction offer 160 through one or more web pages, emails, messages, texts, calls, letters, packages, and the like.

The transaction offer offeror 148 may include one or more websites or web pages independent of the transactional offer platform 100. One or more of the web pages may be associated with the transactional offer platform 100. The transaction offer offeror 148 may be responsible for maintaining any or all web pages that associate the transaction offer offeror 148 product or service transaction offers 160 with the transactional offer platform 100. Alternatively, the transaction offer offeror 148 may only maintain a link to web pages associated with the transactional offer platform 100 and the facilitator 150 may be responsible for maintaining any or all associated web pages.

A transaction offer offeror 148 may establish cross promotional arrangements with primary vendors 144. The transaction offer offeror 148 may notify the transactional offer platform 100 of the cross promotional arrangement through the transaction offer offeror interface 118.

The transaction offer offeror 148 may interact with users 154 directly, such as through a transaction offer 160. The transaction offer offeror 148 may alternatively interact with users 154 indirectly through the transactional offer platform 100, such as through a transaction offer 160. The mode of interaction may be indistinguishable to the user 154 so that the user 154 may perceive that the transaction offer offeror 148 is directly interacting with them at all times.

The transaction offer offeror 148 may be an advertiser, promoter, or other entity interested in establishing connections with new customers. The transaction offer offeror 148 may also be a primary vendor 144 in relation to the transactional offer platform 100. In this way a primary offer 164 may be presented to a user 154 as a transaction offer 160. In an example, a vendor may provide pet products. The user 154 may be acquiring dog food and may be offered to receive the dog food for a transactional offer. The transactional offer may be an offer by the vendor to purchase a new type of dog shampoo, join a mailing list, sign up for a credit card account with the vendor, and the like.

In the preceding example the transactional offer platform 100 may be embodied within an electronic commerce infrastructure of the vendor. Such an embodiment may facilitate the vendor taking advantage of the methods and systems of the transactional offer platform 100 as herein described without having to route electronic commerce through a separate platform. Such an embodiment may be licensed by the vendor from the facilitator 150. The vendor may pay the facilitator 150 a fee for the licensing. The fee may be based on a one time fee, unit pricing, average product cost, offer presentation volume, number of primary 164 and transaction offers 160 supported, calendar time, and any number of other aspects of the vendor business or the transactional offer platform 100.

In embodiments, without limitation, the transactional offer platform 100 may be provided as a service, such as and without limitation according to a service-oriented architecture or any other computing architecture. Use of the service may or may not be associated with a fee, such as and without limitation an access fee, service fee, transaction fee, and the like.

The transactional offer platform 100 may include one or more facilitators 150. Each facilitator 150 may be uniquely identified by the transactional offer platform 100 so that debits 142, transactions, and the like associated with each facilitator 150 may be tracked by the transactional offer platform 100. The unique identifier of a facilitator 150 may be generated by the transactional offer platform 100 when the facilitator 150 registers with the platform 100.

A facilitator 150 may identify limits of use, terms of approval, payment terms, and the like associated with the transactional offer platform 100. In an example, the transactional offer platform 100 may, through one or more interfaces or transaction facilities contact a participant on a facilitator's 150 behalf to facilitate a debit 142, credit 140, or other transaction associated with the transactional offer platform 100.

The facilitator's 150 association with the transactional offer platform 100 may embody a variety of interactions. The interactions may include setup and maintenance of the transaction offer platform 100, viewing and controlling one or more transactional offer platforms 100, viewing reports generated by the transactional offer platform 100 such as may be generated by vendor reporting 110, corresponding with a primary vendor 144, a transaction offer offeror 148, a user 154, or other facilitators 150.

The facilitator 150 may manage aspects of the transactional offer platform 100 through a facilitator interface 122. For example, the facilitator 150 may configure aspects of the transactional offer platform 100 such as the transaction offer transaction facility 120, the payment module 108, and other aspects such as the facilitator interface 122 or one or more databases of the transactional offer platform 100. A facilitator 150 may establish user names and passwords and associate access rights to aspects of the transactional offer platform 100 to the user names.

The facilitator 150 may receive payment from the transactional offer platform 100. The payment may be a result of a transaction offer offeror 148 making a payment, a vendor paying a fee, and the like. The transactional offer platform 100 may credit 140 a facilitator 150 an amount specified by a vendor or agreed by the vendor and the facilitator 150.

The facilitator 150 may receive, such as through the facilitator interface 122, information associated with a vendor registration request. The facilitator 150 may evaluate the received information to determine if the vendor should be authorized to participate in transactional offer platform 100.

The facilitator 150 may contact a participant of the transactional offer platform 100. The facilitator 150 may execute the contact through one or more web pages, emails, messages, texts, calls, letters, packages, and the like.

The facilitator 150 may include one or more websites or web pages independent of the transactional offer platform 100. One or more of the web pages may also be associated with the transactional offer platform 100. The facilitator 150 may be responsible for maintaining any or all web pages that associate the facilitator 150 with the transactional offer platform 100. Alternatively, the facilitator 150 may only maintain a link to web pages associated with the transactional offer platform 100 and the transactional offer platform 100 may be responsible for maintaining any or all associated web pages.

A facilitator 150 may establish cross-promotional arrangements with primary vendors 144, transaction offer offerors 148, other facilitators 150, other transactional offer platforms 100, transaction offer redemption facilitators 150, offer consolidators, and the like. The facilitator 150 may notify the transactional offer platform 100 of the cross promotional arrangement through the facilitator interface 122.

The facilitator 150 may be an advertiser, promoter, or other entity interested in establishing connections with new customers. The facilitator 150 may also participate in the transactional offer platform 100 as one or more other participants as herein described.

The transactional offer platform 100 may include one or more users 154. Each user 154 may be uniquely identified by the transactional offer platform 100 so that payments, transactions, and the like associated with each user 154 may be tracked by the transactional offer platform 100. The unique identifier of a user 154 may be generated by the transactional offer platform 100 when the user 154 registers.

A user 154 may accept one or more primary offers 164 such as products or services. The user 154 may acquire one or more products or services with the transactional offer platform 100 to facilitate acquiring the product or service, thereby establishing a primary offer 164 of the transactional offer platform 100.

A user 154 may accept limits of use associated with a primary offer 164. The limits of use may relate to the transactional offer platform 100. The user 154 may, through the primary transaction facility 114 for example, based at least in part on the limits of use, contact the transactional offer platform 100 to acquire the product or service from the primary vendor 144.

The user 154 association with the transactional offer platform 100 may embody a variety of interactions. Examples of user 154 interactions may include transactions and other interactions as herein described. User 154 interactions with the transactional offer platform 100 may be associated with a primary transaction facility 114, a transaction offer transaction facility 120, a primary offer 164, a transaction offer 160, and the like.

The user 154 may receive, such as through the transaction offer transaction facility 120, information associating a transaction offer 160 with a primary offer 164. The user 154 may evaluate the received information to determine if the user 154 should accept the transaction offer 160. The user 154 may further interact with the transactional offer platform 100 to search for a transaction offer 160 based at least in part on a search criteria. In an example, the user 154 may access a web page of the transaction offer transaction facility 120 and enter offer search criteria such as keywords. The transactional offer platform 100 may search one or more databases of offers to identify one or more offers that match an aspect of the search criteria. The user 154 may review these identified offers and may select zero or more of them.

The user 154 may execute a primary offer 164 directly with a primary vendor 144. The user 154 may execute the offering through one or more web pages, emails, messages, texts, calls, letters, packages, and the like associated with the primary vendor 144 or the transactional offer platform 100.

The user 154 may interact with other participants of the transactional offer platform 100 such as vendors, facilitators 150, and the like. The mode of interaction may be indistinguishable to the user 154 so that the user 154 may perceive that the participant is directly interacting with them.

The user 154 may be an individual, couple, family, business, non-profit, government agency, government office, public official, and the like.

Aspects of the user 154 may include communications. The communications may be associated with the transactional offer platform 100, a primary vendor 144, a transaction offer offeror 148, and the like. The communications may include voice, data, images, text, and the like. User 154 voice communication may include voice mail, voice calls, voice recognition, voice prompting, voice responses, and the like. Services and products associated with a primary offer 164 or a transaction offer 160 may be delivered by voice communication. User data communication may include user names, passwords, security codes, financial data, numerical data, and the like. Services and/or products associated with a primary 164 or transaction offer 160 may be delivered by data communications. User image communication may include product and service images, diagrams, installation drawings, user images, document images, electronic signatures, and the like.

Aspects of user 154 communication may include a transaction offer response 134 such as a user 154 acceptance of a transaction offer 160. A user 154 transaction offer response 134 may include user 154 preferences, opinion, votes, or the like related to one or more transaction offers 160. The transactional offer platform 100 may use these and other aspects of transaction offer communications 158 to facilitate optimizing offers such as through the offer optimization facility 102.

A user 154 may communicate a transaction offer response 134 in response to the transactional offer platform 100 presenting one or more selected offers 138 to the user 154. A user 154 may alternatively communicate a transaction offer response 134 in response to a communication by the transactional offer platform 100, a primary vendor 144, a transaction offer offeror 148, or the like requesting user 154 input. Such a communication request may include a transaction offer 160 that the user 154 may accept in exchange for the user 154 input.

A user 154 communication may include a transaction offer 160. A user 154 transaction offer 160 communication may include presentation of one or more transaction offers 160. Such communication may occur through a website or web pages presented to a user 154 web browser. Web pages associated with a transaction offer 160 user 154 communication may include web pages for evaluating and selecting an offer. The web pages may include a screen in which a vendor makes an item available, a product confirmation screen, a help screen, a user 154 contact input screen, a default screen of offerings, a list of all offerings screen, a category or country filter menu, an offer selection confirmation screen, and the like. The user 154 transaction offer 160 communication may include images, text, data, voice, and any combination thereof.

The transactional offer platform 100 may include a primary offer 164. The primary offer 164 may be any combination of a product, service, information, discount, gift certificate, loan, financial equity, real-estate, futures contract, membership, lottery entry, vacation, and the like. The primary offer 164 may be represented by a physical item such as a book, a non-physical item such as electronic content (e.g. computer game, image, password), and the like. The value of the primary offer 164 may be determined based on a market valuation or may be set by the primary vendor 144. However, the primary offer 164 value may be unknown such as with a lottery ticket that may be worthless (a losing ticket), moderate value (small winning), or large value jackpot winner).

The primary offer 164 may include limits such as use limits associated with the offer. Use limits of a primary offer 164 may be related to an aspect of the offer such as time, quantity of uses, functionality, output, accuracy, advertising, and the like.

A primary offer 164 may include one or more of a Book, DVD, Magazine & Newspaper, Music, Textbook, Video download, VHS, Apparel & Accessories, Jewelry & Watches, Shoes, Computer, Office, Software, Audio & Video, Camera & Photo, Cell Phone & Service, Computer & Video Game, Musical Instrument, Generally, Consumer Electronics, Food, Gourmet Food, Grocery, Pet Supply, Beauty, Heath & Personal Care, Bed & Bath, Furniture & Décor, Home Improvement, Kitchen, Domestic/Home, Outdoors, Garden, Baby, Toy & Game, Exercise & Fitness, Sports & Outdoors, Automotive, Industrial & Scientific, Tools & Hardware, Fresh Flowers & Indoor Plants, Regular Sale Item, Outlet Sale Item, Daily Special Items, Utility, Movies, audiobooks, a media subscription (e.g. a movielink.com subscription or the like), music tracks, music collections, virtual goods such as credits, and the like.

A primary offer 164 may include a service such as Accounting, Computer, Consulting, Dating/Match-making, Other Professional, and the like.

A primary offer 164 may include a type of offer such as Specialty Good, Unsought Good (e.g. something that requires a hard sell), Perishable Good, Durable Good, Non-Durable or Consumable Good, Capital Good, Parts and Materials, Supplies and Services, Commodities, By-primary offers 164, and the like.

A primary offer 164 may be associated with a Gift, Baby Registry, e-Card, Gift Certificate, Shopping List, Wedding Registry, Wish List, Media Library, Associate Program, Affiliate Program, Subscription, Web store, Networking site (based on “interests”), Search Query, a blog, or the like.

A primary offer 164 may be associated with a promotion such as Advertising, Sales Promotion, Publicity, Personal selling, Internet promotion, In-store (e.g. voucher & special offers), Loyalty card offer, Competition (in-store, on packaging, or online), Packaging, Press, TV advertising, Radio, Cinema advertising, Poster/Billboard, Pop-up advertising, Podcast advertising, Email offer, Blog advertising, and the like.

The primary offer 164 may include office and personal electronics products; computers such as desktops, notebooks, tablet PCs, personal digital assistants (PDA), servers, workstations, fax servers, internet-cache servers, barebones systems, POS/kiosk systems; monitors & displays such as CRT monitors, LCD monitors, plasma monitors, projectors; printers such as color laser, mono laser, ink-jet, photo printers, multifunction units, dot-matrix, plotters, label printers, bar code printers, specialty printers, receipt printers, scanners, point-of-sale printer; software such as antivirus software, business software, development tools, education & entertainment, graphics & publishing, internet software, network management software, OS & utilities, security; electronics such as digital cameras, film cameras, camcorders, security cameras, games, digital media players, televisions, home audio, home video, home furniture, GPS, telephony, appliances, office equipment; networking such as adapters, client, communications, conferencing, hubs, infrastructure, KVM switches, modems, routers, security, software, switches, test equipment, wireless; storage devices such as CD drives, CD-DVD duplicators, CD-DVD servers, DVD drives, fibre channel switches, flash drives, floppy drives, hard drives, magneto-optical drives, media, network attached storage, removable drives, SAN equipment, storage enclosures, tape automation, tape drives; accessories such as cables, memory, flash memory, power & surge protection, computer components, audio hardware, video hardware, keyboards & mice, batteries, carrying cases, computer accessories, printer supplies, CD-DVD accessories, monitor & display accessories, mounting hardware, camera-camcorder accessories, PDA accessories, network accessories, projector accessories, scanner accessories, computer furniture, phone, cellular accessories, office & cleaning supplies, and so forth.

The primary offer 164 may also include AV supplies & equipment, basic supplies & labels, binders & accessories, janitorial, business cases, calendars & planners, custom printing, desk accessories, executive gifts, filing & storage, paper, forms, envelopes, pens, pencils & markers, printer & fax supplies, promotional products, school supplies, phones & accessories, or other products found in office, school, or home environments.

The primary offer 164 may include items such as groceries, produce, cuts of meat, deli products, health and beauty products, clothing, towels, pillows, artwork, models, tableware, collectibles, antiques, potted plants, financial instruments such as bonds, certificates of deposit, currency, and the like.

A transaction offer 160 may include a trial of downloaded media. The downloaded media may include movies, movie trailers, movie collections, still photos, slide shows, audio books, electronic books (e-books), music, music tracks, music collections (albums), and the like. A trial of the downloaded media may include a license for a user 154 to use the downloaded media for a limited time, or may include access to a portion of the downloaded media (such as a portion of a movie). Another form of trial of downloaded media may include a chapter of an audio book or e-book, an issue of a periodical publication, and so on.

A primary offer 164 may be delivered by download, file sharing, FTP access, email, email attachment, messaging, phone call, streaming audio, streaming video, and the like. A primary offer 164 may be delivered in installments such as chapters, sections, and the like. Primary offer 164 installments may be delivered on a schedule, based on an event, upon request, by default, and the like. A primary offer 164 may be a physical item or items, or it may be a digital item or items.

A physical primary offer 164 may be delivered to an address. The address may be specified by the user 154. The delivery may be by common carrier, US mail, courier, freight, and the like. The delivery may be subject to terms such as shipping charges, shipping times, and the like. A physical primary offer 164 may include compatibility limits such as a physical size, weight, a computer memory size, a computer disk storage size, a computer operating system, a computer browser, and any other attribute or aspect of a computing facility.

The transactional offer platform 100 may include a primary offer 164. A primary offer 164 may facilitate a user 154 acquiring, accessing, receiving, activating, or otherwise using a primary offer 164. A primary offer 164 may result in activating, extending, or making permanent a use of the primary offer 164. In an example, a primary offer 164 may allow a user 154 to use a product (e.g. software) or a service (e.g. access to an investment advice website) for a limited time. As a result of accepting a transaction offer 160, a user 154 of the transactional offer platform 100 may receive through a primary offer 164, a copy of the software that does not have a time limit, or a password to allow permanent access to the investment website. Although the example here is for the user 154 to receive a primary offer 164 that makes the use of the primary offer 164 permanent, other types of use extension and activation may also be included in the primary offer 164. The password may provide a one year membership to the investment website, allowing the user 154 to access the investment website for 12 months. The software may be useable permanently but support or updates may be limited to 90 days. Many other primary offerings 168 may be apparent from these examples and are included herein.

A primary offer 164 may facilitate acquiring a primary offer 164. A user 154 may use the transactional offer platform 100 when accepting a primary offer 164, such as when performing an ecommerce transaction to acquire, lease, or temporarily use the primary offer 164. The primary offer 164 may provide information to the user 154 that may allow a user 154 to acquire the primary offer 164. Such information may include a proof of purchase, an in-store pickup authorization, a payment authorization, a certificate redeemable for the primary offer 164, a credit 140 to an account, and the like. The transaction offer 160 may further provide a refund of the primary offer 164 purchase price to the credit 140 account. The primary offer 164 may include information confirming the purchase price being charged to the credit 140 account and the refund.

In another example, the primary offer 164 may include primary offer 164 package shipment confirmation and tracking information. The shipping information in the primary offer 164 could facilitate a user 154 receiving the primary offer 164. If the primary offer 164 is a gift for another individual from the user 154, the primary offer 164 could represent a confirmation of shipment of the gift.

A primary offer 164 may be communicated to the user 154 by the primary vendor 144, the transactional offer platform 100, or a combination thereof.

The transactional offer platform 100 may include a transaction offer 160. The transaction offer 160 may be any combination of a product, service, information, discount, gift certificate, loan, financial equity, real-estate, futures contract, membership, lottery entry, vacation, and the like. The transaction offer 160 may be represented by a physical item such as a book, a non-physical item such as electronic content (e.g. computer game, image, password), and the like. The value of the transaction offer 160 may be determined based on a market valuation or may be set by the transaction offer offeror 148. However, the transaction offer 160 value may be unknown such as with a lottery ticket that may be worthless (a losing ticket), moderate value (small winning), or large value (jackpot winner).

The transaction offer 160 may include limits such as use limits associated with the offer. Use limits of a transaction offer 160 may be related to an aspect of the offer such as time, quantity of uses, functionality, output, accuracy, advertising, and the like.

A transaction offer 160 may include one or more of a Book, DVD, Magazine & Newspaper, Music, Textbook, Video download, VHS, Apparel & Accessories, Jewelry & Watches, Shoes, Computer, Office, Software, Audio & Video, Camera & Photo, Cell Phone & Service, Computer & Video Game, Musical Instrument, Generally, Consumer Electronics, Food, Gourmet Food, Grocery, Pet Supply, Beauty, Heath & Personal Care, Bed & Bath, Furniture & Décor, Home Improvement, Kitchen, Domestic/Home, Outdoors, Garden, Baby, Toy & Game, Exercise & Fitness, Sports & Outdoors, Automotive, Industrial & Scientific, Tools & Hardware, Fresh Flowers & Indoor Plants, Regular Sale Item, Outlet Sale Item, Daily Special Item, Utility, Movies, audio books, a media subscription (e.g. a movielink.com subscription or the like), music tracks, music collections, and the like.

A primary offer 164 may include a service such as Accounting, Computer, Consulting, Dating/Match-making, Other Professional, and the like.

A transaction offer 160 may include a type of offer such as Specialty Good, Unsought Good (e.g. something that requires a hard sell), Perishable Good, Durable Good, Non-Durable or Consumable Good, Capital Good, Parts and Materials, Supplies and Services, Commodities, By-primary offers 164, and the like.

A transaction offer 160 may be associated with a Gift, Baby Registry, e-Card, Gift Certificate, Shopping List, Wedding Registry, Wish List, Media Library, Associate Program, Affiliate Program, Subscription, Web store, Networking site (based on “interests”), Search Query, a blog, or the like.

A transaction offer 160 may be associated with a promotion such as Advertising, Sales Promotion, Publicity, Personal selling, Internet promotion, In-store (e.g. voucher & special offers), Loyalty card offer, Competition (in-store, on packaging, or online), Packaging, Press, TV advertising, Radio, Cinema advertising, Poster/Billboard, Pop-up advertising, Podcast advertising, Email offer, Blog advertising, and the like.

The transaction offer 160 may include office and personal electronics products; computers such as desktops, notebooks, tablet PCs, personal digital assistants (PDA), servers, workstations, fax servers, internet-cache servers, barebones systems, POS/kiosk systems; monitors & displays such as CRT monitors, LCD monitors, plasma monitors, projectors; printers such as color laser, mono laser, ink-jet, photo printers, multifunction units, dot-matrix, plotters, label printers, bar code printers, specialty printers, receipt printers, scanners, point-of-sale printer; software such as antivirus software, business software, development tools, education & entertainment, graphics & publishing, internet software, network management software, OS & utilities, security; electronics such as digital cameras, film cameras, camcorders, security cameras, games, digital media players, televisions, home audio, home video, home furniture, GPS, telephony, appliances, office equipment; networking such as adapters, client, communications, conferencing, hubs, infrastructure, KVM switches, modems, routers, security, software, switches, test equipment, wireless; storage devices such as CD drives, CD-DVD duplicators, CD-DVD servers, DVD drives, fibre channel switches, flash drives, floppy drives, hard drives, magneto-optical drives, media, network attached storage, removable drives, SAN equipment, storage enclosures, tape automation, tape drives; accessories such as cables, memory, flash memory, power & surge protection, computer components, audio hardware, video hardware, keyboards & mice, batteries, carrying cases, computer accessories, printer supplies, CD-DVD accessories, monitor & display accessories, mounting hardware, camera-camcorder accessories, PDA accessories, network accessories, projector accessories, scanner accessories, computer furniture, phone, cellular accessories, office & cleaning supplies, and so forth.

The transaction offer 160 may also include AV supplies & equipment, basic supplies & labels, binders & accessories, janitorial, business cases, calendars & planners, custom printing, desk accessories, executive gifts, filing & storage, paper, forms, envelopes, pens, pencils & markers, printer & fax supplies, promotional products, school supplies; phones & accessories, or other products found in office, school, or home environments.

The transaction offer 160 may include items such as groceries, produce, cuts of meat, deli products, health and beauty products, clothing, towels, pillows, artwork, models, tableware, collectibles, antiques, potted plants, financial instruments such as bonds, certificates of deposit, currency, and the like.

A transaction offer may include a trial of downloaded media. The downloaded media may include movies, movie trailers, movie collections, still photos, slide shows, audio books, electronic books (e-books), music, music tracks, music collections (albums), and the like. A trial of the downloaded media may include the user 154 receiving a license to use the downloaded media for a limited time, may include access to a portion of the downloaded media (such as a portion of a movie), and so on. Another form of trial of downloaded media may include a chapter of an audio book or e-book, an issue of a periodical publication, and the like.

A transaction offer 160 may be delivered by download, file sharing, FTP access, email, email attachment, messaging, phone call, streaming audio, streaming video, and the like. A transaction offer 160 may be delivered in installments such as chapters, sections, and the like. Transaction offer 160 installments may be delivered on a schedule, based on an event, upon request, by default, and the like. A transaction offer 160 may be a physical item or items, or it may be a digital item or items.

A physical transaction offer 160 may be delivered to an address. The address may be specified by the user 154. The delivery may be by common carrier, US mail, courier, freight, and the like. The delivery may be subject to terms such as shipping charges, shipping times, and the like. A physical transaction offer 160 may include compatibility limits such as a physical size, weight, a computer memory size, a computer disk storage size, a computer operating system, a computer browser, and any other attribute or aspect of a computing facility.

The transactional offer platform 100 may include a transaction offer offering 170. A transaction offer offering 170 may facilitate a user 154 acquiring, accessing, receiving, activating, or otherwise using a transaction offer 160. A transaction offer offering 170 may result in activating, extending, or making permanent a use of the transaction offer 160. In an example, a transaction offer 160 may allow a user 154 to use a product (e.g. software) or a service (e.g. access to an investment advice website) for a limited time. As a result of accepting a transaction offer 160, a user 154 of the transactional offer platform 100 may receive through a transaction offer offering 170, a copy of the software that does not have a time limit, or a password to allow permanent access to the investment website. Although the example here is for the user 154 to receive a transaction offer offering 170 that makes the use of the transaction offer 160 permanent, other types of use extension and activation may also be included in the transaction offer offering 170. The password may provide a one year membership to the investment website, allowing the user 154 to access the investment website for 12 months. The software may be useable permanently but support or updates may be limited to 90 days. Many other transaction offer offerings 160 may be apparent from these examples and are included herein.

A transaction offer transaction facility 120 may facilitate completing an execution of a transaction offer 160. The transaction offer 160 may facilitate performing an ecommerce transaction to acquire, lease, or temporarily use the transaction offer 160. The transaction offer transaction facility 120 may provide information to the user 154 that may allow a user 154 to complete an execution of the transaction offer 160. Such information may include a proof of purchase, an in-store pickup authorization, a payment authorization, a certificate redeemable for the primary offer 164, a credit 140 to an account, and the like.

A transaction offer 160 may further provide a refund of the primary offer 164 purchase price to the credit 140 account. The transaction offer 160 may include information confirming the purchase price being charged to the credit 140 account and the refund.

In another example, the transaction offer 160 may include transaction offer 160 package shipment confirmation and tracking information. The shipping information in the transaction offer 160 could facilitate a user 154 receiving the transaction offer 160. If the transaction offer 160 is a gift for another individual from the user 154, the transaction offer offering 170 could represent a confirmation of shipment of the gift.

A transaction offer 160 may include a temporary extension of authorization for use of the transaction offer 160 associated with a conditionally accepted transaction offer 160. The extension may be based at least on a time required for a transaction offer offeror 148 to complete an assessment of a user's 154 completion of the transaction offer 160. If the transaction offer offeror 148 approves the accepted transaction offer 160 (in cases where approval is required), the transaction offer 160 may include terms for a permanent extension, replacement of authorization, or the like. The transaction offer transaction facility 120 may provide a notification to the user 154 associated with the conditional acceptance. The notification may include information related to instructions for receiving the transaction offer 160 once their accepted offer is approved by the transaction offer offeror 148.

A transaction offer 160 may be communicated to the user 154 by the transaction offer offeror 148, the transactional offer platform 100, or a combination thereof.

The transactional offer platform 100 may include an offer bidding module 124. The offer bidding module 124 may be associated with a transaction offer offeror 148 through a transaction offer offeror interface 118, an offer search module 130, and other aspects of the transactional offer platform 100 such as one or more databases. The offer bidding module 124 may facilitate bidding related to transaction offers 160. Bidding may be useful in determining transaction offer 160 placement in a presentation of transaction offers 160 to a user 154. Bidding may also be useful to the transactional offer platform 100 in selecting one or more offers to present to a user 154. Bidding may also facilitate optimizing transaction offers 160.

The bidding module 124 may receive bids from transaction offer offerors 148 that relate to specific transaction offers 160, or that relate to any transaction offer 160 from the transaction offer offeror 148. The bidding module 124 may compare bids to facilitate ranking the bids and associated offers based at least partially on the bid amount. A bid may include a presentation amount to be paid upon confirmation of a placement to a user 154, an acceptance amount to be paid upon user acceptance of the offer, an approval amount to be paid upon approval of the user's 154 acceptance of the offer, and any other amount such as a marketing fee, a transaction fee, and the like.

Bid amounts may be based on quality of users 154 accepting transaction offer offers, volume of use acceptances, and the like. In an example, a user 154 from a particular primary vendor 144 may be significantly more affluent and thus have a greater ability to transact with a transaction offer offeror 148, than a user 154 from a different primary vendor. The transaction offer offeror 148 may be willing to bid more for this user 154 from the higher quality primary vendor 144.

The bidding module 124 may process the bids including associating bids with transaction offers 160, transaction offer offerors 148, and the like for use by the offer search facility 130, the offer optimization facility 102, offer selection and display facility 104, and the like. The bidding module 124 may also store information such as bids, bid history, and the like in one or more databases of the transactional offer platform 100.

For example and without limitation, a participant of the transactional offer platform 100 such as a transaction offer offeror 148 may place a bid with the bidding module 124 to obtain a preferred placement of an offer in a presentation of offers to a user 154. The bidding module 124 may determine that an aspect of this bid, such as the amount of the bid, enables the transactional offer platform 100 to fulfill the preferred placement of the offer associated with the bid. Upon selection of the offer by the offer selection and display facility 104, and presentation of the offer by the transaction offer transaction facility 120, the offer would be presented to the user 154 in the preferred placement. The preferred placement may include preferred presentation such as ranking in a list, highlighting, images, font, animation, and the like that may differentiate this offer from other offers.

A transaction offer offer's 160 placement preference may be affected by bid flexibility. Bid flexibility may be related to a transaction offer 160, a transaction offer offeror 148, or other elements of the transaction offer process. Bid flexibility may be specified when a bid is placed or may be based on a transaction offer offeror 148 preference. Bid flexibility may include a maximum number of times the bid will automatically be increased (kicks) to keep pace with other bids. Bid flexibility may also include an amount per kick, a total kick amount, a maximum bid amount, or any combination thereof.

A transaction offer offeror 148 may specify the bid flexibility as a preference that may apply to all transaction offer bids placed by the advertiser. The transaction offer offeror 148 may use the transaction offer offeror interface 118 to specify bid flexibility preferences.

Transaction offers 160 associated with highly flexible bids may be provided higher placement preferences. For example, a bid with a 50% upside bid amount flexibility may be placed ahead of an identical bid with only 20% upside bid amount. In this way, transaction offer offerors 148 who are willing to spend more per transaction offer may be receive improved placement relative to other transaction offer offerors 148.

In addition to considering bid flexibility in transaction offer 160 placement, the performance of the transaction offer offeror 148 and the transaction offer 160 may be included in placement preference. It may be understood that a factor in the likelihood that a transaction offer 148 will be accepted is a previous performance measurement associated with the offer. For example, a transaction offer with a high number of acceptances from previous placements may be highly placed in a new transaction offer offer. Also, a high number of transaction offer 160 placements may improve the placement of future transaction offers 160 from the transaction offer offeror 148.

Some factors that may affect a transaction offer offer's 160 placement may also affect amounts debited from a transaction offer offeror 148 that is associated with the transaction offer offer's 160 placement. Factors such as click-throughs (user selections) of transaction offers 160 may indicate a relevance and/or user interest in the transaction offer 160. Although a high (or relatively advantageous) placement of a transaction offer 160 may be valuable to a transaction offer offeror 148, engaging the user 154 in further evaluation of the transaction offer 160 may be of value even if the user 154 does not accept the transaction offer 160. For example, a user 154 who clicks through (selects) a transaction offer 160 may be presented with further details about the offer as well as other information that the transaction offer offeror 148 may deem to be relevant. In this way, the transaction offer offeror 148 may gain the attention of the potential new customer. This may provide some measurable value to the transaction offer offeror 148.

The transaction offer offeror 148 may be willing to pay a fee based on click through rates as measured daily, weekly, monthly, or the like. The fee that the transaction offer offeror 148 is willing to pay may be debited 142 from the transaction offer offeror 148 on a schedule, based on a volume, based on an event such as a transaction offer 160 acceptance, and so on. A debit amount may be associated with each click through and may be accumulated over time (an accumulation interval may include hours, day, week, month, et cetera) by the transaction offer transaction facility 120. The debit amount may be debited 142 at least once per accumulation interval. Alternatively, a transaction offer offeror 148 may specify that click through debits may be accumulated and added to debits made for accepted offers.

In an example, the transactional offer platform 100 may receive a user 154 request for an ecommerce transaction. The transactional offer platform 100 may select a non-monetary compensation offer through an automated ecommerce bidding process included in the bidding module 124. The transactional offer platform 100 may present the selected non-monetary compensation offer to the user 154.

The bidding module 124 may be embodied as an automatic service, such as and without limitation according to a service-oriented architecture or any other computing architecture.

The bidding module 124 may facilitate a transaction offer offeror 148 bidding for transaction offer 160 placement. The bidding module may interact with the primary transaction facility 114 and other elements of the transactional offer platform 100 such as user demographics 174, user transaction history (including transactional offer history), one or more databases of the transactional offer platform 100, the offer optimization facility 102, and the offer selection and display facility 104, and any other element as needed to facilitate offer bidding.

The bidding module 124 may compute a consumer score for a user 154 seeking to alternatively purchase a primary offer 164. The consumer score may be useful in facilitating offer bidding. To compute the consumer score, the bidding module 124 may assess information related to the primary offer 164 and the active user 154. The bidding module 124 may receive information about a primary offer transaction from the primary transaction facility 114. The information may include the primary vendor 144, primary offer 164, and the user 154. The bidding module may retrieve the user's 154 transaction history from one or more of the databases of the transactional offer platform 100. The bidding module may also retrieve the user's 154 demographics 174. The bidding module may combine the information about the primary offer 164, the user 154 transaction history, and the active user demographics 174 to compute the user's 154 consumer score. In an example, a user 154 may be seeking to alternatively purchase a subscription to Zagat.com. The user's 154 transaction history may show the user accepted transaction offers 160 for three previous transactions with an average transaction offer 160 user cost of $75. The user's 154 demographics may indicate the user's 154 address as an upper middleclass suburb of Boston, Mass. Based on this example user information, the bidding module 124 may compute a consumer score as eight points out of a possible ten points. The bidding module 124 may present this consumer score to a plurality of transaction offer offerors 148 through the bidding module 124 so that the transaction offer offeror 148 may bid to present a transaction offer 160 to the user 154. The consumer score may refer to one or more defined characteristics of the user 154. A high consumer score may be a strong indication of that particular user 154 characteristic while a low consumer may represent an absence of that particular characteristic. The consumer score may be an aggregation of multiple similar consumer scores relating to different characteristics of the user 154. Furthermore, these scores may be valued differently by transaction offer offerors 148 such that one transaction offer offeror 148 may pay a premium for a particular score while another transaction offer offeror 148 will not. In this way, a transaction offer offeror 148 can bid on the consumer scores that best relate to type of user 154 the transaction offer 148 seeks to attract. In this document consumer score refers to an individual consumer score relating to a particular characteristic of the user 154, or an aggregation of consumer scores that may be refer to the overall characteristics of the user 154 and may be the weighted sum of the individual consumer scores.

A transaction offer offeror 148 may place multiple bids for multiple different consumer scores relating to various aspects of a user 154. For example, a transaction offer offeror 148 may place a bid for high consumer scores relating to the female gender and may also place a bid for high consumer scores relating to high household income.

Some or all of the plurality of transaction offer offerors 148 may bid to offer the user 154 a transaction offer 160. The transaction offer offerors 148 may adjust a bid amount based on the consumer score of the user 154. For example, a transaction offer offeror 148 may bid $20 to offer a transaction offer 160 to a user 154 with a consumer score of four. However, the same transaction offer offeror 148 may bid $50 for a user 154 with a consumer score of eight. The transaction offer offerors 148 may also include a conversion rate associated with a bid, where the conversion rate is a measure of the likelihood that a transaction offer 160 (associated with the bid) will be completed by the target user 154 (associated with the bid). An expected value based on a function of the bid and the conversion rate may be computed by the bidding module 124 for each bid received. The transaction offer offeror 148 bid, rate, expected value, and transaction offer 160 information may be shared with the optimization facility 102. Alternatively, the expected value may not be computed by the bidding module 124. Instead, the optimization facility may compute the expected value.

Through the bidding module 124 computation of a consumer value for the user 154, and the transaction offer offerors 148 placing bids and associated conversion rates for the user 154, the optimization facility 102 may now optimize among transaction offers 160 each with a computed expected value. Offer optimization may be directed toward maximizing the expected value that may be shared with the primary vendor 144 for the user transaction. To maximize the expected value of a user transaction, the offer optimization facility 102 may rank the offers based on expected value so that the offer selection and display facility 104 may select the top ranked offers for prominent presentation to the user 154. In an example, the table below shows bids and conversion rates of six transaction offer offerors 148 for the user with a consumer rating of eight/ten in the example above.

### Transaction Offer Bid Example

| Transaction offer | | | |
|---|---|---|---|
| offeror | Bid Amount | Conversion Rate | Expected value |
| Cingular | $50 | 5% | $2.50 |
| Verizon | $55 | 4% | 2.20 |
| Discover | $80 | 2% | 1.60 |
| American Express | $120 | 1% | 1.20 |
| RealRhapsody | $30 | 10% | 3.00 |
| Stamps.com | $40 | 5% | 2.00 |

The offer optimization facility 102 (or the bidding module 124) may compute the expected value as shown in the table and forward the Cingular and the RealRhapsody offers as optimized offers 132 to the offer selection and display facility 104. The selection and display facility 104 may select one or more of the optimized offers 132 and send them to the transaction offer transaction facility 120 as selected offer(s) 138 for presentation to the user 154. The remaining four offers may not be presented to the user 154 unless the user rejects the Cingular and the RealRhapsody transaction offers 160. However, the remaining four offers may be presented to the user 154 along with the Cingular and RealRhapsody offers in a less prominent way such as by smaller print, lower order in a list, and the like. The bidding module 124 may provide real-time feedback to the transaction offer offeror 148 as to the potential impact in offer performance that may result from an increased bid. For example, a message may be sent to the transaction offer offeror 148 indicating that an increase of a given amount will make a particular transaction offer 160 the highest ranked offer on a page.

The transactional platform 100 may include a bidding module 124 for selection of transaction offers stored in the offers database 152. The offers database 152 may be continuously updated with new offers realized by the merchants. The offer selection facility 104 may select transactional offers provided by different merchants based on the predetermined bidding criteria. The bidding criteria may be based on transaction amount, user's commitment to a transaction, correlation of advertiser offer with the transaction, mode of payment, payment type, indication to make payment, and the like.

The platform 100 may include a transactional bidding module 124 that may bid module 124 present bidding suggestions to the advertisers. The bid module 124 suggested bid amount may be based on partial or complete match of the transactional offers stored in the offers database 152 and the information associated with the advertiser. For example, a user 154 may have committed to purchase a mobile phone from eBay; in response to this purchase commitment, the platform may prepare for the user 154 to be presented with a transaction offer. The platform 100 may suggest to the advertiser a bid amount for placement of transactional offers; the bid module 124 may suggest a higher bid amount to the companies selling mobile accessories based on the likelihood of the transaction offer being accepted by the user 154 given that a user 154 who has committed to buy a mobile phone will more likely purchase mobile accessories.

The bidding module 124 may not suggest an amount of bid, but may suggest that one or more advertisers to bid on placing a transaction offer based on the relationship described above or other factors and/or relationships of factors associated with an electronic transaction.

In embodiments, the bid module 124 may evaluate various parameters related to transactional offers and the advertisers. Various rules and algorithm-based criteria may be implemented in the bid module 124 to facilitate selection of the probable advertisers and their bidding amounts. In embodiments, the bid module 124 may implement a statistical criterion for determining the correlation between the transaction and the advertiser, the transactional offer and the bid amount, and the like. In another embodiment, the bid module 124 may implement a neural network for determining the correlation between the transaction and the advertiser, the transactional offer and the bid amount, and the like. In yet another embodiment, the bid module 124 may use fuzzy logic for determining the correlation between the transaction and the advertiser, the transactional offer and the bid amount, and the like. In addition, the bid module 124 may use a rule-based facility programmed for suggesting the bid amount corresponding to the transactional offer for any plurality of advertisers respectively.

In embodiments, the advertisers may bid for placing the offer to the user 154. An offer selection and display facility 104 may be entrusted with the task of evaluating the bid received from a plurality of merchants. The evaluation of bids may be based on contents associated with the transaction. For example, the user 154 may be purchasing a book from Abooks.com and in response to this transaction Bbooks.com and Cbooks.com may like to suggest a transactional offer to the user 154. In this example, evaluation of bid may be performed based on the highest bid entered by each party. In another example, the bid may be evaluated on the content match between the purchased title of the book and the corresponding transactional offer. The offer display facility 104 may display the selected transactional offer to the user/user 154. The offer selection and display facility 104 may decide the timing, duration, placement on the page, and the length of the transactional offers and the like for placement of transactional offers presented to the user/user 154.

While evaluating the criteria for selection of transactional offers to be presented to the user 154, the offer selection facility 104 may evaluate a plurality of factors, including transaction amount, payment type, shipping address, shopping cart contents, user level of commitment, and transactional status, and the like. For example, if the transaction shows a shipping address for India, the user 154 may be presented with transactional offers applicable in India even though the advertiser of such an offer may not be the highest bidder. In another example, if the committed transaction showed a large number of shopping cart contents of closely related items, the transactional offer corresponding to the advertiser providing a package offer may be presented to the user 154. In yet another example, the user indication to try a product and user's commitment to make the payment after the trial would classify the user 154 as first adopter, and transactional offers corresponding to new product trial may be provided to the user 154 without any obligation to buy. The user's level of commitment may be segmented in different categories: an indication of non-payment, an indication of payment, and an indication of indecision to pay; and the transactional offers may be presented to the user 154 based on user's level of commitment.

In embodiments, the transaction status may be an important determinant in identifying the transactional offer to be presented to the user 154 without any obligation or promise in entering into a transaction for the transaction offer. Further, the transaction status may indicate a position of the user 154 communicating a desire to enter into a transaction based on the incentive provided in the transaction offer. Alternatively, the user may foresee a benefit in the form of the transaction offer without any obligation to pay for accepting the transaction by making full payment. In another scenario, the payment approval for the transaction may attract an incentive, which may be embodied as a transaction offer.

The transactional offer platform 100 may include an offer search facility 130. The offer search facility 130 may communicate with aspects of the transactional offer platform 100 such as a bidding module 124, the offer optimization facility 102, the offer selection and display facility 104, various databases of the transactional offer platform 100, external offer databases 152, and the like. The offer search facility 130 may comprise search techniques such as text string matching, to identify one or more offers from a plurality of offer databases 152. Searching by the offer search facility 130 may be performed as a result of an event or a request. A search event may include receiving a user 154 request for an ecommerce transaction, such as acquiring a primary offer 164 using the transactional offer platform 100. A search event may be a vendor registering with the transactional offer platform 100, a vendor introducing the transactional offer platform 100 to a new primary offer 164 or a new transaction offer 160, a user 154 rejecting all offers presented through the transaction offer transaction facility 120, a schedule such as a date and time, and the like. The search request may include any participant, including a user 154 of the transactional offer platform 100 sending the transactional offer platform 100 a request to perform an offer search.

The offer search facility 130 may maintain a directory of offer databases 152. Vendors and facilitators 150 may provide input to the directory so that new offer databases 152 may be searched by the search facility 130. The search facility 130 may search through specific offer databases 152 such as those in the directory. Additionally, the search facility 130 may also search throughout a network, such as the internet, for offers or offer databases 152 that have a relevance to the transactional offer platform 100.

Changes to offer databases 152 may be provided to the offer search facility 130 through a variety of notifications. In an example, an RSS feed of updates to one or more of the offer databases 152 may be monitored by the search facility 130.

The offer search facility 130 may also include information provided by bidding module 124 in identifying offers for possible presentation to users 154.

The offer search facility 130 may also receive a request from the offer selection and display facility 104 to retrieve one or more offers from one or more of the offer databases 152. Upon receiving the request, the offer search facility 130 may access the appropriate offer databases 152, retrieve the offer, and present it to the offer selection and display facility 104 for use in a presentation to a user 154, for example.

In an example, the transactional offer platform 100 may receive a user 154 request for an ecommerce transaction. The offer search facility 130 may search a plurality of databases for non-monetary compensation offers to be presented to the user 154 as further incentive to complete the transaction. The offer search facility 130 may retrieve at least one non-monetary compensation offer from the plurality of databases, and present it to the user through the transactional offer platform 100.

The offer search facility 130 may be embodied as an automatic service, such as and without limitation according to a service-oriented architecture or any other computing architecture.

The transactional offer platform 100 may include a lead generation facility 172 for developing leads of users 154 that may appeal to one or more vendors such as primary vendors 144 and transaction offer offerors 148. The lead generation facility may communicate with users 154, and aspects of the transactional offer platform 100 such as the offer optimization facility 102, the offer selection and display facility 104, and the like.

The lead generation facility 172 may process primary offers 164 and transaction offers 160 to generate criteria for lead generation. The criteria may include aspects of the offers such as user 154 cost, geographic limits, user demographics 174, and the like. The lead generation facility 172 may generate a lead that may contain user 154 contact information such as an email address, or messaging username, telephone number, and the like, so that the generated lead has a relevance to a primary offer 164 or a transaction offer 160.

Users may be contacted by the lead generation facility 172 based on their email address being known to the lead generation facility 172 such as would be the case if a user 154 had registered with the transactional offer platform 100. The lead generation facility 172 may contact users through a variety of other methods including, telephone, text message, instant message, and the like. User contact may include offer promotional material such as an advertisement for the offer. If the promotional material appeals to the user 154, he/she may respond and thereby generate an acceptance of a transaction offer 160 of the transactional offer platform 100. This acceptance may result in the transaction offer offeror 148 associated with the transaction offer 100 paying the transactional offer platform 100 a fee for providing the lead.

The lead generation facility 172 may match one or more aspects of an offer to one or more aspects of a user 154 so that the offer 160 may appeal to the user 154.

The lead generation facility 172 may be embodied as an automatic service, such as and without limitation according to a service-oriented architecture or any other computing architecture

The transactional offer platform 100 may include external offer databases 152. The external offer databases 152 may be accessible by the transactional offer platform 100 through the offer search facility 130. The external offer databases 152 may be configured as a collection of records stored in one or more computers in a systematic way, so that a computer program such as the offer search facility 130 consult it to find offers. However, any collection, list, single entry, or other logically related group of offers may comprise the external offer databases 152.

One or more of the external offer databases 152 may be established and/or maintained by the transactional offer platform 100. This may be used as a primary store of offers by the transactional offer platform 100 or it may be a backup or transaction offer store of offers.

An external offer database 152 may be established and/or maintained by a vendor such as a transaction offer offeror 148 or an offer consolidator 180. The database 152 may be maintained such that, from time to time, offers may be added, removed, or changed. The addition, removal, or change of an offer in one or more of the external offer databases 152 may result in a signal, such as an RSS feed being sent to the transactional offer platform 100.

In addition to offers being stored in an external offer database 152, the transactional offer platform 100 or a vendor may also store information related to offers such as bid amounts, payment terms, account numbers, contact information, offer performance, user 154 acceptance information, and the like. Including this additional information in one or more of the external offer databases 152 may facilitate communicating the information between a vendor and the transactional offer platform 100. In an example, the offer search facility 130 may retrieve an offer and associated information as herein described from an external offer database 152 for processing by the offer optimization facility 102.

External offer databases 152 may be distributed and/or duplicated to facilitate timely searching and retrieval of information in the databases. In an embodiment including a plurality of transactional offer platforms 100, information may be stored in the external offer databases 152 to facilitate coordination of access among the transactional offer platforms 100. Alternatively, the transactional offer platform 100 may coordinate access separately from the external offer databases 152.

The transactional offer platform 100 may include user demographics 174. User demographics 174 communicate with aspects of the transactional offer platform 100 such as offer optimization facility 102, offer selection and display facility 104, vendor reporting 110, and the like. User demographics 174 may be stored in a database that may be accessible to the transactional offer platform 100 at all times. The user demographics 174 database may be external to the transactional offer platform 100 and may be established and/or maintained by a user demographics provider. Alternatively, the transactional offer platform 100 may establish and/or maintain a user demographics 174 database.

As herein described the offer optimization facility 102 and the offer selection and display facility 104 may use user demographics 174 in optimizing and selecting offers for presentation to a user 154. The user demographics 174 may facilitate presenting offers to a user 154 that have a relevance of some importance to the user 154. In an example, an offer for fly fishing equipment may have an important relevance to a user 154 with demographic aspects that may characterize the user as having an interest in outdoor participatory sports.

User demographics 174 may include a user's 154 individual demographic variables such as age, sex, race, religion, an area code, zip code, a home address, a work address, a billing address, credit information, family information, income range, birth date range, birthplace, employer, job title, length of employment, an affiliation, or other such information as described herein.

The transactional offer platform 100 may include one or more transaction offer redemption facilitators 178. The transaction offer redemption facilitators 178 may communicate with users 154 and the transactional offer platform 100 such as through the transaction vendor 148. Transaction offer redemption facilitators 178 may facilitate a user 154 redeeming a transaction offer that the user previously accepted in an electronic transaction.

The transactional offer platform 100 may include offer consolidators 180. Offer consolidators 180 may communicate with one or more transaction offer offerors 148 and one or more transactional offer platforms 100. An offer consolidator 180 may coordinate offers such as transaction offers 160 from transaction offer offerors 148 to enable users 154 to take advantage of the offers. An offer consolidator 180 may handle aspects of the offer such as user registration, offer approval, offer delivery, transactional offer platform 100 payment, and so on. An offer consolidator 180 may perform these and other functions for a fee paid by the transaction offer offerors 148.

An offer consolidator 180 may provide benefits of consolidating offers from different aspects of a vendor's business while maintaining a consistent methodology and standards for the offers. In an example, an offer consolidator 180 may manage offers from a transaction offer offeror 148 so that a single offer may be adjusted for different geographic regions. For example, the payment associated with a transaction offer 160 may be different with respect to accepting users 154 from different regions, the price of the primary offer 164 may vary by region, or the like.

Offer consolidators 180 may also provide additional services such as consolidating offers from a plurality of transaction offer offerors 148.

Facilitating transaction offer offerors 148 reaching high quality users 154 may be a valuable service of the transactional offer platform 100. Transaction offer offerors 148 may be looking to acquire high quality users 154 to increase the likelihood that such a user 154 will become a customer of the transaction offer offeror 148. Determining which users 154 are high quality may be challenging in an electronic commerce environment because users 154 can make a transaction, including accepting a transaction offer offer, without providing key quality information such as spending habits, product preferences, and the like. A user's 154 email address and contact information, while required for most transactions, may not facilitate quality determination. In an electronic transaction such as a transaction offer transaction, users 154 may also be reluctant to provide personal details.

The transactional offer platform 100 may offer alternative ways for transaction offer offerors 148 to gain access to high quality users 154. By establishing a customer acquisition marketplace (also referred to herein as a “customer marketplace”), the transaction offer platform 100 may facilitate a transaction offer offeror 148 gaining access to high-quality users 154 through the platform's dynamic transaction offer 160 association features. The transactional offer platform 100 may allow transaction offer offerors 148 to specify aspects of user 154 quality that can be assessed by the platform 100. User 154 quality may include aspects of primary offers 164. Therefore, transaction offer offerors 148 may request their transaction offers 160 be offered to users 154 who are alternatively purchasing products or services with specified aspects. For example and without limitation, a user 154 who is interested in a primary offer 164 that involves purchasing a luxury good may be a user 154 that is ready to spend a relatively large amount of money. In this respect, the user 154 may be considered a high-quality user. For another example and also without limitation, a user 154 who is interested in a primary offer 164 that is generally associated with a particular demographic may be considered a high-quality user to a transaction offer offeror 148 who is a purveyor of goods that are typically purchased by members of that demographic. Many definitions of a high-quality user 154 will be appreciated and all such definitions are within the scope of the present disclosure. Similarly, many systems and methods of determining whether a user 154 is a high-quality user 154 will be appreciated and all such systems and methods are within the scope of the present disclosure.

In embodiments, there may be many transaction offer offerors 148 interested in acquiring users 154 who are alternatively purchasing one or more of the primary offers 164 with the specified aspects. Therefore, the transactional offer platform 100 may enable transaction offer offerors 148 to request promotion, placement, pricing, and the like (collectively, referred to herein simply as “placement”) of their transaction offers 160 to high quality users 154. Such placement may be associated with positioning one transaction offer 160 in relation to another transaction offer 160; providing one transaction offer 160 instead of another transaction offer 160; modifying a look, feel, price, or other element of a transaction offer 160 such as and without limitation to improve the appearance and/or allure of one transaction offer 160 as compared with another; and so on. Transaction offer offerors 148 may include a bid in association with a transaction offer 160 placement request. The offer bidding module 124 may determine which transaction offer 160 is selected based at least in part on the bid. In an example, credit card vendors such as Discover Card, VISA, Master Card, and the like may be willing to pay more to acquire a customer alternatively purchasing a Zagat.com subscription than a customer alternatively purchasing WinZip, perhaps because the purchase of a subscription to Zagat.com, as opposed to a purchase of WinZip, naturally leads to additional purchases (such as for restaurant visits) for which using a credit card may be a preferred method of payment. Additionally or alternatively, such a customer (i.e. a user 154) may have income or spending habits that would highly benefit a credit card vendor. This aspect of the transactional offer platform 100, which a customer marketplace may encompass, may allow transaction offer offerors 148 to bid on users 154 who are performing live transaction offer transactions rather than soft leads.

To facilitate the customer marketplace, the transactional offer platform 100 may allow transaction offer offerors 148 to specify aspects of primary offers 164 that indicate that a user 154 who is selecting the primary offer 164 might be a high quality user 154. The transaction offer offerors 148 may specify these aspects through one or more screens, dialogue boxes, webpages, et cetera of the transaction offer offeror interface 118. Aspects of the primary offer 164 may be associated with specific products or services. In other examples: a home equity lender may consider a user 154 alternatively purchasing replacement windows as a high quality customer; a horse transportation vendor may consider a user 154 alternatively purchasing a saddle as a high quality customer; a wine club may consider a user 154 alternatively purchasing a case of wine to be a high quality customer. Many other such examples will be appreciated and all such examples are within the scope of the present disclosure.

Aspects of primary offers 164 may also include categories or types of products or services. It will be appreciated from the foregoing examples that the products or services may be included in categories such as home improvement products or services, horse riding and care products or services, wine and liquor products and services, and so on. Additional category examples may include gaming products or services, camping products or services, travel product or services, boating products or services, and the like. It will be appreciated that primary offers 164 may be categorized or typed in a wide variety of ways that may be usefully specified by transaction offer offerors 148 to identify potentially high quality customers. All such categories, types, and combinations of aspects are contemplated by this specification and are within the scope of the present disclosure.

Aspects of primary offers 164 related to customer quality, and the transaction offer offeror's 148 specification of these aspects may be processed by the offer optimization facility 102 such that the optimized offer 132 selection incorporates these additional factors. Offer selection, as performed by the offer selection and display facility 104, may also be affected by these factors. A possible outcome of incorporating these additional factors into offer optimization and offer selection is a presentation by the transaction offer transaction facility 120 of transaction offers 160 that may have a greater relevance, and possibly greater value to the user 154 than other transaction offers 160.

In addition to the customer acquisition marketplace being useful and beneficial to transaction offer offerors 148, it may also be beneficial to primary vendors 144. Primary vendors 144 may view the possible associations with transaction offer offerors 148 as adding value by providing co-marketing and/or co-branding opportunities. Primary vendors 144 may perceive that participating in the transactional offer platform 100 may increase their sales through these offer associations and therefore the primary vendors 144 may employ the transactional offer platform 100 to provide a transaction offer option for their products and services. A user 154 that is a high quality customer to a transaction offer offeror 148 may also be a high quality customer to a primary vendor 144. Therefore, if a primary vendor 144 is aware that a user 154 may be able to buy the primary vendor's 144 product or service by alternatively purchasing a product or service (transaction offer 160) that the user 154 highly desires, the primary vendor 144 may want to participate in that offer association. These offer associations thereby make the transactional offer platform 100 a viable, effective, and desirable method of purchase for primary vendors 144.

Demographic and other user 154 aspects that factor into a consumer's value to a vendor may include zip code and may relate to property value. These user 154 aspects may be implicitly determined based on location detection of the user through the ISP and/or IP address. The user 154 aspects may be explicitly determined based on user-provided data such as zip code. For example, a user 154 may provide a zip code that, when evaluated against demographic data, is considered a “high approval rate” zip code for financial products such as loans, credit cards, and the like. A credit card company may be willing to pay a relatively high fee to acquire a customer from a “high approval rate” zip code.

Third-party services that provide on-line access to property value, income assessment, approval rate, and the like may provide valuable information for determining customer quality to the transactional offer platform 100. For example and without limitation, an area with relatively high property values may contain higher quality/value customer and therefore an advertiser may be willing to pay a premium to acquire a customer from such an area.

Similarly, an aspect of a user's 154 house/home/apartment may factor into customer quality/value. A user 154 in an apartment may not be a high quality/value customer for transaction offer offerors 148 that provide home improvement products and services. However, such a user 154 may be quite valuable to insurers that are offering apartment insurance. Therefore, determining whether a userl 54 lives in an apartment, home, or other type of domicile may allow the transactional offer platform 100 to establish an appropriate quality/value factor for the customer.

Other factors such as a customer's (i.e. a user's 154) use of a particular type of internet connection, a particular type of web browser, a particular operating system, and the like may also be of value in establishing the quality/value of the customer. For example, a transaction offer offeror 148 offering faster internet access may consider a user with an out-of-date operating system (e.g. Windows 98) as a low quality potential customer. Conversely, a user with a current model computer, an updated operating system, and a slow internet connection may be considered a high quality potential customer. Many other examples will be appreciated and all such examples are within the scope of the present disclosure.

From the transaction offer offeror's 148 viewpoint, having timely access to high-quality customers who are actively performing electronic transactions may provide much greater value than traditional internet advertising and marketing techniques such as cost-per-click, keyword-based marketplaces.

Transaction offers 160 may take place before a primary offer 164 sale/checkout or after the sale/checkout. Additionally the user 154 may be presented with multiple offers from the platform 100. The platform 100 may present the multiple offers at one time, such as through a webpage showing the offers, or may be presented at more than one time. Directly presented offers may be presented in succession on individual webpages or may be presented together on a single webpage. Offers may include low value items, such as a digital music song download, and the like.

The transactional offer platform 100 may include release testing for testing changes, additions, conversion, updates, and new releases of aspects of the platform 100 to ensure the platform 100 achieves high quality performance and reliability. Release testing may be automated to support and facilitate platform 100 complexity. The platform 100 release may be deployed to a subset of users, a subset of vendors, and the like. The deployment may be automatic or manual and may include a sufficient numbers of users and vendors to create a statistically significant sample size. The release may be deployed for only certain tasks. New releases of a transactional offer platform 100 may be tested for performance, usability, bugs, advance warning of support needs, and the like. These measurements may be made automatically. In an example and without limitation, usability may be inferred from tracking user times to complete tasks, by analyzing results from subjective assessments, by tracking the number of completed versus abandoned transactions in relation to the number of bugs, and the like.

The platform 100 may be associated with vendor administration. Vendor administration may involve tracking active placements. Active placements may include URLs, emails, and other touchpoints, such as Uninstall, Nagscreen, UnSubscribe, Cancel, Shopping Cart Abandon, and the like, involving the transactional offer platform 100. Active placement tracking may involve account managers, vendors, and the like identifying where a given product page is being promoted. Active placement tracking may facilitate making sure “best practices” are implemented, identifying misrepresentations, demonstration of live examples for prospective vendors, identifying sources of traffic, and the like. In an example, active placement tracking may capture touch point type along with associated information, duration comments, and the like. A vendor interface may facilitate active placement tracking by presenting information and analysis that may identify revenue associated with a ‘constant’ traffic source and a transient source.

The transactional offer platform 100 may comprise a vendor interface. The vendor interface may facilitate vendor registration, configuration of the vendor account, management of a vendor account, monitoring of a vendor account, and the like. The vendor interface may facilitate monitoring of primary offers, referrals, referral commissions, active placements, statistics, and the like. Analytics and reports may be generated through a vendor interface.

The transactional offer platform 100 may comprise a primary vendor interface 112. The primary vendor interface 112 may allow primary vendors 144 to perform analytics for each product available through the transactional offer platform 100 and monitor performance of various customer communications. Analytics may be available as a daily feed through a dashboard of the primary vendor interface 112. Analytics may include traffic sources, actions taken on a product webpage, products sold, repeat customers, the association of revenue generated with traffic source, the association of revenue generated with repeat customers, payment option performance, touch point analytics, and the like. Analytics may assist primary vendors 144 in decision making and adjusting communication strategy. Analytics may assist a primary vendor 144 in determining optimal pricing of a product. In an example and without limitation, analytics may demonstrate payment option performance, such as the rate of transaction completion for credit-card transactions versus transactional offer platform 100 transactions. Analytics may assist a primary vendor 144 in determining how to convert webpage visitors into customers by analyzing past transactions. Analytics may assist a primary vendor 144 in determining when to introduce the transactional offer platform 100 during a transaction Analytics may assist in determining user 154 related fraud, such as when a user completes multiple transaction offers 160 without regard to the terms and conditions of the transaction offer 160. In an example and without limitation, analytics may assist in deciding if a transactional offer platform 100 may be introduced prior to a payment point during a transaction, with the payment point, after the payment point, at any time in the transaction, and the like by providing data regarding rates of transaction completion for each touch point. Wherever there may be a payment option, there may be a touch point.

The primary vendor interface 112 may allow primary vendors 144 to extend transaction offer offeror 148 timeout, as described elsewhere herein with respect to offer optimization 102. The primary vendor interface 112 may allow primary vendors 144 to add a landing page option for the check-out process. In an example and without limitation, a vendor may want to specify additional context on the transactional offer platform 100 payment module using a landing page which may be provided with default messaging, custom messaging, and the like. The landing page may be customized based on a traffic source, a season, a demographic, and the like.

The transactional offer platform 100 may comprise pricing alternatives. In an example and without limitation, a vendor may indicate a minimum acceptable price for one region of the world but indicate a different minimum acceptable price for another region. In another example, pricing may be based on a demographic. In an example and without limitation, a vendor may indicate a lower minimum acceptable price for seniors and a higher one for non-seniors. In another example, pricing may be based on a psychographic. In an example and without limitation, a vendor may indicate a lower price for members of Amnesty International. The transactional offer platform 100 payment module 108 may aggregate pricing parameters for each region, demographic, and psychographic where a vendor may indicate a pricing alternative in a pricing table. The pricing table may allow the vendor to indicate the pricing alternative as a new entry, as a percentage of a prior minimum acceptable price, and the like. Pricing alternatives may be indicated in any currency in use. The pricing table may be accessed by the payment module when a user indicates a certain regional location, demographic, psychographic, and the like.

A vendor may receive additional information related to a user 154 after a transaction is complete. In an example and without limitation, a user 154 may accept a User ID from a vendor. Using this User ID, the vendor may track and report completed offers associated with the User ID. In another example, a vendor may have access to an Order ID or Product ID associated with a transaction offer 160. The vendor may be able to track the fulfillment status of a transaction offer 160 using the Order ID or Product ID. Vendors may be able to indicate transaction parameters to which they want access. Vendors may make transaction parameter choices by configuring a transaction parameter list. Upon initiation of a new transaction, the transaction parameter list may be accessed. All relevant parameters may be delivered to the vendor once they become available in the course of the transaction. The transaction parameters may be available on a webpage, in a report, by email, and the like.

The platform 100 may facilitate offer management by allowing primary vendors 144 to select transaction offer 160 to make available as transactional offer options for their primary offers 164 (a k a pulling offers). The platform 100 may alternatively, or additionally, facilitate offer management by pushing a selected offer or offers to a primary vendor 144. The selection may be based on aspects of the primary offer 164, primary vendor 144, transaction offer offeror 148, transaction offer 160, user location or geography, and the like. The primary vendor 144 may review selected offers that are pushed so that only offers that meet the primary vendor 144 offer selection criteria may be presented to users seeking to use the transaction offer platform 100 to acquire a primary offer 144.

Pushing offer(s) may facilitate a reduction in the overhead and human interaction associated with pulling offers by utilizing the offer selection facilities 104 and other offer coordination aspects of the platform 100 to push highly relevant offers to the primary vendor 144 to approve use of the transaction offer 160 as transactional offer for the primary offer. Preferences and other transaction offer 160 related constraints identified by the primary vendor 144 to the platform 100 may be included in the selection of offers to push to the primary vendors 144. A primary vendor 144 may identify preferences that indicate certain types of offers, or offers with certain content may not be presented to a user as a transactional offer for the primary offer 164. The primary vendor 144 may identify these and other preferences through the primary vendor user interface 112. The primary vendor 144 may select options such as “accept all pushed offers,” “accept all qualified pushed offers,” “accept all pushed offers except those listed below,” “only accept pushed offers listed below,” “accept no offers automatically,” and the like. A primary vendor 144 may choose to review each pushed offer or offers before making a decision about allowing the offers to be presented to users 154.

Vendors may establish relationships with affiliates to further promote sale of the vendor's product or service. Affiliates may be associated with primary vendors 144, transaction offer offerors 160, and may also be associated with the platform 100. An affiliate associated with the platform 100 may be similar to a transaction offer 160 consolidator 180 in that the affiliate provides a real-time connection between a user 154 and a primary 164 or transaction offer 160 through the platform 100. Vendors may compensate an affiliate for a completed transaction, such as a purchase of a primary offer 164. Therefore, vendors may want to compensate an affiliate for a user 154 who uses the transactional offer platform 100 to complete a primary offer 164. To ensure an affiliate that is involved in a platform 100 related transaction receives proper credit for a transaction for which they provided the user 154, the platform 100 may support receiving, storing, tracking, and reporting the affiliate identification associated with transactions. Maintaining a record of the relationship of an affiliate with a platform 100 transaction may facilitate proper accounting of post-transaction actions such as charge backs, credit and debit adjustments, and the like.

To promote quality use of the platform 100, a best practices forum may be associated with the platform 100. Participants to the platform 100 may have access to the best practices forum through one or more interfaces of the platform 100, through email contact, other messaging contact, physical mail, and the like. A best practices forum may benefit participants of the platform 100, such as primary vendors 144, transaction offer offerors 148, offer consolidators 180, transaction offer redemption facilitators 178, users 154, facilitators 150, and the like. A best practice forum may include material, such as on-line material, that may include getting started guides, primers, examples of touch points, examples of emails with high conversion rates, and the like. A best practice forum may include any information that may facilitate a vendor maximizing use of the platform 100 which may result in increasing platform 100 associated revenue.

The platform 100 may be associated with customer service. Customer service may facilitate a participant accessing and receiving service associated with an interaction with the platform 100. In an example, a user interface to the platform 100 may support viewing and printing receipts of all platform 100 transactions associated with the user. The transaction receipts provided by the platform 100 may include a transaction offer 160 consolidator 180 name or ID, or may instead only show the transaction offer offeror 148 information and the platform 100 information, thereby making it easier for a user 154 to determine if the receipt is the one desired.

Many questions asked by participants may have previously been answered. The platform 100 may be associated with at least a semi-automated customer service that may provide automatic responses to know inquiries by the users 154 and/or participants of the platform 100. Automating at least a portion of the platform's 100 customer service interaction may reduce costs. However, providing access to an administrator of the platform 100 through a customer service interface may facilitate quick, high quality answers to questions not readily identified in the semi-automated environment.

Providing information, such as offer redemption information, through the primary transaction facility 114 or as part of a primary offer 164 may include webpage based display, instruction download, emailing redemption instructions, and the like. A customer service system or interface of the platform 100 may facilitate a user 154 selecting how to receive offer redemption information for each transaction, for all transactions, for certain types of transaction, and the like. In an example, a user 154 may select to always receive redemption instructions by email, while also selecting to receive download instructions associated with wireless devices through the wireless (e.g. cellular phone) network. In this way the user 154 may select two or more non-conflicting ways of receiving offer redemption information.

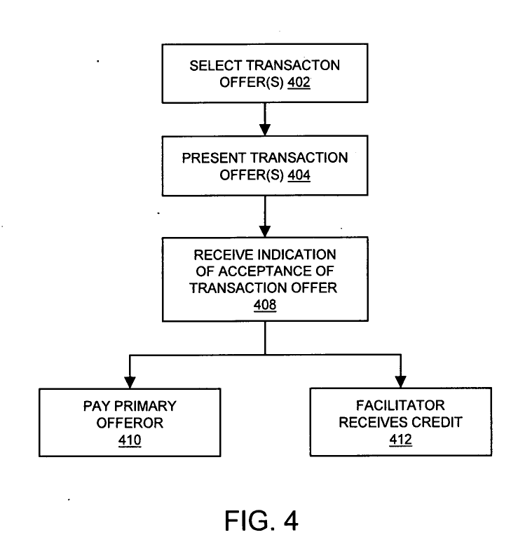

Referring to FIG. 4, in one preferred embodiment the methods and systems disclosed herein may include a method of facilitating a transaction offer platform 100 that includes steps of selecting transaction offers 160 at a step 402, presenting transaction offers 160 at a step 404, receiving an indication of acceptance by a user 154 of a transaction offer 160 at a step 408, paying a primary offeror 410 who allowed the transaction offer 160 to be presented to the user 154 and providing a credit to the facilitator at a step 412.

In embodiments the indication of acceptance is received from the user 154. In embodiments the indication of acceptance is received from the vendor of the transaction offer offer. In embodiments the payment for the primary offer 164 is a negotiated amount. In embodiments the negotiation is between a host of transaction offer offers and the primary offer merchant 144 or the transaction offer advertiser 148. In embodiments the payment for the primary offer 164 is a variable amount. In embodiments the amount varies based on: the accepted transaction offer 160; a count of primary offer payments; lifetime value or quality of the user completing the transaction offer 160; location of the user (e.g., foreign users may be worth less to advertisers); a credit score of user; a spending capacity of the user; the propensity of user to spend; the propensity of the user 154 to use a transaction offer 160; loyalty of the user 154 to the transaction offer 160; type of transaction offer completed; number of transaction offers completed; relationship of primary vendor 144 to the host of the transaction offer platform 100 or the like. Such methods and systems may include fulfilling the primary offer or the transaction offer, such as by delivering an item or items.

In embodiments receiving an indication of user 154 acceptance of one of the transactional offers includes receiving a confirmation of user acceptance to the accepted offer vendor. In embodiments receiving payment for presenting the accepted offer is in response to delivering an indication of the user acceptance of the accepted offer to the accepted offer vendor.

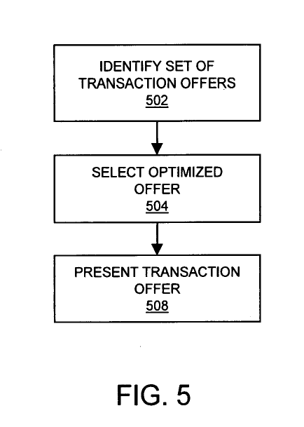

Referring to FIG. 5, in one preferred embodiment the methods and systems disclosed herein may include a method of facilitating a transaction offer platform 100 that includes steps of identifying a set of transaction offers 160 to a primary offer 164 at a step 502, selecting an optimized offer at a step 504 and presenting one or more optimized transaction offers 160 to a user 154 at a step 508.

In embodiments optimizing is based on anticipated benefit to a party associated with at least one of the transaction offers 160, wherein the party is a primary offeror 144, a user 154, a facilitator 150, or a transaction offer offeror 148. In embodiments the optimized relationship is based on a metric associated with the quality of a user. In embodiments the optimized relationship is based on maximizing participation in a transaction offer offering. In embodiments the relationships comprise suitability of the offers to a user 154 associated with the primary offering.

In embodiments optimizing is based on an expected profit associated with presenting the one or more identified offers: wherein the expected profit is based on the identified offers; wherein the expected profit is for the primary vendor 144; wherein the expected profit is for the host of the transaction offer platform 100; wherein the expected profit is for the transaction offer offeror 148; and wherein the expected profit is for a weighted combination of the profit for at least two of the primary offeror 144, the host of the transaction offer platform 100, the user 154, and the transaction offer offeror 148.

In embodiments optimizing is based on user demographics. In embodiments user demographics are provided by a primary offeror or vendor 144 or by the user 154. In embodiments the user demographics include a user location. In embodiments the demographics include an IP address.

In embodiments the user demographics include at least one of user connection speed and user browser type. In embodiments optimizing is based on historic transactions associated with a primary vendor or offeror 144. In embodiments the historic transactions include selection of transaction offers 160. In embodiments optimizing is based on a URL associated with the primary offer 164. In embodiments optimizing includes reducing adverse selection. In embodiments an automatic process selects the transaction offer 160 from a plurality of transaction offers 160. In embodiments the automatic process is an optimization process that is directed at optimizing a parameter that is associated with the transaction offer 160. In embodiments the parameter is a measurement of user interest in the transaction offer 160. In embodiments the parameter represents at least one of network traffic, a conversion rate measuring a proportion of users 154 who accept the transaction offer 160, overall profit of a transaction, payout amount, and total volume of completed transaction offers 160.

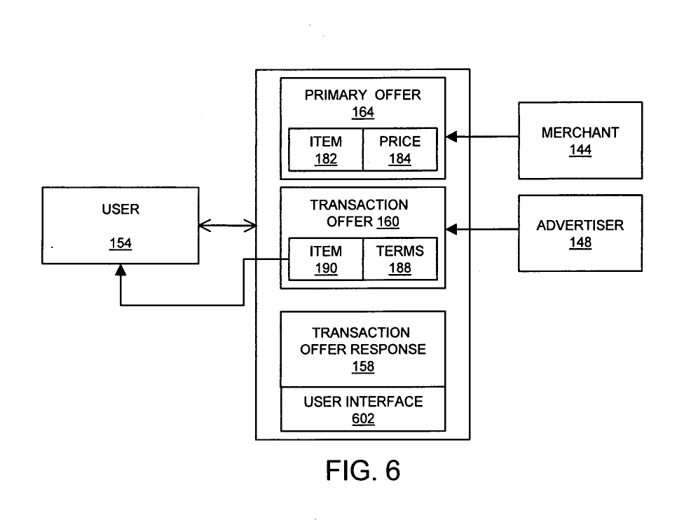

Referring to FIG. 6, in one preferred embodiment methods and systems are provided herein for providing a user interface to a transactional offer platform 100. Such methods and systems may include, in an environment in which a user 154 is presented with a primary offer 164, providing an interface 1802 that allows a user to view at least one transaction offer 160. Such methods and systems may include identifying an alternative form of payment for the primary offer 164; presenting a transaction offer 160 from at least one transaction offer offeror 148; and upon user 154 selection of a transaction offer 160, providing an interface 602 by which a user 154 accepts the selected transaction offer 160 which is independent of the user obtaining an item 182 offered in the primary offer 164. In embodiments the user interface 1802 may maintain the same appearance as the environment of the primary offer 164.

In embodiments the interface maintains the same ecommerce environment of the primary offer 164. In embodiments the transaction offers 160 are ranked. In embodiments presenting the transaction offers 160 includes promoting a visual prominence of the higher ranked transaction offers 160. In embodiments the highest ranked offer is presented to influence the user 154, such as toward selecting the highest ranked offer. In embodiments the interface 602 includes presenting real-time status of the user's 154 acceptance of the transaction offer 160. In embodiments the interface 602 allows a user 154 to view the user's activity associated with prior primary offers 164. In embodiments the interface 602 allows a user 154 to view the user's 154 activity associated with prior transaction offers 160. In embodiments the interface 602 allows a user 154 to view a receipt of a primary offer 164, a transaction offer 160, and an association there between. In embodiments, upon satisfaction of the obligation, methods and systems may include providing an interface 602 by which the fulfillment of the primary offer 164 is initiated. In embodiments fulfilling the primary offer 164 includes at least one of downloading digital content to the user 154 and providing access to a premium service. Methods and systems may further include activating at least one of the digital content and the premium service. In embodiments fulfilling the primary offer 164 includes receiving a mailing address of the user 154 for delivery of the primary offer 164.

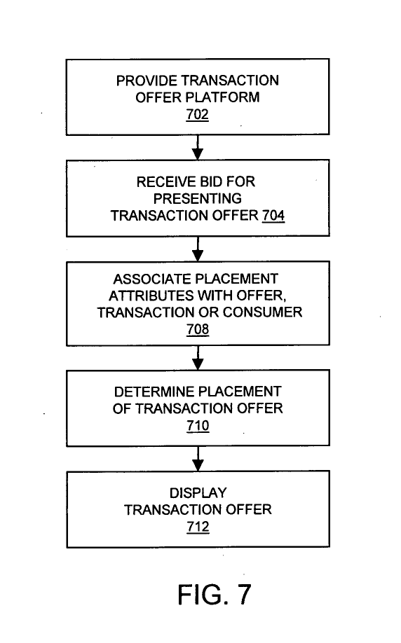

Referring to FIG. 7, methods and systems disclosed herein may include methods and systems for facilitating transactional offer bidding. Such methods and systems may include: at a step 702 providing a platform for presenting transaction offers as an alternative to payment for a primary offer 164; at a step 704 receiving a bid for presenting the transaction offer 160, wherein the bid includes placement attributes; at a step 708 associating the placement attributes with at least one of the primary offer 164 and a user related to the primary offer 164; at a step 710 determining a placement of the transaction offer 160 based on the association of the placement attributes and a bid amount; and at a step 712 displaying the transaction offer 160 in the determined placement in the presentation of transaction offers 160. In embodiments the placement attributes include at least one of a user attribute, characteristic or property, a location of placement, a time of placement, a size of placement, and proximity of placement to another offer. In various embodiments, bids may be for user properties (or a combination of such properties) and placement is the outcome of those bids. If advertisers bid on a “generic” user 154, in effect they are bidding on placement.

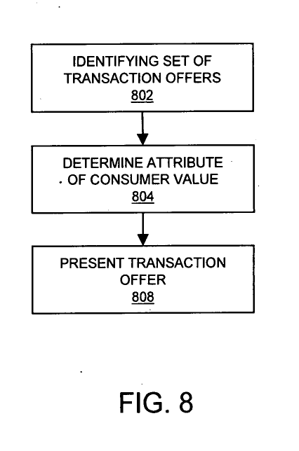

FIG. 8 shows steps associated with methods and systems for optimizing user value associated with a transactional offer platform 100. Such methods and systems may include: at a step 802 identifying a set of transaction offers 160; at a step 804 determining an attribute of user value associated with at least one of the transaction offers 160; and at a step 808 presenting the one or more identified offers based on the user value attribute. In embodiments the relationship is the likelihood of the user accepting an offer. In embodiments the user value is a value to a transaction offer offeror 148. In embodiments the optimized relationship is related to the transaction offer offeror 148 payment amount. In embodiments the user value is a lifetime user value. The embodiment may further include adjusting one or more aspects of the identified offers based on the user value. In embodiments the determination of a user value includes comparing the user value to a transaction offer 160 threshold. In embodiments in response to the determination exceeding the transaction offer 160 threshold, the transaction offer 160 is included in a presentation of transaction offers 160 to the user. The embodiment may further include determining a payment to a primary vendor 144 based on user value. In various other embodiments, optimization may be based on any of the optimization factors described throughout this disclosure, including the factors described in connection with FIG. 5

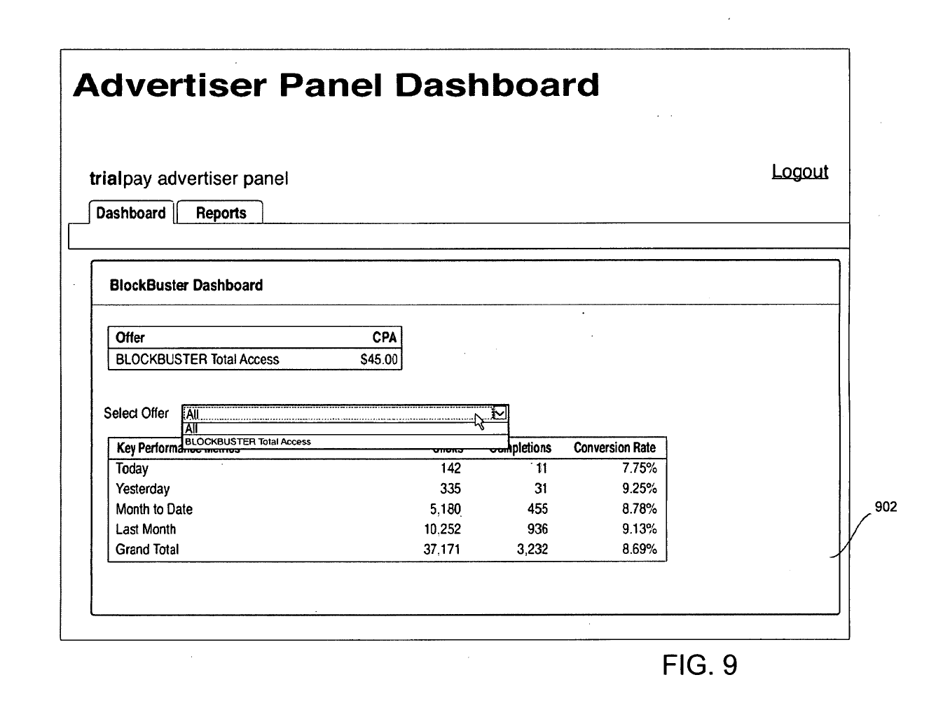

FIG. 9 shows a screen 902 shown to an advertiser 148 by which an advertiser 148 or transaction offer offeror 148 may track performance of transaction offers 160 offered through the transaction offer platform 100. An advertiser 148 may track the clicks associated with each transaction offer 160, the conversions of users 154 with respect to each transaction offer 160 and other statistics associated with each transaction offer 160.

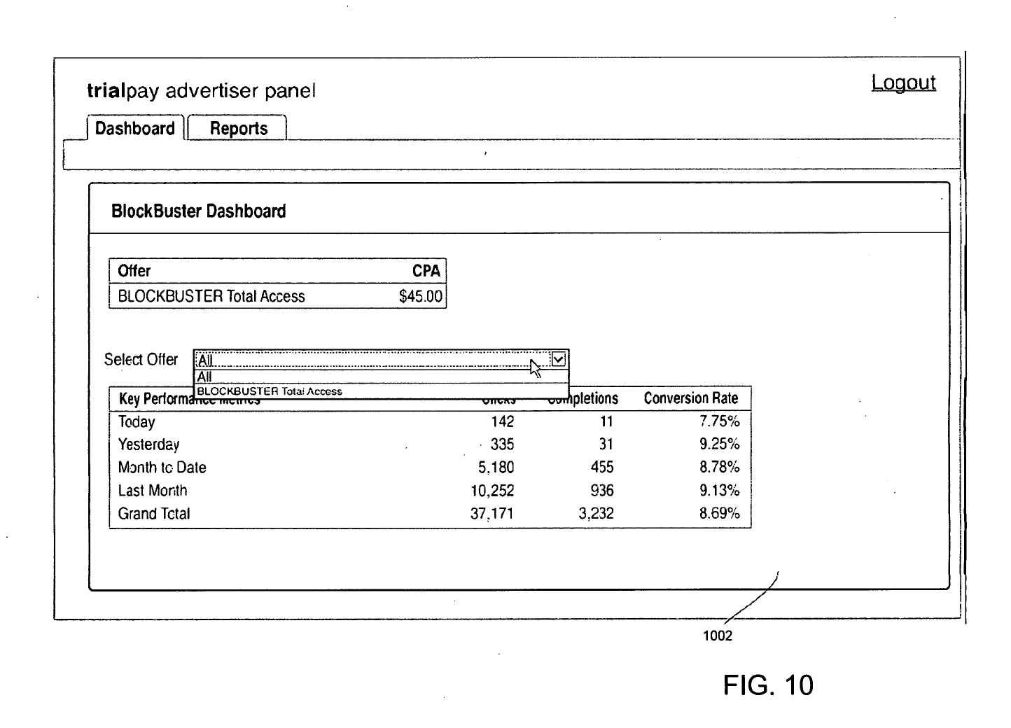

FIG. 10 shows a screen 1002 with additional details as to the interface 1002 of FIG. 10.

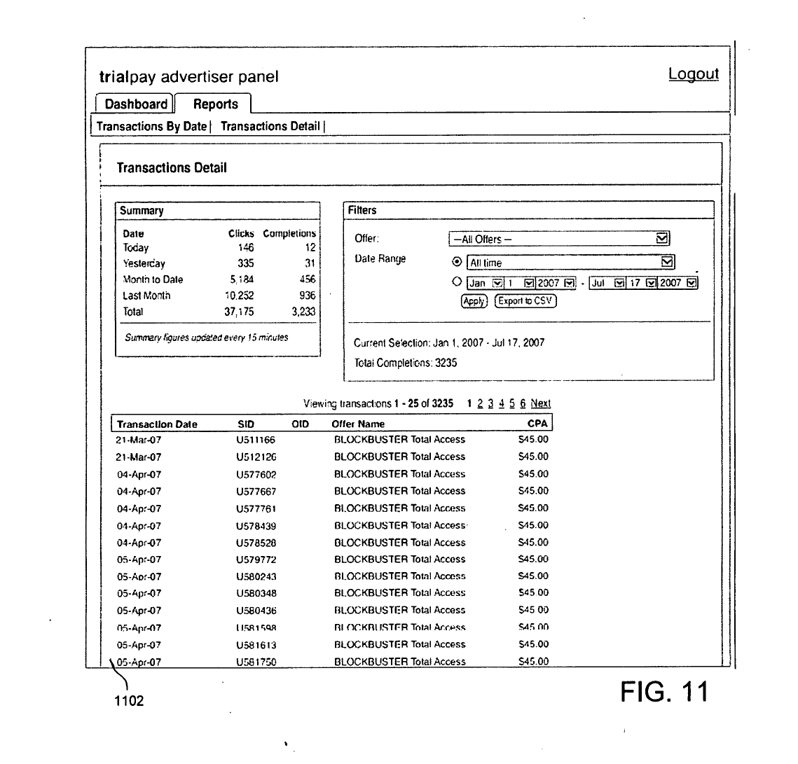

FIG. 11 shows a screen 1102 shown to a transaction offer offeror 148 with statistics as to performance of a transaction offer 160 offered through the transaction offer platform 100. A report may provide transaction detail as to each transaction entered into by a user 154 with respect to each transaction offer 160.

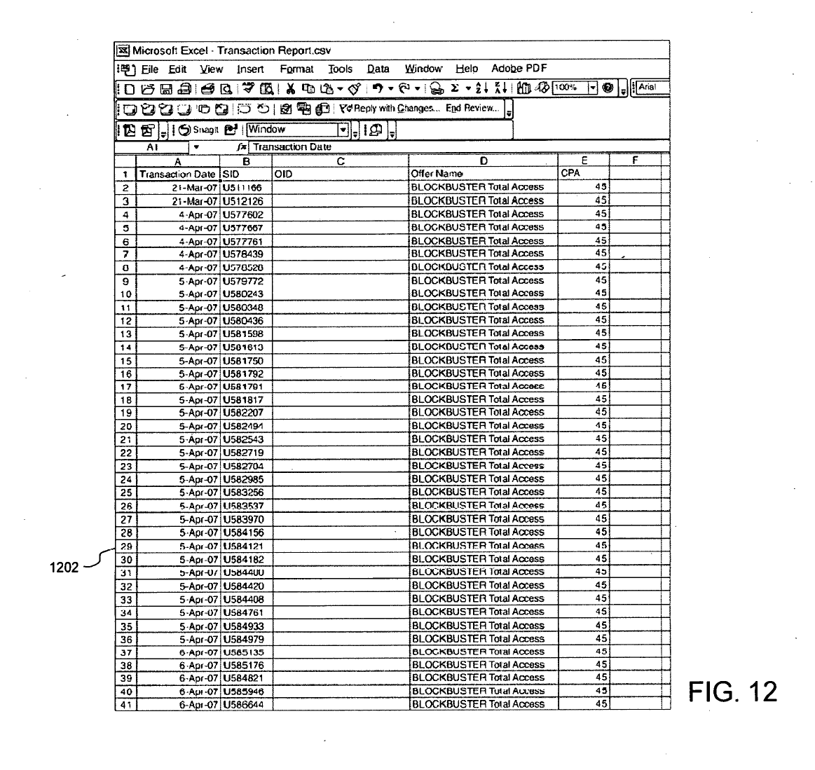

FIG. 12 shows a screen 1202 where a user 154 is shown a detailed transaction report associated with performance of a transaction offer 160 offered by an advertiser or transaction offer offeror 148 through the transaction offer platform 100.

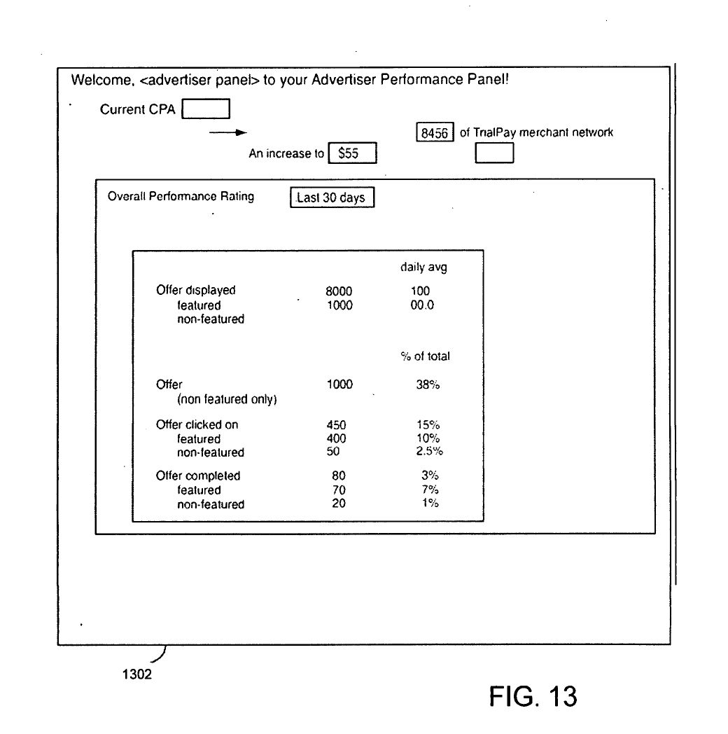

FIG. 13 shows a screen 1302 where an transaction offer offeror 148 is shown a detailed reported associated with the advertisers performance of transaction offers 160 offered by a transaction offer offeror 148 through the transaction offer platform.

In embodiments financial terms associated with fulfillment of the transaction offer 160 is based on the user geographic location. In embodiments financial terms associated with fulfillment of the primary offer is based on the user 154 geographic location. In embodiments the transaction offers 160 are presented in response to a user declining a primary offer. In embodiments the transaction offers 160 are presented in response to a user 154 uninstalling digital content. In embodiments the transaction offers 160 are presented for a user to upgrade a primary offering 164. In embodiments the transaction offers 160 are presented within a computer game environment. In embodiments the upgrade is access to selected levels in a computer game. In embodiments the transaction offers 160 are related to the primary offer 164

In embodiments the transaction offer 160 is based on an upcoming event. In embodiments the event is at least one of Valentines Day, Thanksgiving, mother's day, father's day, Memorial day, July 4^{th}, and the like. In embodiments the event is related to the user 154. In embodiments the user 154 related event is at least one of a birthday, an anniversary, a marriage, a new baby, a promotion, and the like. In embodiments the transaction offer 160 is associated with a fulfillment process. In embodiments the fulfillment process includes providing a transaction offer offering 148 to the user 154. In embodiments the transaction offer offering 148 is a physical object. In embodiments the primary offering is not a physical object. In embodiments the primary offering converts a trial copy of software to a full version of software. In embodiments the primary offering is selected from the group consisting of a product, a service, a good, a premium good, a wine club subscription, a software package, an online service, a subscription-based offering, a newspaper/magazine/professional subscription, an offering with a one-time purchase price, or the like. In embodiments a transaction offer offering 148 is selected from the group consisting of a product, a service, a good, a premium good, a wine club, a software package, an online service, a subscription-based offering, a newspaper/magazine/professional subscription, an offering with a one-time purchase price or the like.

Methods and systems may include identifying a plurality of transaction offers 160 that correspond to a primary offer 164. In embodiments the transaction offers 160 are offers from a plurality of providers. Methods and systems may include providing a transaction facility for resolving fulfillment of a transaction offer 160 if the user 154 accepts the transaction offer 160. In embodiments the transaction facility is adapted to fulfill transaction offers 160 of a plurality of merchants. Methods and systems may include first presenting the transaction offer 160 to the user 154. Methods and systems may further include initiating a primary fulfillment process, upon receiving the user's 154 acceptance. In embodiments the primary fulfillment process is associated with delivering the primary offering to the user. Methods and systems may further include initiating a transaction offer fulfillment process, upon receiving the user's 154 acceptance. In embodiments the transaction offer fulfillment process is associated with delivering the transaction offer 160 to the user 154. Methods and systems may include initiating a payment process for both debiting a transaction offer entity and crediting a primary entity. In embodiments the transaction offer entity is associated with the transaction offer 160 and the primary entity is associated with the primary offer 164.

In embodiments the primary entity is a vendor, retailer, seller, dealer, trader, purveyor, merchant, advertiser, sales person, affiliate, supplier, service provider, or the like. In embodiments the transaction offer entity is a vendor, retailer, seller, dealer, trader, purveyor, merchant, sales person, affiliate, supplier, service provider, or the like. The embodiment may further include charging the user for the primary offer, and upon receipt of confirmation of the user acceptance of the transaction offer 160 crediting the user a predetermined amount.

The transaction offer platform 100 may facilitate purchase transactions that include conventional (e.g. non-alternative) payment means, such as direct credit card processing, indirect credit card processing through a third party, and the like. Conventional purchase transactions may be facilitated with the powerful capabilities of the platform to seamlessly incorporate transaction offers as part of the transaction, resulting in blended or hybrid transactions as herein describe. Because the platform provides significant flexibility in sourcing and presenting offers, a merchant's ability to offer highly desirable offers is essentially unlimited.

Another advantage of the platform 100 for conventional payment transactions is that the user may receive reimbursement against the current transaction by fully accepting one of the offers. This is distinct from ‘post-purchase’ offers that propose to provide a discount to a user on a future purchase, or offers that require a user to select a particular form of payment to gain a discount. At least because the platform may facilitate the payment directly, offers can impact the amount charged to the user's form of payment for the current transaction.

Transaction based offers, such as conventional purchase transaction offers that are provided through the platform 100 are advantageous in that information from the user, the merchant, the platform, and the advertiser making the offer may be combined and provided to the advertiser, or transaction offer offeror. At least some of the information provided to the advertiser may be user related information that may allow the advertiser to begin a business relationship with the user, maintain an existing business relationship with the user, conduct a transaction with the user, any and all combinations of the foregoing, and the like.

By supporting blended purchase transactions and a powerful offer selection and optimization engine that can target ads that protect business interests of the merchants, the platform 100 enables merchants to have high confidence that the offers presented to the merchant's users at the critical purchase authorization stage will be viewed by the user as beneficial rather than annoying or disruptive. This allows the merchant to direct all purchase transactions to the platform 100 without concern for losing sales or promoting competition with are both serious concerns with keyword based ad serving systems.

The platform supports a business model that ensures profitable transactions for the merchant and the platform facilitator when a blended purchase transaction is executed, because the advertiser pays a fee to the platform in conjunction with an accepted offer. The platform benefits the user in a blended transaction because a blended transaction executed through the platform enables a user to choose a form of payment, such as credit card, debit card, third party payment service (e.g. PayPal), and the like while taking advantage of a transaction offer presented during the payment transaction. In an example, a user making a purchase transaction may be presented with a choice of payment options including an option to open a credit account, such as with a 0% interest rate to allow for interest free payment over time. This offer benefits the user because the user can spread the payments that total the purchase price over the 0% interest rate term. However, the new credit card may not be applied to the primary transaction. By signing up for the 0% credit card, the user and the vendor providing the credit card offer enter a business relationship that is facilitated by the platform. The advertiser pays the platform for facilitating access to a new customer. The merchant may receive a portion of the advertiser payment as an incentive to use the platform for purchase transactions. The user may receive a portion of the advertiser payment as an incentive to signup for the credit card. These and a wide variety of other uses of the fee paid by the vendor/advertiser are possible with the methods and systems of the transactional offer platform.

Another example is simply to offer a consumer the opportunity to receive a coupon from an online retailer. Benefit to consumer might be $10 off any purchase for new customers. Benefit to advertiser might be a new business relationship with a consumer

The transaction offer platform 100 may facilitate a reduction, elimination, or reversal of fees typically paid by merchants for purchase transactions using conventional means. Fees may typically be charged to a merchant by a payment processor, bank, or other transaction offer redemption facilitator that accepts a user form of payment, such as a credit card. While the user form of payment may be charged a full purchase amount, the amount paid to the merchant is usually reduced by the fee charged. A prepayment transaction, such as this may be required for the user to receive the item that the user has selected to purchase and for the merchant to receive payment for the item. Typically, the merchant does not receive compensation directly from the user, instead the user authorizes a third party, such as credit card provider, bank, and the like to make a payment to the merchant on the user's behalf and the third party collects the user authorized purchase amount from the user through a billing or debiting process. Although the merchant agrees with the user to sell the item, service, subscription or the like at a fixed price and the user agrees to pay the fixed price, the merchant receives less than the fixed price from the user's authorized third party because the third party retains a portion of the fixed purchase price as a transaction fee. The transactional offer platform 100 may facilitate fee-based payments while enabling the merchant to receive the full amount paid by the user

By providing the merchant with such an opportunity, the merchant may allow the platform to prepare and present offers, such as transactional offer offers to the user at various times during the purchase transaction process. The merchant may also provide the platform with information related to the user that may allow the platform to identify and prepare offers that may be relevant to the user. In addition to user related information, the merchant may provide information related to other users with which the merchant has or had engagements, such as prior purchases and purchases made by other users. The platform may combine the information provided by the merchant with other information available to the platform as herein described, and use the combined information to select one or more offers targeted at the user. The offer selecting, optimizing, processing, and other features and capabilities of the platform as herein described may be applied to this process. The offers, such as transaction offer offers as herein described may be provided to the user.

The merchant may receive compensation, such as an amount equal to a financial transaction fee described herein that may be charged by a transaction service provider, for engaging the platform to make offers to the user during the checkout/payment transaction process. The amount of merchant compensation may be variable, using the methods and systems for determining merchant payments as herein described. In this way a merchant may offer an item or service at a fixed price; the user may agree to purchase the item or service for the fixed price and provide a form of payment to pay the fixed price; and the merchant may receive a fee-reduced amount provided through the form of payment_plus an amount based on an agreement with a facilitator of the platform. In this way the merchant may receive the full amount paid by the user. Based on a wide variety of factors such as the perceived value of the user to the platform or to an advertiser, the amount of merchant compensation may be adjusted to be more, less, or the same as the transaction fee.

The offers provided to the user may be provided at various points during the checkout or purchase transaction process. The user may be presented offers after the user has agreed to make a purchase and has selected the payment method, such as the type of credit card. Offers presented at this point may be based at least in part on the form of payment selected. Alternatively, the user may be presented offers after the user has entered payment information, such as a credit card number. Based on the credit card number and information related thereto that may be available to the platform, such as a credit rating, a purchase history, address information, a credit limit, and the like, one or more offers may be selected. Additionally, this information may affect the amount of merchant compensation for using the platform to present offers. A user with a high credit score or high credit limit, may be deemed to be of higher value than low credit score users and the merchant may receive comparatively more compensation. In an example, one or more offers may be presented during a payment confirmation page, so that the user may receive a reimbursement against the completed transaction by fully accepting one of the offers.

Because offer selection can be based on a wide variety of factors, including without exclusion important information about the user, the offers can be targeted to the user in ways that typical ‘post-purchase-decision’ offers cannot be targeted. Instead of the offers being based on the item being purchased or merchant-centric information, the offers can be independent of the item being purchased and do not have to be related to merchant inventory. The platform provides significant flexibility in sourcing and presenting offers that allow the merchant to gain access to an essentially unlimited number of offers for users.

The platform may play a critical role in providing advertisers with access to a user during one or more critical points in the purchase transaction process. Access to the user may be in the form of information related to or otherwise identifying the user in terms that are important to the advertiser. To receive the information that facilitates access to the user, the advertisers may pay a fee to the platform. The fee may entitle the advertiser(s) to receive information about the user and/or transaction that may allow the advertiser to begin a business relationship with the user, maintain an existing business relationship with the user, conduct a transaction with the user, make adjustments in offers to improve offer performance as herein described, and the like. The advertisers may also compensate the platform for presenting the offers, and/or for the user accepting the offer and/or for the user fulfilling requirements of acceptance of the offer, and the like. The platform 100 may facilitate a user 154 and an advertiser 148 to engage in or support an existing business relationship.

By receiving compensation from the advertiser(s), the platform may distribute the compensation to the user, the merchant, to a facilitator of the platform, and the like. The platform may act as an intermediary during the payment transaction so that the platform pays the purchase transaction fee to the financial institution as herein described. In this way, the platform may be able to reduce the cost of the transaction fee charged by the financial institution because of a large volume of transactions performed for a plurality of merchants through the platform.

Offer selection, optimization, presentation, primary and transaction offer fulfillment, and offer types, all herein described, may apply to purchase transaction based offers independent of the location of the purchase (e.g. on-line, point of sale, and the like).

Referring again to FIG. 2, the flow diagram 250 shows certain actions that may take place in the context of some embodiments of the transaction offer platform 100. At least one of these embodiments may be a purchase transaction based embodiment as previously described.

At step 252, the primary offeror 144 (also referred to herein, without limitation, as the merchant) may offer the primary offer 164 to the user 154.

At step, 254, the user 154 may begin a merchant transaction to purchase the primary offer 164. In some embodiments, beginning the merchant transaction may involve selecting a “check-out” option in an online shopping cart containing the primary offer 164. It will be understood that a variety of embodiments are possible, including, without limitation, single click purchase actions commonly referred to as “buy it now” transactions, automated self-serve checkout stations, and the like.

In at least the purchase transaction offer embodiment, the user 154 may be associated with user data that relates to aspects of the user 154 and/or aspects of the merchant transaction. In some embodiments, the user data may include demographic information 174 about the user; information about an online shopping cart of the user; information about the online shopping cart's contents; information about the primary offeror 164; any and all combinations of the foregoing; or the like. At least some of the uses of this information are described herein for conventional purchase transaction offers.

At step 260 the transaction offer offerors 148 (also referred to herein, without limitation, as the advertisers) may specify the transaction offers 160 (also referred to herein, without limitation, as the transaction offers). Each of the transaction offers 160 may be associated with target data including without limitation demographic, merchant, and/or shopping cart data. For example and without limitation, the transaction offer offeror 148 may be a local restaurant; the transaction offer 160 may be a $20 gift certificate to the local restaurant, the gift certificate priced at $5; and the target data may include zip codes in the local restaurant's service area.

At step 258, the facilitator 150 may analyze the transaction offers 160 in light of user data in order to select which, if any, of the transaction offers 160 might be presented to the user 154.

At step 262 and based upon the analysis of step 258, the facilitator 150 may select which, if any, of the transaction offers 160 will be presented to the user 154. In some embodiments, the platform 100 and/or the facilitator 150 may select those transaction offers 160 having ad target data that is more or less associated with the user data. For example and without limitation, the ad target data may be data associated with an offer and may include a zip code and radius (e.g., 02138 and 5 miles) and the user data may include a zip code (e.g., 02140). In this example, the ad target data and the user data may be associated in that a geographic area defined by the user's zip code intersects a geographic area defined by the target data. For another example and also without limitation, the target data may include a musician's name (e.g., Victor Wooten) and the user data may include another musician's name (e.g., Marcus Miller). In this example, the target data and the user data may be associated by collaborative filtering, the collaborative filtering determining that a user who is purchasing a primary offer 164 having “Marcus Miller” in the target data (e.g., an MP3 file featuring Marcus Miller) may be interested in a transaction offer 160 having “Victor Wooten” in the target data (e.g. subscribing to Victor Wooten's promotional mailing list). In still another example and also without limitation, the target data may include a threshold shopping cart value (e.g., $5,000) and the user data may include the total cost of all items in the user's online shopping cart (e.g., $7,359). In this example, the target data and the user data may be associated in that the total cost of all items in the user's online shipping cart exceeds the threshold shopping cart value. It will be understood that a variety of correlations between the target data and the user data are possible.

As a result of a committed transaction or intent to purchase a product through an electronic transaction, the purchaser may receive a transaction offer. The transaction offer may be based on the instantaneous transactional content that may include the information related to the purchaser at the time of transaction, or generally associated with the purchaser. The transactional content may include a credit card number, an address, location, the URL used for making the transaction, the country of transaction, or some other type of attributes entered by the purchaser while conducting the transaction. In contrast to conventional advertisement and offer targeting which may associate user preferences or history with demographic data to determine potentially relevant offers or advertisements, a transaction offer can take advantage of extensive specific information that is only available in connection with the transaction. While conventional offer matching methods may recognize a user history that includes a type of credit card that a user may have provided in the past, a transaction offer can be based on the card being used in the current transaction and important information related to the card, such as approval status of the card in the current transaction. Other information may include the actual shipping address of the current transaction rather than a general localization offered by Internet Service Providers based on an IP address of a user's computer. Transaction specific information may include descriptions of items actually being purchased, rather than items that may have been added to an electronic shopping cart that was discarded. In one example, the purchaser may commit to purchasing a Rolex watch using a Visa credit card, which may result in a transaction offer that the user may find to be complimentary such as a discount for watch repair services. Another immediate transaction specific context for offer selection may include the transaction amount. By applying a threshold comparison to the instant transaction amount, transaction offers may be selectable based on the transaction exceeding the threshold.

The platform may implement one or more algorithms, rules, procedures, programs, and the like to ensure that the transactional offers are not annoying or disruptive for the client and also protects the business interest of the merchant. Conventional electronic shopping offer methods and systems often rely on the preferences or behaviors of other users to present items to add to an existing shopping transaction. These offers can often be disruptive because although they may be related to an item being added to an electronic shopping cart, they are not well related to the current transaction and/or user-specific aspects of the current transaction. Similarly, merchants using the transaction offer methods and systems as described herein want to make valuable offers to their customers while protecting their own business interests. In this way, an on-line vendor of watches may not want to offer a customer a discount for a purchase of a watch at a competitor. However, as described in the example above, watch repair or restoration services may complement the on-line watch retailer's offerings and therefore may make for a potentially valuable and highly relevant transaction offer.

Selection of a transaction offer may be based partially on the instantaneous transactional content as well as one or more attributes of the purchaser without deviating from the scope and spirit of the invention. For example, the transaction offer may be provided based on the credit card used by the purchaser at the time of purchase and the purchase history of the purchaser.

The transactional offer may be associated with the type of transaction and the amount of transaction apart from other parameters. Examples of transaction types may include mode of payment, i.e. credit card, e-check, electronic fund transfer, debit card, electronic purse, and the like. Additional information associated with the mode of payment may influence the selection of offer. For example, the name of the bank and the type of credit card (platinum, gold, or silver) that the purchaser is holding may directly be correlated to the offer. In another example, the type of card and the purchase amount may influence the transaction offer. In addition, the transaction offer may be based on shipping address; for example, the shipping address may include zip code, country code, town state, locality, and the like. The purchaser may accumulate products in the shopping cart with an intention to purchase them or in the process of making a transaction. In this scenario, the transaction offer presented to the purchaser may be partially or completely based on the shopping cart. In another scenario, the purchaser may be registered with the primary merchant. The primary merchant may issue an alpha numeric code to the purchaser, which the purchaser may enter at the time of the transaction to validate the relationship claim with the primary merchant. Alternatively, the purchaser may be registered with the online site provider, who may in turn validate the purchaser's relationships with merchants via a database that maintains such data. Accordingly, the transaction offer may be presented in correlation with the purchaser's relationship with the primary merchant.

In embodiments, the transaction offer presented to the purchaser may depend upon the transaction status. Intermediate states may include payment credited, payment approved for crediting, payment promised but not initiated, or any other type of intermediate state. For example, the transaction offer may differ based on the state of transaction. In addition, the time and date of the year may also influence the transaction offer presented to the purchaser. It may be noted that the disclosed method and system may present transaction offers that depend on the current transaction and may not be based on keyword search, product comparison, client recommendation, product ratings, blogs, recommendations, or some other type of parameters.

In embodiments, the transaction offers presented to the purchaser may benefit both the merchants and the purchasers. The merchants may advertise their products by offering free trial in anticipation of increasing sales. The purchasers would benefit from it by availing free trial of product, or by accepting the free discount available to them.

At step 264, the transaction offers 160 selected for presentation to the user 154 are presented to the user 154. In some embodiments, these transaction offers 160 are provided to the user 154 as a more or less integral part of a check-out experience associated with the online shopping cart containing the primary offer. It will be understood that a variety of embodiments are possible for providing these transaction offers 160 to the user 154.

For example and without limitation: When the user 154 selects the check-out option on the online shopping cart, the user 154 may be presented with a confirmation page showing the contents of the shopping cart. The confirmation page may include a user interface element labeled “For an extra $5, add a $20 gift certificate to Charlie's Kitchen to your order. A $20 value for only $5!” Alternatively or additionally, the confirmation page may also include a message that reads, “Text ‘GO CHARLIE’ to short code 123456 to add the gift certificate to your order now.” In this example, the transaction offer offeror 148 may be a restaurant named Charlie's Kitchen; the transaction offer 160 may be a $20 gift certificate to Charlie's Kitchen, the gift certificate priced at $5; the target data may include the 02138 zip code, the zip code in which Charlie's Kitchen resides; and the user data may include 02140, a zip code in the vicinity of 02138.

At step 268, the user 154 may accept the transaction offer 160 by responding to it. In some embodiments responding to the transaction offer 160 may involve selecting a user-interface element provided to the user 154 during the check-out experience. Continuing with the previous example, without limitation the user 154 may click on the user-interface element. Also continuing with the previous example, without limitation the user 154 may text the string ‘GO CHARLIE’ to short code 123456. It will be understood that a variety of methods for responding to the transaction offers 160 are possible.

Then, at step 270, the user 154 may receive the accepted transaction offer from offeror 148. Accepting the transaction offer may result in the transaction offer offeror 148 receiving information about the user 154 that allows the transaction offer offeror 148 to begin a business relationship with the user 154; to maintain the business relationship with the user 154; to conduct a transaction with the user 154; any and all combinations of the foregoing, and the like.

As described herein and elsewhere, the user 154 may accept the transaction. By accepting the transaction, the user 154 may avail the free transaction offer without any obligation to use the offer. The transaction offer may be in the form of a digital instrument or a physical instrument. Digital instruments may include electronic coupons, e-cash, e-check, a digital certificate, a digital code, or some other type of digital instrument. Similarly, the transaction in the form of a physical instrument may be a printed contract that may be physically exchanged for the promise made on it. The physical instrument may include discount coupons, special offers, offer printed in newspaper, mailer, or some other type of physical instruments.

In embodiments, the user may receive a transaction offer in the form of an electronic coupon. Electronic coupons may be stored locally or may be provided through a reference location in the network. Electronic coupons may provide an advantage in that they may include the capability to be organized in different ways, such as date of receipt, expiry date, vendor, or manufacture, and the like. The electronic coupon may include the capability to refresh periodically or may offer discounts based on the total amount of purchase made by the user 154. The user 154 may periodically receive electronic coupons based on past purchases or based on the user information. User information may include age, address, profession, credit card number, email id, and the like. In another embodiment, the user may receive a transaction offer through email. An attachment may be provided with the email that can be utilized to avail the offer associated with it while making an online purchase. In another embodiment, the user 154 may download a small program that may be executed on the user device such as a mobile phone, a PDA, a computer, a laptop, a palmtop, and the like that may periodically pop information regarding various transaction offer opportunities.

In embodiments, the transaction offer may be in the form of an e-check that the buyer may offer as a gift for the last transaction. For example, as a result of the transactions, the user 154 may be offered a PayPal e-check that can be credited to the users account without any obligation. PayPal may promote this e-check to the user 154 by providing the user with a free trail without any obligation to enroll for e-check services with PayPal. In this example, the user 154 was provided with PayPal e-check since the user 154 had used the PayPal service for purchasing goods; therefore the transaction offer is not disruptive. In embodiments, the transaction offer may be in the form of a digital certificate that may be exchanged in the next purchase without any obligation to buy or make the next purchase. The digital certificate may be stored in the user 154's device or may be stored in the form of a cookie in the browser and may be automatically instantiated at the time of purchase. In another embodiment, the digital certificate may be delivered to the email address of the user 154.

In embodiments, the transaction offer may be in the form of a physical instrument such as a printed discount coupon, special offers, or some other type of physical instrument carrying a promise. For example, the user 154 may receive a discount coupon for buying two bottles of wine as a reward for making a transaction. In another example, the user 154 may be offered a free subscription to a club for one month as a part of the current transaction without requiring an obligation to use the offer. The transaction offer may include conditions, such as an expiration date or a ‘valid’ date. In an example, the user 154 may be provided with a mailer that promises a discount on the purchase of a cake on June 21. The platform 100 may access user information after or during the transaction and associate this information to the transaction offer being made to the user 154. In the above example, the platform determined that June 21 happened to be an anniversary of the user 154. In embodiments, the transaction offer may be a physical instrument that may be in the form of a physical product such as a free product or a service. For example, a user 154 may be provided with a free air ticket in the delivery of an item purchased in a transaction.

It will be understood that a variety of embodiments of the engagement are possible. For example and without limitation: In some embodiments, the engagement may involve providing to the user 154 information associated with the transaction offer offeror 148 and/or the transaction offer 160. In some embodiments, the engagement may involve the user 154 providing information to the transaction offer offeror 148. In some embodiments, the engagement may involve the user 154 giving permission to the facilitator 150 to release to the transaction offer offeror 148 information relating to the user 154. In some embodiments, the engagement may involve providing an incentive or enticement to the user 154 in exchange for the user's providing information to the transaction offer offeror 160. In some embodiments, the incentive or enticement may without limitation comprise a cash payment, a credit, incentive points (e.g., frequent flier miles or the like), any and all combinations of the foregoing; or the like.

Upon completion of the engagement, the facilitator 150 may credit the merchant as shown in step 272; the user may receive a benefit as shown in step 274; the facilitator 150 may retain a credit as shown in step 278; and the facilitator 150 may debit the transaction offer offeror 148.

The debit applied to the transaction offer offeror 148 may be a function of an aspect of the engagement. In some embodiments, the aspect of the engagement may be a type or extent of the engagement may influence the debit. It will be understood that a variety of aspects and functions may be possible.

The credit provided to the merchant and the credit retained by the facilitator 150 may each be a portion of the debit to the transaction offer offeror 148. Additionally or alternatively, the user 154 may pay an engagement fee to the facilitator 150. The facilitator 150 may retain part of the engagement fee and distribute part of the engagement fee to the primary offeror 164.

The user benefit may include or be associated with the transaction offer 160. In some embodiments, the benefit may include a coupon, a frequent flier mile, cash or cash back, advertising or promotional content a prospect of exclusive deals, and the like.

Throughout the merchant transaction, the facilitator 150 may act on behalf of the primary offeror 164. The facilitator's 150 actions may be associated with providing and/or enabling the merchant transaction between the user 154 and the primary offeror 144. Additionally, the facilitator's actions may be associated with providing and/or enabling the engagement between the user 154 and the transaction offer offeror 148.

In some embodiments, the facilitator 150 may provide an online shopping cart and/or checkout sequence that enables the merchant transaction between the primary offeror 164 and the user 154.

In some embodiments, primary offeror 164 may provide its own online shopping cart and/or checkout sequence. Systems providing the primary offeror's online shopping cart and/or checkout sequence may communicate with the facilitator 150 via system-to-system calls. These calls may be enabled by an API, SDK, software plug-in, or the like. Offers or advertisements, could be presented through the merchant's shopping cart/checkout interface facilitated by the API, and the like. The API, SDK, software plug-in, or the like could embody any portion of the platform functionality. In an example, an online retailer may already use an existing shopping cart platform, such as a proprietary platform or a commercial third-party platform, to process payments. In this example the traditional shopping cart platform may provide certain benefits to the retailer such as tight integration with inventory systems. In this example, the retailer can take advantage of the blended transaction capability of the transactional offer platform 100 through use of software, such as the API which can add the blended payments capability to the existing traditional shopping cart platform. By incorporating programming in the retailer checkout system that supports a functional interface with the platform 100 for offer selection, presentation, and fulfillment, the retailer can process the user's primary purchase through their system while gaining the advantages that the transactional offer platform 100 provides through blended and/or transactional offer transactions. Further in this example, a user of the retailer purchase system may be offered, through the API interface, an option to accept a coupon for a discount at another retailer. If the user accepts, the coupon can be delivered to the user by the platform 100 while the user completes the item purchase from the retailer. Because the advertisement/offer targeting facilities of the platform have determined that the user meets an acceptability criteria for the coupon, the vendor or advertiser providing the coupon to be offered to the user pays the platform for, among other things, proper delivery of the coupon to the user. The foregoing example shows how an API-based embodiment of the methods and systems of the transactional offer platform 100 provides essentially the same benefits to a user, a merchant, an advertiser, the platform facilitator, and the like, as providing the full payment transaction through the platform 100.

In another example, a user makes an on-line purchase of music with a total transaction amount of $250. The on-line music retailer uses the API interface of the platform 100 and provides context of the transaction to the platform through the API. The platform determines, using the offer optimization and targeting capabilities herein described, that the user making this transaction is a good customer for a high end outdoor adventure clothing retailer and presents a discount coupon for a future purchase at the high end outdoor adventure clothing retailer to the user during the purchase transaction. If the user accepts the offer, the coupon may be added at no cost to the user's list of items being purchased during the transaction. For fulfilling the identification, offers presentation, and proper delivery of the coupon, the outdoor clothing retailer pays the platform a fee, similar to an advertising delivery fee. At the conclusion of the blended transaction, the user has received a free coupon along with the selected music for $250 without having to take on any obligation to use the coupon or visit the outdoor clothing retailer.

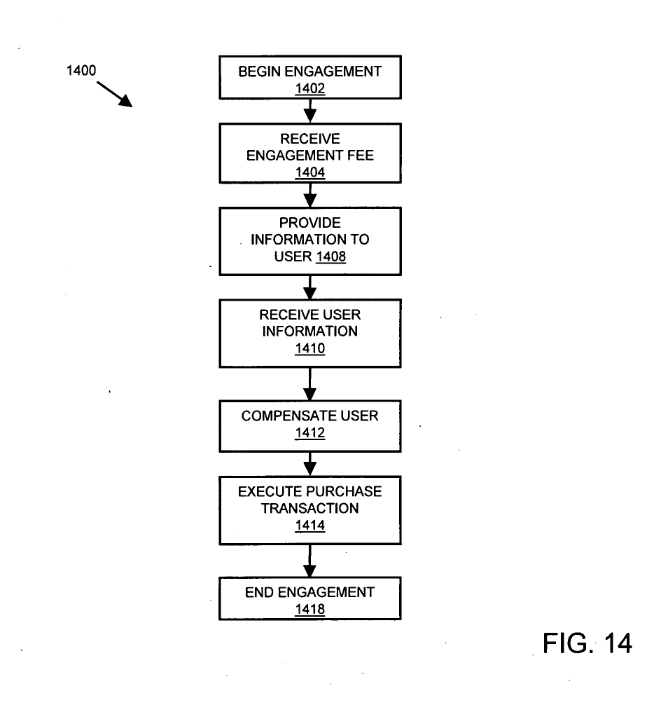

FIG. 14 shows a flow diagram 1400 of a method of the engagement. In some embodiments, the method may be directed at selling a customer-engagement to an advertiser and enabling that advertiser to own whatever customer information may be gathered during the course of the engagement.

The engagement may begin as shown in step 1402. As shown in step 1404, the facilitator 150 and/or the transaction offer offeror 148 may receive a fee from the user 154. While an engagement fee step is shown in the flow diagram of FIG. 14, step 1404 may be optional. Alternatively, the engagement fee may be a symbolic commitment that indicates the user's willingness to engage in transaction offers. The user may agree to be charged the fee, but based on the result of the offer process, the user may not actually be charged the fee. Alternatively, the fee may be returned to the user upon completion of the offer process.

As shown in step 1408, the facilitator 150 and/or the transaction offer offeror 148 may provide information from the transaction offer offeror 148 to the user 154, the information relating to the transaction offer 160. In a purchase transaction embodiment, the offer may be presented to the user at various points in time during the purchase transaction process. As described herein, a plurality of transaction offers 160 may be aggregated, organized, ordered, and/or visually arranged by the platform 100 to be presented to the user 154.

As shown in step 1410, the facilitator 150 and/or the transaction offer offeror 148 may receive user information, such as from the user 154. This information may be associated with establishing and/or maintaining a business relationship between the user 154 and the transaction offer offeror 148. This information may be associated with enabling a transaction between the user 154 and the transaction offer offeror 148. The information having been received by the facilitator 150 may then be provided to the transaction offer offeror 148 by the facilitator 150, and vice versa. The user information, or information related to the specific user-transaction, may be provided by the merchant 144 to the platform 100, the facilitator 150, or the transaction offer offeror 148.

As shown in step 1412, the facilitator 150 and/or the transaction offer offeror 148 may compensate the user for participating in the engagement. In some embodiments, this compensation may take the form of cash, merchandise, services, rewards points, any and all combinations of the foregoing, and the like. The user compensation may be a credit against a form of payment used by the user in the current merchant purchase transaction. Because the user may be known to the platform 100, all of the information about the user that is known to the platform may be used to determine the user compensation. Therefore, the user compensation may be based on a plurality of transactions or engagements between the user and the platform. It will be understood that a variety of embodiments are possible.

As shown in step 1414, the facilitator 150 may execute a purchase transaction in which the user 154 purchases the transaction offer 160. In some embodiments, the transaction offer 160 may include a product and/or a service. In some embodiments, some or all of the information relating to the purchase transaction may be shared between the facilitator 150 and the transaction offer offeror 148, but may or may not be shared with the primary offeror 144. The user supplied form of payment may be charged for the merchant product or service. The amount charged to the user form of payment may be adjusted based on the original purchase price and any changes due to the result of the offer process as herein described.

In some embodiments, a transaction fee may be associated with any and all of the transactions. For example and without limitation, the transaction offer offeror 148 may pay a transaction fee to the facilitator 150 as part of the purchase transaction.

In some embodiments, a transaction payment may be associated with any and all of the transactions. For example and without limitation, the primary offeror 164 may receive a transaction payment from the facilitator 150 as part of the merchant transaction.

The embodiment of the method of the engagement may then conclude, as shown in step 1418.

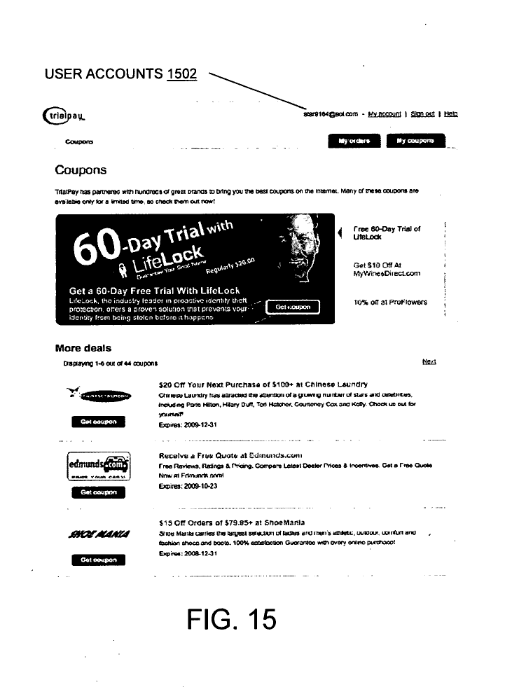

Referring to FIG. 15, a user account 1502 that may belong to a user is shown on a platform 100. The user may receive one or more transaction offers 160; for example, discount coupons for a 60-day free trial with Lifelock, $20 off on the next purchase of $100 at a Chinese laundry. The user 154 may use these coupons based on the availability and the transaction offer 160.

In embodiments, there may be many transaction offer offerors 148 interested in acquiring users 154 who are alternatively purchasing one or more of the primary offers 164 with the specified aspects. Therefore, the transactional offer platform 100 may enable transaction offer offerors 148 to request promotion, placement, pricing, and the like (collectively, referred to herein simply as “placement”) of their transaction offers 160 to high quality users 154. Such placement may be associated with positioning one transaction offer 160 in relation to another transaction offer 160; providing one transaction offer 160 instead of another transaction offer 160; modifying a look, feel, price, or other elements of a transaction offer 160 such as and without limitation to improve the appearance and/or allure of one transaction offer 160 as compared with another; and so on. Transaction offer offerors 148 may include a bid in association with a transaction offer 160 placement request. The offer bidding module 124 may determine which transaction offer 160 is selected based at least in part on the bid. In an example, credit card vendors such as Discover Card, VISA, Master Card, and the like may be willing to pay more to acquire a customer alternatively purchasing a Zagat.com subscription than a customer alternatively purchasing WinZip, perhaps because the purchase of a subscription to Zagat.com, as opposed to a purchase of WinZip, naturally leads to additional purchases (such as for restaurant visits) for which using a credit card may be a preferred method of payment. Additionally or alternatively, such a customer (i.e. a user 154) may have income or spending habits that would highly benefit a credit card vendor. This aspect of the transactional offer platform 100, which a customer marketplace may encompass, may allow transaction offer offerors 148 to bid on users 154 who are performing live transaction offer transactions rather than soft leads.

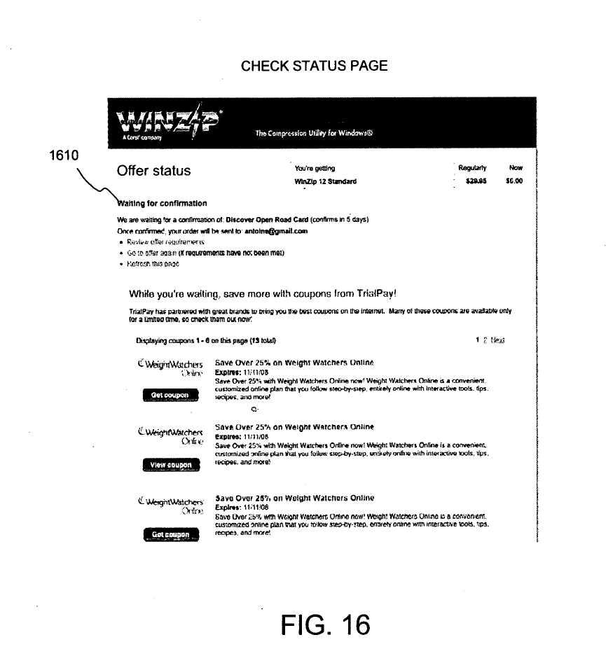

FIG. 16 depicts the screen showing the status of the transaction offer 160. In embodiments, the user 154 may check the status of the transaction offer 160 online. For example, the user 154 may have purchased a primary offering. As part of the primary offering, the user 154 may have received one or more transaction offers 160, such as the “Discover Open Road Card” offer. The embodiment of FIG. 16 provides an example of a user having accepted an offer 1610 that has not yet been fully completed. However, the platform 100 may have debited an advertiser when the transaction offer was presented and may again have debited the advertiser when the user accepted the credit card offer. It is conceivable that the platform 100 would again debit the advertiser once the user receives approval of the exemplary credit card. The embodiment of FIG. 16 may also depict a transaction offer screen in which a user has just accepted one transaction offer and additional transaction offers are presented. The user 154 may check the status of these offers online that are displayed on the platform 100. In addition, the user 154 may view the various other transaction offer 160 available.

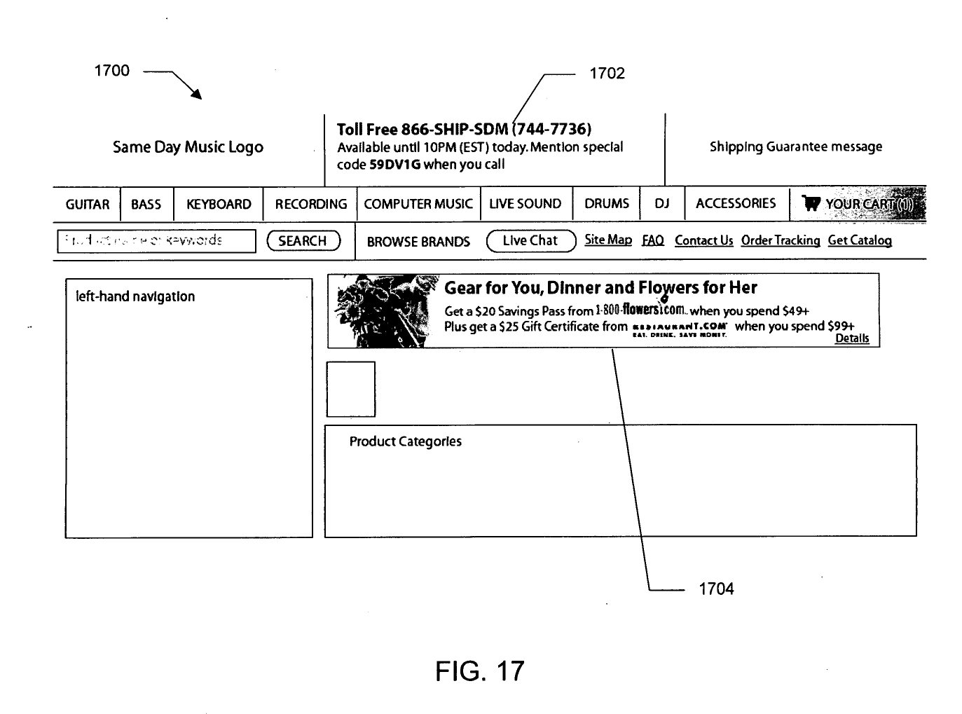

Referring to FIGS. 17 through 22, which depict various embodiments of transactional offer and transactional offer invitation placements in a primary transaction environment, a transactional offer may be fully integrated with a primary offeror website, electronic transaction, shopping cart, and the like.

FIG. 17 depicts a primary offeror web page with an embodiment of the invention. Users may be informed of transactional advertisements to facilitate planning their purchases with the merchant. A primary offeror web page 1700 may include merchant information 1702 and an invitation 1704 for a transactional offer. The invitation 1704 may include conditions of the transactional offer that may help a user of the merchant site plan for an electronic transaction which may include a transaction offer.

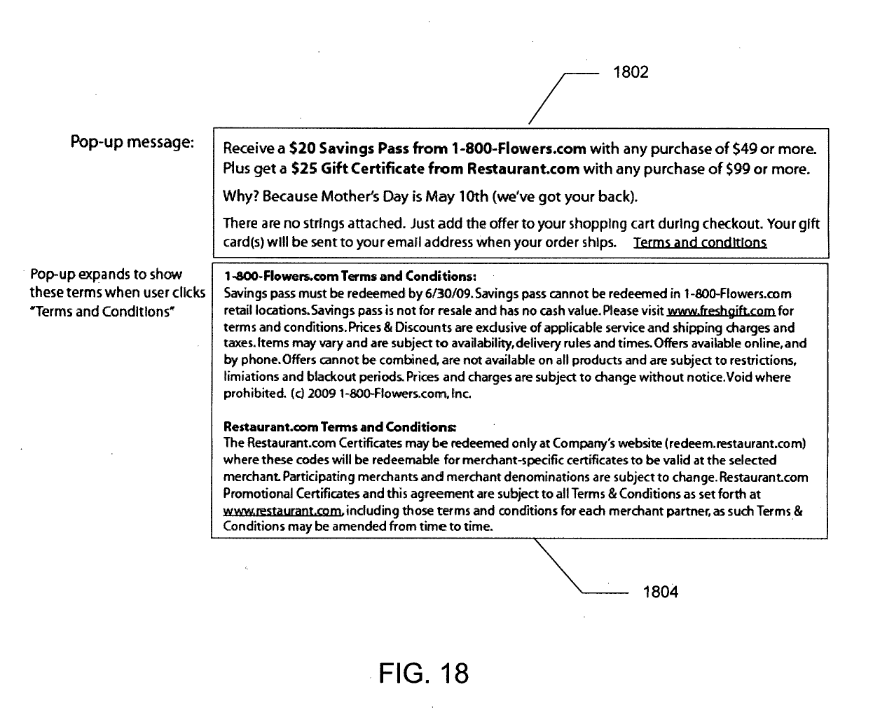

FIG. 18 depicts an exemplary web browser display of a detailed description of a transactional offer. A user may visit the web page of FIG. 17 (or any other web page that may display an invitation to a transactional offer) and interact with the invitation 1704 so that details 1802 and/or expanded details 1804 may be displayed. The transactional offer 1802 and/or expanded details 1804 may facilitate a user determining if a transaction offer is right for him. The user may also learn that the transactional offer, while being contingent on a completed electronic transaction with the merchant does not obligate the user to any other action or financial commitment.

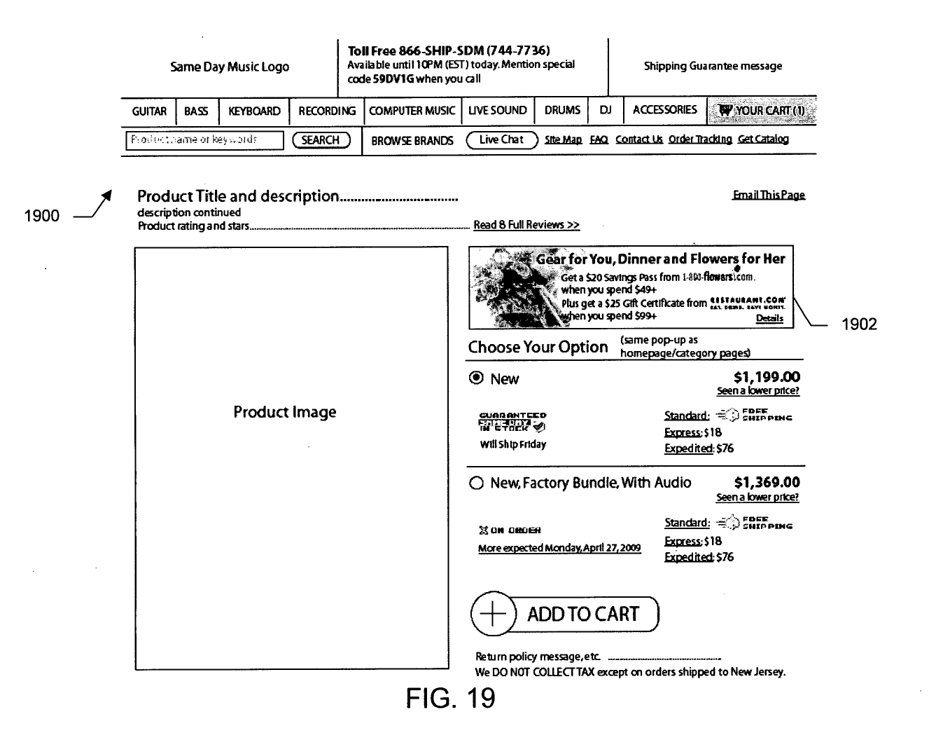

FIG. 19 depicts a transactional offer invitation placement on a product page in which a user may be reminded of a transactional offer to help the user to make a purchase decision with the merchant. Primary vendor web page 1900 may include product information and an invitation 1902 to select a transactional offer that may be presented at the completion of an electronic transaction with the primary vendor. The invitation may be adjusted based on the methods and systems described herein to reflect a status of the transaction, the user shopping cart contents, advertiser anticipated payout, and the like. The user may also choose to view transactional offer details 1802 or expanded details 1804 as shown in FIG. 18. Continued visualization of transactional offers and invitations for transactional offers within a primary vendor's web pages reinforces the transactional offer as an integral part of the primary vendor's electronic transaction environment. Such placement may also strengthen brand association between the primary vendor and the transactional offer. Such placement may provide the user with confidence that the transactional offer is endorsed by and/or supported by the primary offeror. In this way, transactional offer invitations may be differentiated from conventional banner or pop-up advertisements that may be keyword based.

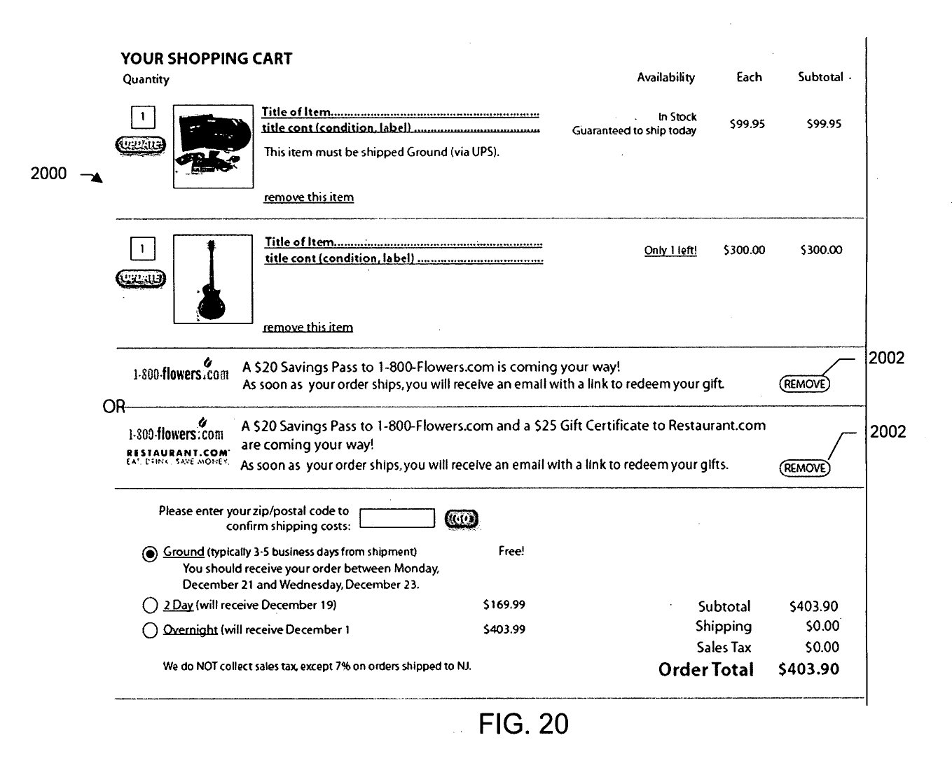

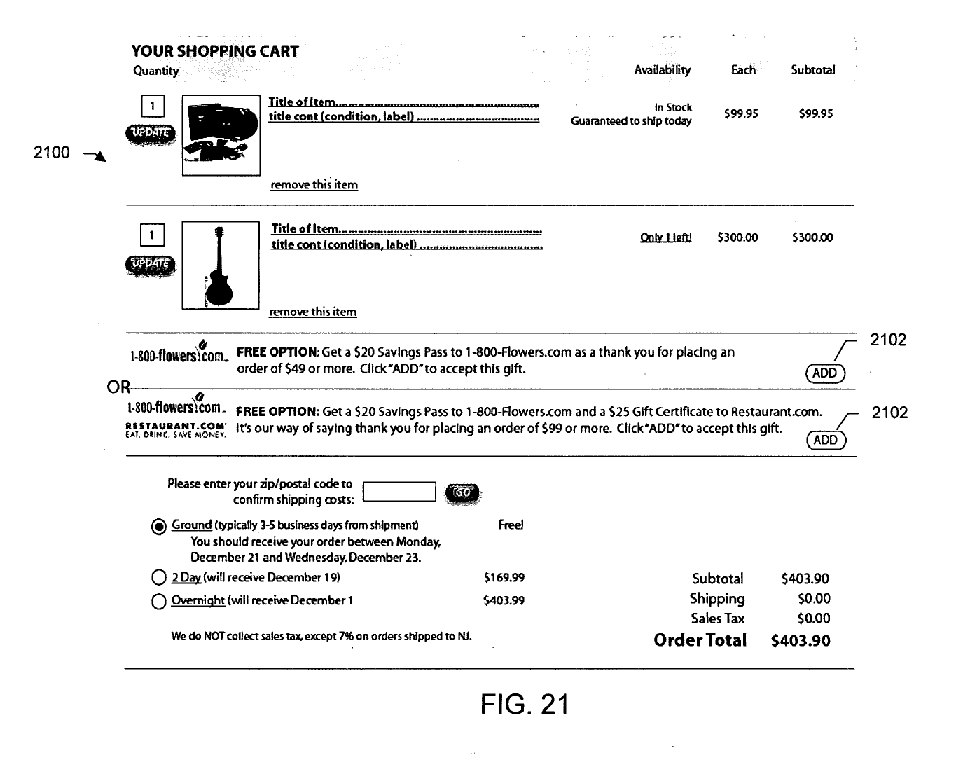

FIGS. 20 and 21 depict checkout web page embodiments of a transactional offer invitation. In the embodiment of FIG. 20, the user may be presented with a checkout page 2000 that includes an opt-out transactional offer invitation 2002 for one or more transactional offers. Because the transactional offer may be provided to the user for no cost or obligation to the user, an ‘opt-out’ type invitation 2002 may provide the user with an easier checkout because the user does not have to take an action to explicitly include the transactional offer with the electronic transaction. Even though the user may be presented with two transaction offer invitations, not opting out of both may not result in the user receiving both. Although the user may receive both, the user may alternatively receive the most appropriate offer based on information associated with the transaction.

FIG. 21 depicts a checkout page similar to the embodiment of FIG. 20 and includes a checkout page 2100. However, in contrast with the opt-out invitation 2002 of FIG. 20, the embodiment of FIG. 21 includes an opt-in transactional offer invitation 2102 that the user must explicitly select to “Add” the transactional offer to the electronic transaction. If the user does not explicitly add the transactional offer to the electronic transaction, the user may again be presented with the offer or another offer at the completion of the electronic transaction. However, explicitly selecting the transaction offer during the checkout process may streamline the electronic transaction confirmation process because the user has already selected to receive a transaction offer. Even though the user may be presented with two transaction offer invitations, opting in to both may not result in the user receiving both. Although the user may receive both, the user may alternatively receive the most appropriate offer based on information associated with the transaction.

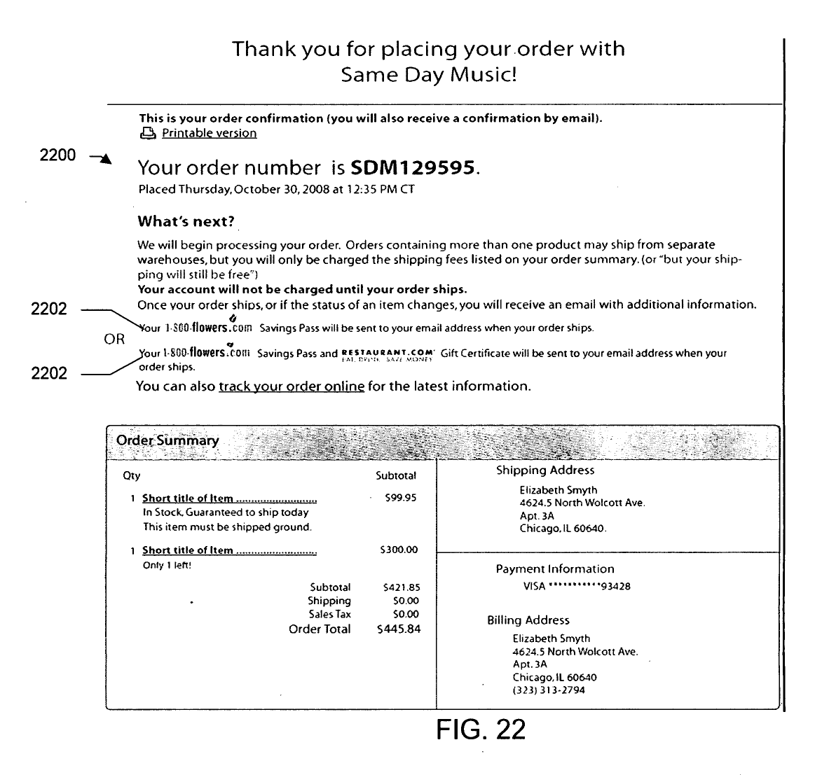

FIG. 22 depicts a transactional offer in an electronic transaction confirmation page. If the user opted-in or did not opt-out of the transaction offer during the checkout process as described for FIGS. 20 and 21, the electronic transaction confirmation page may include a confirmation of the transaction offer that the user included in her shopping cart. The user may receive the transaction offer via an email or other contact means provided by the user as part of the electronic transaction checkout process. Alternatively, the user may not have included any transaction offer with his electronic transaction and he may be presented with one or more transaction offers 2202 that he may optionally accept.

All of the elements of the transaction offer platform 100 may be depicted throughout the figures with respect to logical boundaries between the elements. According to software or hardware engineering practices, the modules that are depicted may in fact be implemented as individual modules. However, the modules may also be implemented in a more monolithic fashion, with logical boundaries not so clearly defined in the source code, object code, hardware logic, or hardware modules that implement the modules. All such implementations are within the scope of the present invention.

It will be appreciated that the various steps identified and described above may be varied, and that the order of steps may be changed to suit particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

It will be appreciated that the above processes, and steps thereof may be realized in hardware, software, or any combination of these suitable for a particular application. The hardware may include a general purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It will further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across a camera system and/or a computer in a number of ways, or all of the functionality may be integrated into a dedicated, standalone image capture device or other hardware. All such permutations and combinations are intended to fall within the scope of the present disclosure.

It will also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood in the broadest sense allowable by law.

All documents referenced herein are hereby incorporated by reference.

1. A method of transactional advertising, comprising:
providing a transaction offer platform for presenting offers to a user committed to complete an electronic transaction in which the user is currently engaged;
accessing a database of offer templates;
electronically calculating an anticipated payout amount for user acceptance of at least one of the offers in the database;
customizing at least one of the offer templates based on the anticipated payout to provide a transaction offer; and
presenting the transaction offer to the user in the electronic transaction.

2. The method of claim 1 wherein an advertiser is associated with each offer template in the database of offer templates.

3. The method of claim 1 wherein customizing the at least one offer template includes adjusting a redemption value.

4. The method of claim 1 wherein customizing the at least one offer template includes adjusting a redemption validity time frame.

5. The method of claim 1 wherein a portion of the offer templates includes a plurality of offers with adjustable redemption values that can be adjusted within a range of values.

6. The method of claim 5 wherein customizing the at least one offer template includes selecting a redemption value within the range of values based on an aspect of the transaction.

7. The method of claim 6 wherein the aspect of the transaction is the purchase amount of the transaction.

8. The method of claim 6 wherein the aspect of the transaction is an aspect of an advertiser transaction offer program that is associated with the offer template.

9. A transactional advertising facility for handling bids from advertisers to provide offers to users, comprising:
an offer search facility for identifying candidate offers based on transactional advertising information;
an offer bidding facility for suggesting a bid amount to an advertiser associated with one or more of the candidate offers based on the transactional advertising information and information associated with the advertiser;
the offer bidding facility for receiving bids from a plurality of advertisers for offer placement in an electronic transaction;
an offer selection facility for selecting one or more offers to present to the user in the electronic transaction based on results of analyzing the matched offers, suggested bid amount, and received bids; and
an offer presentation facility for presenting the one or more selected offers in the electronic transaction.

10. The transactional advertising facility of claim 9 wherein information associated with the transaction includes a transaction amount, a payment type, a shipment address, a shopping cart contents, a user level of commitment, and transaction status.

11. The transactional advertising facility of claim 10 wherein the user level of commitment includes one of an indication of non-payment, an indication of payment commitment, an indication of payment authorization, and an indication of indecision to pay.

12. The transactional advertising facility of claim 11 wherein the transaction status includes one of needs incentive to transact, method of payment provided, payment approved, and payment complete.

13.-25. (canceled)

26. A system for transactional advertising, comprising:
a transaction offer platform for presenting offers to a user committed to complete an electronic transaction in which the user is currently engaged;
an accessing facility for accessing a database of offer templates;
a electronically calculating facility for calculating an anticipated payout amount for user acceptance of at least one of the offers in the database;
a customization facility for customizing at least one of the offer templates based on the anticipated payout to provide a transaction offer; and
a presentation facility for presenting the transaction offer to the user in the electronic transaction.

27. The transactional advertising of claim 26, wherein the offer is a discount coupon.

28. The transactional advertising of claim 26, wherein the offer is an e-check.

29. The transactional advertising of claim 26, wherein the offer is an electronic certificate.

30. The transactional advertising of claim 26, wherein the offer is a mailer.

31. The transactional advertising of claim 26, wherein the anticipated payout amount is the total amount received after completing the transaction.

32.-38. (canceled)
